(19) United States
(12) Patent Application Publication
(10) Pub. No.: US 2022/0374793 A1
(43) Pub. Date: Nov. 24, 2022

(54) Additional Solution Automation & Interface Analysis Implementations & Applications

(71) Applicant: Joni Jezewski, Fremont, CA (US)

(72) Inventor: Joni Jezewski, Fremont, CA (US)

(21) Appl. No.: 17/652,068

(22) Filed: Feb. 22, 2022

(30) Foreign Application Priority Data
Apr. 20, 2021 (US) PCT/US21/70425
Jun. 23, 2021 (US) PCT/US21/70750

(51) Int. Cl. G06Q 10/06; G06N 3/02

(52) U.S. Cl. CPC G06Q 10/0633; G06N 3/02

(57) ABSTRACT

Additional example implementations & applications of components of solution automation & interface analysis (like example solution automation workflows, problem-solving intents, and useful structures) to implement solution automation & interface analysis are included in the specification of this invention.

The example applications & implementations in this disclosure specify configuration/data/code that can be used to apply/implement the inventions referenced in U.S. patent applications Ser. Nos. 16/887,411 & 17/016,403.

These examples extend the example applications & implementations referenced in U.S. patent applications Ser. Nos. 16/887,411, 17/016,403, 17/301,942, 17/304,552, 17/444,286, 17/446,677, and 17/449,810.

### BACKGROUND OF THE INVENTION

### Field

Embodiments of the disclosure relate to additional example applications & implementations of variable components like “solution automation workflows” such as “interface queries”, to implement or apply as configuration/data/code in the inventions ‘solution automation’ and ‘interface analysis’.

### BRIEF SUMMARY OF THE INVENTION

One or more embodiments of the present disclosure may include a method that involves solution automation & interface analysis implementation variables & components, like:

Problem-solving intents like ‘apply generally successful solution or optimization structures’

Solution automation workflows & their useful structures (like ‘interchangeable alternate workflows’) & their implementation variables (like ‘variable workflow component combinations’)

Generally useful structures like ‘structure/intent connections’ (for example, like ‘combinations of uncertainty/certainty structures’ & its associated intents like ‘resolving uncertainties, based on certainties applied as a foundation’)

Variables of implementations of solution automation & interface analysis (like ‘certainty structures applied in a workflow as limits/bases, such as known suboptimal workflows to apply as a base workflow’)

Error/sub-optimality structures (error structures such as ‘differences unresolvable with adjacent interaction level concepts/functions’)

The examples in this disclosure include example implementations or applications of these components.

### BRIEF DESCRIPTION OF THE DRAWINGS

Example embodiments will be described & explained with additional specificity & detail through the use of all of the accompanying drawings in U.S. patent applications Ser. Nos. 16/887,411 & 17/016,403, which contain diagrams of the relevant program components (like solution automation module 140) where example implementations contained in this specification can be applied as configuration/data/code. The same applies for U.S. patent applications Ser. Nos. 17/301,942 & 17/304,552 & 17/444,286 & 17/446,677, which also offer alternative examples of configuration/data/code of U.S. patent applications Ser. Nos. 16/887,411 & 17/016,403.

### DETAILED DESCRIPTION OF THE INVENTION

As used herein, terms used in claims may include the definitions & term usage as detailed in U.S. patent applications Ser. Nos. 16/887,411, 17/016,403, 17/301,942, 17/304,552, 17/444,286, 17/446,677, and 17/449,810.

The term ‘implement’ a component indicates intent to ‘build’ a component, like ‘implement a function to reverse a sequence’ indicates ‘build a function to reverse a sequence’ using specific verbs like ‘build’ to fulfill the ‘implementation’ intent.

The term ‘apply’ a component indicates intent to ‘use’ a component, like ‘apply interface analysis’ indicates ‘use interface analysis’.

The exception to this is where ‘apply’ is used in the context of the core intent function of the invention called ‘apply’, which refers to a specific invention function that ‘applies’ one component to another, like ‘applying an input to a function’, in the sense of ‘injection’ or ‘fitting/merging’.

These definitions are implied/referenced in the other applications & included to avoid conflation.

The term ‘interface’ means a standardizing filter where any problem can be solved.

The term ‘interface query’ means a way to automatically implement a function (connect inputs/outputs), such as automatically implementing a solution-finding method like a solution automation workflow, using operations applied to interfaces.

The term ‘solution automation workflows’ means a way to solve any problem automatically, implemented with an ‘interface query’.

Examples of alternate function representation formats (as opposed to formats like ‘cellular automata’ or a basic function/variable network) to apply in interface queries requiring format finding/conversion/derivation/generation to implement solution automation workflows

Conditions as ‘direction changes’ or ‘integrations/splits’ of a vector sequence/tree/network, inputs as a vector, input vector changes as a ‘vector sequence’, iterations as ‘possible branching vectors from the base vector representing a set’ (each point in or component of the vector indicates a possible point of change during iteration of a set represented as a vector with orthogonal vectors indicating a solution metric to check during iteration), where branching vectors (items selected during iteration) can be connected to or combined in another vector (or vector sequence)

formatting a ‘set’ as a vector formed by component vectors (isolated items of the set) with a function that changes inputs in a way that differentiates input sets, such as variables that can be mapped to vector attributes like ‘degree of difference from a standard base function’ and ‘function limits’

A ‘set of variable change sequences’ is a useful function representation since it allows for interactions between variables as multiple input structures that may or may not contribute to the same outputs and which can be combined

Input/component functions as ‘tensor components’ of a state or function network

‘differences created in inputs, when amortized across inputs’ as the ‘degree of direction change’ in the next vector in the sequence of function vectors

Functions can be represented as an area (volume, etc) or equivalently its ‘limit conditions’ in multiple alternate ways

the area can represent the set of possible functions that could be solutions in the original problem format (connect the input variables to the output variable, given the original input format of the ‘data set of variable connection examples’)

the area can represent a topology of possible solutions (coefficient vectors) adjacently connected by similarity

the area can represent the set of connecting vector sequences between another input/output (‘function steps as connection sequences indicating the steps of the solution/solution-finding function implementation’, ‘function state changes as solution/solution-finding method state sequences connecting the problem input with the solution output (iterated sets of coefficient vectors)’)

the area can represent function components (sub-functions or variable connections/combinations) that a particular function implementation uses (each sub-square in the square representing a component function or variable combination)

Functions can be represented as their inputs or components and the impact on solution metrics

an ‘area indicating a function input change’ and an ‘area indicating a function output change’ can be organized as a ‘set of connected areas where the changes are aligned sequentially’ (like ‘areas connectible by rotating areas around a line’) to indicate function changes that co-occur

Functions can be represented by approximations in more useful dimensions (like ‘lower dimension count’) which are useful for intents like ‘approximation’ which dont require exact matches

example: a polynomial with high rank can be represent in a lower rank by a ‘sequence (like a ‘rotation’ dimension sequence or a sequence on an existing dimension) of lower-dimensional functions that approximate the higher rank function within an accuracy range’ (such as ‘parabolas that can approximate a wave function’ or a ‘circle function’)

Examples of interface structures applied to neural networks, such as ‘error/sub-optimality structures’ of neural networks

Basic backpropagation cant identify error structures such as ‘previously barely deactivated nodes’ that would have contributed with slightly different inputs (ability to recall prior deactivation values & decide whether to re-activate a node, possibly reverting to a previous training state with less information but excluding fewer useful nodes)

if a change to inputs is required to avoid deactivation or optimize weights according to some optimization structure (like creating weights that ‘maximize differences in outputs’) doesnt contradict the output of other weight paths, deactivating a particular node can be avoided or weights can be optimized if its barely under the threshold (which moves the error to a new threshold, the threshold value to determine whether to apply the original threshold value)

examine effects of ‘weight-swapping’ across structures of relevance like ‘adjacent nodes’ if node position indicates initial or emergent similarity in weight path or ‘adjacent weight values in a node layer’ to test if similar but not equal weight updates apply to the possibly similar weighted feature sets that created those similar weights or are otherwise useful in generating errors (such as how values relevant by a similarity such as adjacence should be or remain similar)

Neural networks cant identify & correct their own possible error structures in pattern-finding tasks, such as assumptions/biases or the cause for its errors like ‘missing information’, or change its predictions given its error structures to correct them or at least account for them

they also cant identify why its not being used (has error structures for a particular problem), which is be its a function network, rather than a data store of ‘user intents’ and ‘user queries’, and ‘functionality to infer this related data to improve itself’ is not built-in to neural networks by default

By default, neural networks optimize for ‘finding prediction (variable interaction) functions of the original data set’, not ‘creating an optimal solution-finding method for finding variable interactions in a data set’ or ‘inferring related data to improving itself’ or related intents, integrating ‘local specific optimization structures for a particular solution metric’ (to find prediction function for original data set) rather than ‘generally useful optimization structures’ or ‘optimization structures specific to problem attributes like problem type’

A target ‘explanation’ structure for neural networks to generate with their prediction output, which they don't currently implement, is:

‘given my understanding of the concept of “differences” applied to identify different variable values such as a “category” for a particular input in the data set, and given my ability to identify differences & my ability to derive output features from input feature change combinations, I think these inputs map to these outputs with x % accuracy, which should be adjusted for my inability to correct “ambiguity resolution” errors in contexts such as “unexpected new inputs” which differ from the ambiguity structures I can resolve, because the differences I cant resolve are less obvious’

this explanation connects the network's abilities (functions) & decisions (solution filters/selections), the error structures the network can infer as possible given its functionality, the cause of those error structures, the interface structures like ‘concepts’ and ‘assumptions’ involved in its functions & decisions, & the cause of its input-output mapping decisions, and how the network (& its probable usage intents, given its abilities) relate to problems including problem attributes like ‘obviousness of a solution’

if the output isnt exclusively a function of structures (like combinations/subsets) applied to inputs, it wont identify those structures that its missing

if the neural network ‘differentiates’ too early (by committing to a particular structure as a ‘certain’ useful structure for generating the output, like stem/blast cells differentiating too early or certain pre-processing rules applied to data that shouldnt be assumed constants), that differentiation cant necessarily be reversed later by emergent effects, so differentiation should happen on subsequent layers rather than immediately after inputs

this would occur if there are multiple input-output sequences of different structures leading to outputs that coordinate (rather than providing alternatives)

Over-prioritization of correcting ‘known errors’, such as ‘filling in missing information’, which occur frequently in language data sets but not frequently in highly structured language data sets like math word problems

example: assuming that two different examples of a type should have every attribute/function the same, and assuming that the problem should have similar structures as the solution, because over-prioritization of a priority like ‘equivalence’ fulfilled by ‘inferring missing information’ can create errors like ‘forcing equivalence of different variables that dont need to be equal’

The error structure of a ‘gap in the ‘input-output sequence’ of a possible function of inputs predicting the output can prevent almost useful sequences from contributing to output, if a node is deactivated to create the gap

Given that a network learns one representation of a prediction function, it cant learn multiple representations unless it retains ‘alternate conditional’ neural network nodes/layers/paths that allow other structures to be considered in case a hidden pattern emerges in another data set (like what appears to be a parabola can be produced by multiple polynomial structures)—restricting ml networks to the ‘most efficient compression’ of a network to represent the found prediction function would remove its learning potential for these possible alternate structures

these ‘functional similarities’ can be encoded in the network if it evaluates which decisions are the result of possible emergent functions in the network that could have ‘alternate conditional functions’ also explaining that decision, and retains multiple alternate weight sets

Example of deriving a ‘mental model or state of interacting structures like functions/errors’ (such as ‘learning’ or ‘misunderstanding’ or ‘handling a contradiction’ or ‘disorganized’ or ‘over-prioritized error correction’) as a useful lower-dimensional representation of a neural network to apply when finding/deriving/generating/applying neural networks

These ‘mental models’ of networks involve various functions, errors, alternatives, priorities, concepts & other interface structures, including functions such as ‘components of the concept of intelligence’ like ‘imagination’

On the ‘agent’ interface, the corresponding object is a ‘personality’, such as a network that is particular averse to learning or new information, over-simplifies everything, more rational/logical than other networks, more stubborn in its resistance to change, more interested in the truth than other networks, lacking in self-awareness in not correcting its own errors, more intelligent in having more abilities (like an imagination/simulation function) or having more experience or better at avoiding errors than other networks, etc

1. a ‘mental model’ of a neural network may have interaction structures of interface (‘error’) & problem (‘sentence’, ‘sentence variables/components’) structures such as:

having the ability to identify the correct ‘missing information’ error to fix, given its ability to identify when the correct variables are different, which differences need to be resolved in which sequences, and which variable differences are relevant

having the ability to identify when an object is relevant to adjacent sentence's objects in the sentence sequence

having the ability to identify related or equivalent objects

having the ability to sort information in order of factuality, prioritizing factual information first to start applying possible connection/change functions to facts first, identifying that assumptions need to be based on facts

having the ability to identify interactions like type to infer object connections

having the ability to identify the solution format (interaction structures applied to problem variables, such as ‘type of an input vector’), thereby connecting the given & adjacently inferrable information with the requested solution format, inferring the connection between various structures in the process

having an understanding of how to build variables from sequential operations applied to input variables to create other variables/structures

possibly having a concept of problem-solving workflows such as ‘build possibilities from facts’, ‘build outputs from sequences of functions applied to inputs’, ‘connect original inputs with target solution output’, ‘identify differences/errors to resolve/connect/equalize and only connect those differences/errors’, ‘identify requirements & fulfill requirements using inputs’, if the neural network can store the abstraction of the ‘workflow’ rather than generating the workflow implicitly in solving a problem

2. a ‘mental model’ of a neural network may have interaction structures of interface (‘error’) & problem (‘sentence’, ‘sentence variables/components’) structures such as:

an inability to identify when a value has already been calculated, in assuming an inherent required difference between variables which are actually equivalent in some context

an inability to infer alternate contexts which could impact other variables, such as ‘equalizing other variables’

an inability to identify that there is more than one object of a type, despite the differences in descriptions of those objects

an inability to infer an error of a ‘false difference’ or avoid this error, in identifying variables as necessarily different when one of them was already calculated because of an assumption about relevant structures like ‘groups’ that impact functions like ‘combine’

3. a ‘mental model’ of a neural network may have interaction structures of interface (‘error’) & problem (‘sentence’, ‘sentence variables/components’) structures such as:

having the ability to correctly identify relevant interim variable values to calculate before calculating other variables, but incorrectly calculating it despite correctly identifying the sequence of operations and misidentifying an output as the next output in the calculation sequence, thereby skipping a step

having an inability to identify comparable variable values which are relevant to compare (being comparable in having irrelevant differences removed and relevant similarities included for finding differences in those similarities)

having an inability to identify whether an operation has been done, is required, or in what sequence the operations should be executed, producing errors in ‘missing operations’ and ‘incorrect operation-output connections’

having an inability to identify the inequality in the variable used to calculate another variable, compared to another more relevant variable as relevant, and an inability to identify this as an error to fix

having an inability to identify a difference in a variable such as metadata of the variable like ‘possible value count/range’

having an inability to infer that not every variable/value/function is required to be equal or equally applied

having an inability to identify the right format to input into an operation, to create/apply variables that are of equivalent format/relevance (like a ‘unit example of a type’)

4. a ‘mental model’ of a neural network may have interaction structures of interface (‘error’) & problem (‘sentence’, ‘sentence variables/components’) structures such as:

having a ‘priority’ of simplicity leading to an overly simple ‘concept’ of errors as ‘differences’, limited to a particular ‘example’ error structure that it knows how to handle which is ‘missing information, where “missing” is determined by inequality’

a ‘priority’ of preserving ‘structures’ like similarities, without evaluating usefulness

a ‘priority’ of ‘equalizing’ variables to create similarities, without evaluating whether a difference is useful, such as for a ‘comparison’ intent

having minimal ‘understanding’ of usefulness, and an ‘inability’ to imagine other contexts like different problems to solve such as ‘compare’

an ‘inability’ to correct its errors, identify the cause of errors, identify other errors that are more high-priority to avoid such as ‘removing information about a difference’, an error which the neural network creates by trying to fix the ‘missing information of the inequality present in “one object's variable not being populated when the other object's variable is populated”’ and in trying to fix this definition of ‘missing information’, it creates a ‘missing information’ error by removing the information that differentiated the two objects, which is the actual ‘missing information’ structure the model should have avoided

never having encountered the ‘state’ of ‘receiving negative feedback’ for errors in its error-correction method

given these priorities, examples, experiences, concepts & other components, this neural network can produce errors when applied to sentence data that is highly structured for a particular purpose, simply applying any equalizing method it can, without evaluating whether all variables of the problem/solution should be equalized to connect the problem/solution state or if a subset of variables are useful for doing so

Examples of other types of operations a neural network can support including ‘interface operations using interface structures’, which are particularly useful for a neural network to implement as they fulfill useful intents such as ‘resolve errors’, ‘add functionality’, or ‘fulfill a solution metric’

Ideally all of the following example solution metrics, conditions, & other interface structures would be supported by a neural network, with various structures like ‘injecting interface structures’ & ‘allowing communication with other networks or generation of networks’

Functionality to select between alternative priorities by the functionality gained from that priority

example: maximizing the number of functions supported by a network (varying constants like weight sign to allow different operations) vs. maximizing the number of emergent/conditional/compression/other function types supported by the network vs. maximizing the number of error types avoided by a network in a variety of data cases vs. covering the functions necessary to cover the functions required to quickly converge to most prediction functions is a useful set of limits to apply when filtering possible networks

Functionality to derive insights, even if the insights are certain and can be applied as preprocessing functions rather than in the neural network

neural networks are for resolving uncertainties to find rules in the problem system, but insights enable this process to be optimized, and the uncertainty of ‘finding insights to optimize neural networks’ or the uncertainty of ‘selecting which insights to find/apply’ are likelier to be more valuable uncertainties to resolve than the original problem

example insight: different label ratios create a higher likelihood of predicting the more common label be networks dont have a structure to handle this, like an input-representation-ratio metric included as inputs by a preprocessing script or derived by the network itself, such as through a function that calculates what percent of the dataset contains that label or a structure that emergently calculates the same (like a function that amounts to evaluating if the ratio of a predicted label is too similar to the ratio of that label in the training data set, beyond what the test set implies), (preprocessing functions like a commonness type evaluation function to evaluate what the source of commonness is and whether that source is legitimate to influence the weight changes toward a particular output or a standardizing function that removes various illegitimate sources of commonness), and then adds it as a feature after a layer containing these functions, which would likely discover such associations as false and being attributable to data ratios rather than meaningful connections that should be included in the output prediction function

this type of insight can be injected into networks by force (designing the network to apply the insight), but it can also be discovered by particular neural network structures (emergent functions), and given that new prediction function-correcting insights will always be in-demand and should be considered part of the responsibility of a neural network, given their potential to discover them if used & built correctly

Functionality to discover the right variable interface level at which most of the variation occurs (variables like position/angles for facial recognition) & retain that variation

Functionality including interface operations like:

merging the high-variation variable interface with the interface containing the specific functions creating that variation or the standard functions of the network (aggregation, pooling)

removing interface structures like the ‘requirement’ structure to identify concepts like ‘play’ (unrequired activity without a required point/intent like ‘survival’), this concept being useful for optimizing resources to exercise/learn when not used for other intents, which is a useful system design insight that networks should integrate

identifying useful concepts like the following, and identify the set of concepts that are useful in optimizing the network system:

‘sharing’ which allow it to coordinate with other networks to optimize various metrics (this concept having requirements in the form of other input concepts like ‘other networks’ which requires the concept of a ‘network’ for the network to be able to identify this concept), and apply these concepts to its own structure (‘learn a more optimal network structure’ such as by including them in the input or by changing its structure/params to consistently create these concepts) to enable learning other concepts

‘helping’ which allows it to identify extremes such as ‘fighting other networks’ as sub-optimal and identify when another network is not helping it but rather exploiting it so it can defend itself against exploits/hijacking

Functionality to find operations like the ‘attribute removal’ and ‘attribute generalization’ to identify concepts like ‘type’

Functionality to find useful structures like similar structures across interfaces for intents like:

a ‘priority’→‘hierarchy’→‘tree’→‘overlapping sequences with fixed end point’→‘rotation with fixed end point’→‘circle’→‘symmetry about the center’→‘direction’→‘priority’ connection structure for intents like ‘find a structure to model a priority or hierarchy’

a ‘combination into one output’→‘tree’+‘overlap’→‘network’+‘select/summarize/filter’→‘neural network’ connection structure for intents like ‘find structure to integrate multiple outputs of trees’

Functionality to find common distortion functions of features like ‘corruption around a symmetry’

Functionality to identify useful structures as particularly powerful structures applicable across neural networks/intents/problems, and finding alternative optimal paths to generate these useful structures like the following paths (which are solution automation workflows), if these concepts/structures like ‘useful structures’ and ‘insights’ are injected as inputs or built in to the network structure emergently by creating a network that priorities creating/finding/applying useful structures or by other function sets amounting to the same

apply useful structures like input/output sequences to problem-solving structures like problem-solving intent functions

find structures like ‘similar’ that implement/enable or are inputs to core problem-solving intent functions like ‘connect’, such as finding structures with similarities that may be relevant/useful in ‘connecting the problem/solution’

find alternate structures of ‘usefulness’, like structures of ‘obviousness’, such as structures which make clusters linearly separable or highlight differences by maximizing them, & developing functions to find these structures

start by solving a unit case & generalize

start by solving for a function to find functions to connect input/output pairs that are connectible with adjacent/simple transforms, and find a function to generalize unit cases (generalize by ‘removing specific problem attribute values such as inputs or requirements, like the number of inputs’) and apply this function to the first function

specify inputs & outputs

specify solution outputs to restrict possible outputs: specify a range/area of functions for a network to find a prediction function within, which has a particular error rate across data subsets, without varying on any function subsets that are more certain/calculatable

if the outputs are more restricted in this way, the network can identify optimizations for those specific outputs like ‘calculate the impact of a de/activation decision and if it contributes significantly to violating the specific solution function error range with other decisions being made in this iteration or likely to be made in future iterations at that point, prevent it’

identify alternate function sets

identify alternate functions (like a set of useful testing functions, a change function, and a selection function as an alternative function set to the functions of a neural net) to fulfill a problem-solving function like ‘connect the problem inputs & the solution output’

apply insights from other systems

identify alternate systems (like physics) with the complexity to delegate functions like ‘generating new change types’ to that system, or alternatively identify a system that is the source of problems solved by neural networks, or alternatively generate a system that could be the source of problems solved by neural networks, in order to use that system info to optimize neural networks & derive intent/meaning/usage of neural networks, derive other networks & coordinate with other networks, and develop self-awareness in that system

identify useful structures for core standard intents like ‘identification’ (such as ‘identifying whether something has changed’) or core specific neural network required intents like ‘identify change’ or ‘identify change contributed by a unit (node)’

identify the concept of a ‘derivative’ by identifying the following, and identifying variables to compare it to (previous success, time, other input variables)

the useful structure of the combination of a ‘change’ and a ‘comparison’ to derive a ‘change rate’ concept by identifying the relative low value of change information when not compared to another type of change (‘the meaning of a change, compared to what’)

the requirement to identify change to test if a weight update improved the solution (‘meaning of a change, compared to the previous solution success’)

apply general solution metrics as filters of possible solution components & further inputs to derive problem structures

apply general solution metrics like accuracy (with possible input solution components like ‘specific equivalence’ with possible inputs like ‘equivalent structures’)

identify rules & inject those rules as prior knowledge:

identify insights & applying insight operations like ‘variables usually vary more than a particular subset of the data set’+‘real systems typically have many variables leading to noise’=‘variables should be corrupted to generate a more realistic data set’

change problem-solving intent (like ‘find structures to prevent errors’ rather than ‘find solutions’)

rather than finding/generating solutions & checking if a particular solution has errors, identify possible errors (differences from solutions) & reasons why (causes) an error might occur (‘over-prioritization of a priority, like simplicity’) and check for & prevent these causal structures of errors by generating counter-structures to correct it without causing other errors

trial & error:

alternatively, apply every possible change to every possible variable to generate every possible variable structure and then select for those which perform better & repeat this process for every task

self-awareness/modification or awareness of neural network structures like usage structures (like ‘training structures’)

make one training iteration aware of another by allowing a network to keep track of other training data sets & contexts & outputs it's trained with, to identify the reason training is more successful (difference in data sets making one quicker to converge than another) in order to identify differences to apply (change a data set by adding noise to account for these differences in data sets) and identify possible operations to try that could identify useful structures (like combine the data sets, select subsets, combine training input/output in a sequence of training iterations, etc)

Functionality to identify useful high-level & meaning-adjacent intents like ‘standardize’ and ‘organize’ as particularly useful functions to create and apply across intents/problems

identifying that its ‘operations are more effective once a standard is applied to inputs’ or ‘operations like comparison is more effective when inputs are more similar in some ways and more different in others’ can be an input to identifying ‘standardize’ as a useful function

alternatively, a function that can identify when structures have the same input/output like ‘operations are more effective once a standard is applied to inputs’ or ‘operations like comparison is more effective when inputs are more similar in some ways and more different in others’

identifying the insight that ‘some structures are more useful in specific positions’ or ‘structure adds value when variation is known and randomness adds value in discovering new change structures’ can be an input to identifying useful connecting structures like ‘networks’ and identifying useful implementing functions like ‘organize’ of those connecting structures, or in identifying useful structures for improving prediction functions rapidly

alternatively, identifying that functions which support multiple cross-interface intents like these are inherently more important/useful and should be prioritized & developed by the network

Functionality including other variable operations than aggregation (of small features into big features) such as ‘selecting’ (between alternates) or ‘changing’ (creating alternates), or ‘breaking the original output into components’ (reverse direction of aggregation) or ‘generating all feature structures like combinations and filtering them’ or ‘switching & mixing abstraction & interaction levels’

Functionality to find contexts where applying structures like ‘opposite’ (such as by negating a sign of a network structure or executing a filter instead of a combination operation) is useful for quick or accurate convergence, for finding maximally different functions, for finding alternate conditional functions, for handling errors of ‘falsehood’ where the trend in a particular direction is an error to correct by negating it, or other intents relevant to ‘finding a prediction function’ that could be fulfilled by neural networks if informed by interface structures

In addition to finding interface structures like interaction levels of related objects in a network, functionality to find other useful structures like opposite structures (input variables & output requirements, problem/solution, difference/similarity, component/whole, generate/filter) which provide a network of useful boundaries to base solutions within, as few extremes/absolutes apply in real systems (except in for example cases like booleans) and therefore these opposites act like bounds

Functionality to find/build/derive a solution to known error types, like ‘missing variables’ (solution like ‘adding random noise’) or ‘nested variables’ (solution like ‘expanding variable into sub-network of variables’)

Given that the standard neural net structure supports variable interactions like ‘combine’ and ‘filter’ to fulfill problem-solving intents for problems in the ‘find a prediction function’ format, like ‘solve for relevant structures to solve a problem (such as on an adjacent interaction level as the problem/solution structures)’, ‘combine variables in many possible combinations’ and ‘filter possible combinations’, functionality including other core problem-solving workflow function sets other than combine/filter variable combinations (similar to build/test, generate/reduce), like ‘change existing solution’, ‘reduce problem’, etc

functionality to identify/derive/find which structures align with these problem-solving function sets (finding ‘variable interactions/combinations’ as a solution structure for the ‘find a prediction function’ problem)

Functionality to find tasks that would capture the functions of or generalize many tasks, like abstract tasks or other interface tasks, or standard problem format tasks like ‘sorting’, ‘filtering’, ‘building’, ‘fitting/matching’, ‘connecting’, ‘combining’

meaning ‘would a network trained specifically to perform a particular interface operation be better at tasks in general than a standard neural network’

is there a task or set of tasks that generalizes most tasks better than other tasks, and which is it (is there a set of interface operations which, when supported by a network, can solve most ‘find a prediction function’ problems)

is this the reason networks that learn functions like compress/expand (encode/decode) or translate perform better than standard neural networks, because these functions are similar to interface functions (like ‘standardize to a (network)/interface’) or core functions like ‘change a (language) network into another network’

Functionality to apply other solution automation workflows like ‘reverse engineering a solution’ such as by first ‘finding out what structures could influence the target structure, then checking if any of the inputs are those influential structures’ (a ‘function output’ or ‘function intent’-based interface query which first generates candidates for solutions using solution requirements before checking if each input is one of these candidates), rather than a standard workflow such as ‘check if each input influences the target structure’ (which iterates through all possible inputs and checks each one for equivalence to a solution)

Functionality to identify structures of optimization such as structure to optimize for the number of data points predicted

example: instead of predicting one particular data point in a set of adjacent or otherwise related data points (adjacently converted into each other using minimal probable available operations in the input problem space), try to predict that data point earlier in the network and then apply distortions to it to optimize predicting data points generated by distortions of that data point, to optimize predicting more data points accurately than to predict each data point accurately

Functionality to derive the input problem space, such as the network of variables, the system in which this network occurs, the functions that take some subset of the variables as inputs or creates subsets of variables, etc

Functionality to identify opportunities for optimization like:

developing a ‘function to identify adjacency/groups and predict one point from an adjacent point or a point in a similar group’ rather than ‘finding prediction function coefficients of input features’, which may be useful for local optimizations as opposed to the standard function developed by a neural net

identifying when a subset function is better than a combination function to identify features, such as when a ‘surrounding structure like a container’ is relevant to identifying a medical problem like ‘structural damage’, to identify that the ‘subset of the damage’ that has a similarity to the surrounding structure is the important place to use a subset when looking for interface structures like similarity that can indicate relevance, to identify other relevant features like where the damage can not be and where the damage may hit next

identifying ‘attachable sensory/function simulation networks’ as a more effective/efficient way to gain feedback than ‘labeled data with supervised learning’ and creating & attaching these networks to avoid over-focusing on a priority/metric/structure/task and identifying the tasks these sensory/function simulation networks should perform in order to gain the most useful feedback (for example identifying that a ‘robotic arm used to put blocks in a pattern’ is a useful system & task to create a ‘sensory vision network’ and a ‘functional arm network’ for in order to optimize a network used to ‘rank features in a particular sequence’ (like a sequence of blocks))

Functionality to identify sub-optimal structures, like whether a neural net that aggregates features is only useful for image recognition be adjacent features in an image tend to combine to create larger features in reality, so by accident, the aggregation function aligns with this real function applied to features in reality

Functionality to identify structures to counter these sub-optimal structures (correct sub-optimal structures rather than purely optimize structures) such as phase shifts/thresholds between features that should not be combined with adjacent features (detecting the limit/boundary of feature groups that dont always appear adjacently in real life)

example: identifying these boundaries would be a clear counter-structure to the structure of combining adjacent features which would be sub-optimal in situations where the adjacent features dont always appear together, which is a possibility the network should be able to generate & create a counter-structure for

Functionality to identify insights about its own structure like ‘a network is insufficient to describe its own interactions with other networks’

‘inputs’ like injecting interface structures like concepts like ‘networks’ into a neural net along with the data set input features might produce this functionality

‘network structures’ like ‘giving every node the ability to connect with every other node’, ‘conducting regular global communications’, ‘abstracting features’, ‘allowing the network to generate other networks’ could also amount to the same functionality

Functionality to identify problems like ‘over-weighting common data as if its more important be of that commonness, given statistics of the data set and given that default neural networks treat commonness as equivalent to importance’ and correct them with solution structures like ‘over-weighting less common but equally valid data that hurts the accuracy of the network in cases where accuracy is required (the model cant be generalized so much that it ignores these outliers if the solution metrics are to be achieved)’ and convert those target solution structures into neural network structures like ‘guaranteed protected or isolated weight paths that allow the outliers to be correctly labeled, once a weight path/tree is identified as being able to correctly identify an outlier or other example type in a way that doesnt contradict the rest of the model or can coexist with the rest of the model as it uses the same variables in a significantly different combination that would be generalized out if the network didnt have protection structures in place, to avoid updating certain paths in the network where those paths are useful for some intent that would be invalidated by allowing them to be updated’ or an ‘enforced/required layer of all possible outcome variants (distorted members of a class) before the final pooling/selection layers so that all possible outcomes in the data set are always given some probability at which point this probability can be changed to account for prioritization (prioritizing structures like patterns of extreme low probabilities that still indicate valid members of a class), after calculating all possible outcomes including the outliers, this layer acting like a solution metric requirement embedded in the neural network, where all required outcomes to predict can be predicted by the network, even if theyre over/under-weighted by their data set statistics

this applies a process used in solution automation workflows that derive structures that are derivable from solution metrics to specific more structures than those directly derivable from the problem, using those solution metrics as requirements of the solution to specify more of the solution's structure

rather than being a random or standard network applied to inputs, the solution metrics are then embedded in the final layers of the network to require the output to fulfill solution requirements

this injects the certainty of the solution metric requirements into the network in different positions—the protected weight structures, or the conditional weight structures that allow the normal data and the outlier data to be accurately predicted, or the enforced output variant layer requiring the earlier layers to produce some probability for each variant at some point, or the network has to reverse its weight state trajectories and try other combinations of weights once its determined that some output variant is being generalized out

Functionality to find/derive/apply useful error-triggering structure, like the most different/contradictory of examples that would still be valid in the same system (supporting both the most distorted/standard members of a class), using the least informative data (images of other members of a class rather than either of the two most distorted/standard), meaning can the network determine useful structures like ‘differences’, ‘averages/standards’ and ‘extremes/outliers’ without being explicitly given that ability and apply those useful structures to increase its accuracy on those examples (can the network come up with ways to solve the problems of identifying these structures and these contradictory examples, like conditional weights, protected weight structures, etc), given that ‘differences like weights/combinations applied to variables’ are a default network structure that can solve these problems if changed slightly

functionality to identify these slight changes to its functions/structure/params, such as applying variables to the ‘weight’ structure to create the concept of a ‘conditional weight’, and applying the concepts of ‘difference’ and ‘extreme/maximum’ to create the concept of the ‘most extreme difference’ as a useful test of its emergent prediction function's accuracy

how to embed these concepts in the network's input features as variables that the network can change (input parameters of the network and concepts like ‘maximum’ and ‘difference’ as inputs to the network so the network can change these variables and combine them in order to change its functionality, or alternatively embedding these variables in functions applied in the network, such as by applying conditional weights by default using code, and allowing those conditional weights to be updated like normal weights are updated and allowing input variables like ‘difference types’ like ‘exponential’ or ‘subtraction’ or ‘net’ or ‘count’ or ‘position’ difference to be applied to these embedded functions in a separate ‘metadata weighting function’ of the network to weight that inputs to these embedded functions using alternate input data sets containing these useful structures as variables)

this enables the network to have a concept of itself, by embedding neural networks terms into the network inputs, so it can conceive of functions like ‘creating an alternate network to train each extremely different data subset, to avoid errors of de-prioritizing less common example data by forcing all of the data to be an input to the same network’

its possible this is as simple as having an initial or wrapper neural network (an abstraction level above the problem of finding the prediction function) trained on different network configurations (like multiple networks for each different data subset, or a network having conditional weights) to produce varying output success on solving the data set prediction function problem, with possible alternate implementations like:

network to find neural network configuration/transformations (using concepts like ‘network’ and ‘weights’ as input variables), followed by network to apply changes to data recommended by initial network, followed by network to find prediction function for original data set

network to solve multiple problems like ‘find useful neural network configurations/transformations’ or ‘find useful neural network configurations/transformations for a data set’, then ‘apply recommended changes to network before/during/after training to find prediction function’ and ‘find prediction function’, using concepts like ‘network’ as input as well as original data set variables as input, and adding ‘recommended changes’ to inputs once found

this would involve converting concepts like ‘network’ into a numerical format (such as how a variable might change if it represents a particular node on the network of related values, like different tenth values in the set of 0, 0.1, 0.2, up to 1.0, where values are clearly members of a type, and where subsequent values are likelier to follow similar values as opposed to very different adjacent value changes like from 0 to 1, similar to how an actual network works given that connected/adjacent nodes are related for a reason, hence the structure connecting/positioning them in that way), and applying those value changes as a variable determining some network configuration (like the percentage of the network devoted to differences in weight path protections), or another format that represents the useful intents fulfilled by the network, formatting the ‘network’ concept as a prediction function-generator (so the ‘network’ concept variable would be able to influence as in ‘correct errors in’ a variable representing the ‘prediction function’, where the network would have both these variables as input, and where the ‘prediction function’ variable would be a ‘set of variables representing coefficients’ or a ‘scalar representing the vector applied to other variables which are inputs’, meaning the original data set variables or some variant of them like ‘general common variable interaction patterns’, and including other useful structures like ‘errors’ as ‘sub-optimal differences’ such as ‘difference types’ applied to a value like exponential/subtraction/negation or applying the errors to the data to generate ‘error data sets’ as inputs)

functionality to identify whether simpler structures like embedding ‘error weight structure patterns’ (patterns of weight structures indicating an error like data corruption) into the network by checking for these error patterns during training and de-prioritizing them if there is no overlap/ambiguity between the error pattern and a useful pattern like an outlier pattern

functionality to identify other useful patterns than just the data set variable interactions, such as the aforementioned training/network error patterns, outlier patterns, as well as the patterns in the data that reflect errors such as bias and whether the network can connect these patterns to useful structures like perspectives (what did the data set over-prioritize that resulted in alternate data set being lower accuracy with this model, and can those priorities be offset to generate alternate data sets reflecting different priorities)

if there isnt noise in a particular data set or variable interaction, its probably not realistic data, and as sometimes this noise isnt noise in all contexts but is useful in certain contexts, some of this noise should be preserved and used as variables rather than removed from the data set

removing this type of data error reflects a perspective that prioritizes ‘just learning the patterns of the variable interactions in the data set’ which is limited in its usefulness

to offset this pattern, techniques like generalization & data augmentation/generation can be applied, which contradict the structure of the error of ‘specificity’ that over-prioritizes the original data set with noise removed

the structure of ‘generalization’ directly contradicts the structure of ‘specificity’, and the structure of ‘alternate’ (applied as alternate data sets) contradicts the ‘static’ attribute of only/specifically the original data set

functionality to identify other error structures of over-prioritization and correct them is another solution metric of neural networks that can be resolved with interface structures (deriving the opposite of a structure like ‘specificity’ is trivial with interface structures, and deriving a method to implement the ‘generalization’ of a neural network is similarly trivial, which would identify the usefulness of ‘random filters’ to fulfill the intent of ‘generalizing the model’)

Functionality to identify useful structures to reduce errors/improve solution metrics, like identify the network configurations and original data sets that would minimize/maximize errors, and finding overlaps in the configurations & data transformations that would cover the most of these error structures, and identifying patterns in these configuration overlaps to identify more optimal configurations/transformations more often in other examples, given the usefulness of patterns as a generalization structure

for example, identify configurations/transformations that minimize/maximize errors with a particular data set, then repeating this process for alternate data sets (or data subsets of the original data set), and identifying the configurations/transformations that are useful in the maximum number of different data sets (the configurations/transformations that overlap as useful among these different data sets), then finding a network configuration/transformation structure that identifies the useful configurations/transformations given an original data set

this applies one neural network to solve the problem of ‘finding useful configurations/transformations to avoid the most errors in the most different data sets, using the original data set as input’, then applying the outputs of that to another neural network to solve the problem of ‘predicting outputs from the original data set input, using the original data set as input and using the output of the first neural network as configuration/transformations’

this applies the workflow of ‘applying solution-finding methods to the problem of applying solution-finding methods in the specific problem of finding a prediction function using the specific solution format of neural networks’

Functionality to identify useful transformations that its weights should support, these transformations being useful across data sets and across problems, such as ‘maximal difference-producing transformations’ (producing the alternate variants of a prediction function that are equally valid but maximally different, to average or merge into one prediction function, or use as conditional alternate prediction functions)

Functionality to identify the data as benefitting from alternate configurations/networks than a standard network solution, such as splitting the data into separate data subsets that would benefit from having their own network to avoid errors like de-prioritizing a less common outlier example

Functionality to identify errors produced by structures like ‘causal loops’ that are variable interaction structures which are not accurately modeled by neural networks, to generate alternate solutions like training multiple networks to predict each variable in the causal loop from the other variables, and integrating the output prediction functions of these networks as input variables to another network, or allowing ‘reverse weight combinations’ where a feature contributes to a preceding weight to create a causal loop in the network (or storing the output variable as a factor to add to the input variable in the next propagation), or including the output as an input variable, or identifying alternate variables to predict that encapsulate the intent of the prediction function better than the original target variable involved in the causal loop, or removing the difference added by an output variable in causing itself to isolate the input variables, and identifying structural changes that fulfill these intents

Functionality to identify & correct conceptual errors with conceptual corrections

the error of assuming a sequence will always have a ‘high probability of ending or proceeding in a particular way’, even when data suggests that the pattern of this sequence is changing, results from the assumption of ‘commonness’ of a ‘current state’ indicating ‘commonness’ of a ‘future state’

if the occurrence of different states than the common state is increasing/differentiating (both being indicators of further changes), statistically that would not indicate the common state will continue to be common

current ml models convert the ‘assumption of the correctness and absoluteness of the priority of commonness’ into other assumptions that lead to incorrect differences (errors)

ml can be built to consider structures that fulfill alternate priorities if there are reasons to consider other priorities (reasons such as ‘previous patterns indicate a change in a variable's average is probable’) until those reasons are invalid, or built to integrate priorities into one structure, or build to apply conditional priorities as needed (storing conditional weights)

these structures can correct a ‘scope’ error structure (assuming the priority of commonness is always correct) and the ‘degree’ error structure (assuming the priority of commonness is not an error or suboptimal state but a solution)

there are other structures of importance than ‘commonness’ which cant be directly integrated into ‘commonness’ be they contradict it (‘initial signals of a change cascade’ contradict ‘common signals’), which could be integrated as ‘initial states’ of a ‘commonness structure’, which would require the ml model to have a concept of ‘state’ applied to its processes, to keep track of its weight state changes to derive structures of change like ‘initial signals of change’ that it detected during learning processes, like when moving in a different direction, or diversifying its weights to integrate handling a new difference, to remember that many or every major change it made started as seemingly insignificant initial signals of change, which would prioritize ‘future importance’ or ‘possible importance’ rather than ‘current importance’ or ‘known importance’

Functionality to identify optimizations like:

identify alternate output formats like ‘vectors that change a base function’ to create the prediction function and inputs that condense those vectors

example: given ‘subset averages’ indicating a vertical change to a function subset, or eigenvectors indicating primary vectors of change in a data set, what vector sets are likely to connect to create the vectors that change the base function into the prediction function, and what filters identify the more optimal vector sets, and how are these vector sets connectible to input data set points (like the ‘subset averages’ and ‘base function’ created from input data set points), to predict change vectors applied to a base function, as an alternate to predicting the coefficients starting from the data set

this reflects an insight of ‘finding a suboptimal solution to base changes on’ by first starting from a base function summarizing the data set, then applying changes to refine it

a variant of this would be ‘alternate the preprocessing and network changes’ to find the changes which are constants (preprocessing changes that should definitely be applied, bc theyre true) and the changes which involve unknowns (changes which should be explored in the network, bc theyre uncertain)

a variant of this would be ‘find alternate condensed variations of preprocessing changes which reflect truths’ to reduce the steps required to preprocess the data in a useful way

a variant of this would be ‘find change vectors that would be interchangeable alternates to summarize a data set and test them on other data sets/subsets to find the vectors that summarize the most data sets’

another format would be ‘maximum point-intersecting lines’, ‘boundary lines’ of a data set to summarize the limits of its changes, ‘tangent bundles’ (sets of adjacent change rates of a curve) to summarize that adjacent change types of a function (included by probability), ‘vector sequences’ to create variation in a data set from base points or base functions of data subsets/sets, ‘bounding functions’ to indicate probable ranges where the solution function should be in most alternate data sets, ‘local linear functions’ to summarize data set subsets in simpler ways given that local subsets are likelier to be connected with fewer variables, than the possibility that all subsets given common structures like phase shifts from threshold values, etc

a variant would identifying the useful intents supported by each alternate format, identifying the unique set of useful intents and how these intents are connected, and integrating these intents & the associated formats in a network structure that uses all of the advantages of each alternate format

a variant would be to dynamically identify useful alternate function formats (sequences of terms) and mapping those formats to the neural network structures (variable components mapping to nodes/layers as weight changes & deactivations), given insights like how variables that interact to contribute to the output variable are likely to have similarities, like a common base/denominator, or insights like how variables can form ‘neutralization structures’ (like ‘added opposites’) that temporarily hide a variable or variable set by negating another variable or variable set, in which case the alternate format also has to have structures supporting that interaction type

identify alternate variable sets that can be used in place of alternate variable sets (like if a variable value is missing or outside the original training set in a way that the category cant be identified using that value, what other alternate variable sets can be used to identify a category)

change order of feature aggregation or change the function ‘aggregation’ to another function like ‘isolation’ or ‘change’

instead of aggregating small to big features, store types of images or store big features like average/base examples of a type, or common base components of a type (eye/ear shapes, fur) and apply changes to these base features

aggregate features by order of variables

once a ‘skeleton’ structure is constructed from features, other structures can be built on top of it, like fur or fur color

this is relevant in cases like missing features, which might be incorrectly predicted by sequential/adjacent pixel data aggregated from small to big features, but might be accurately predicted by ordered feature data, where a feature built on another feature (meaning a ‘dependency’) cant exist if the underlying feature doesnt exist

solve the ‘find a prediction function’ problem not by ‘condensing’ features into representative features like ‘averages’ to reduce steps, but by ‘expanding’ variables into many possible variable combinations & variable components to determine varying contribution size of variables

specify variable values as features of a network rather than variables themselves to further expand it

identify features like lines/curves/colors which can be used to feed a network of ‘differences’ between those values to determine a particular shape (dog/cat) to encode relationships between useful structures like determining features which tend to be medium-sized in between smallest possible features and output label categories

feed sequential data of image pixel sequences to predict next value in sequence, given set of random points on an image, and generate probable dog/cat images based on these sequence probabilities, and use these probable images to determine similarity to a new image

identify structures with a true insight reflecting the actual variable interactions (like ‘adjacent features are likely to predict each other in many cases’), then apply ml to identify the patterns of the interactions of those structures (where the network creates adjacent feature combinations and finds patterns in the combinations that are successful in predicting outputs)

a variant of this applying the ‘opposite’ structure is to identify pattern components that do/dont exist in the data set and use those or the remaining components to form possible patterns of variable interactions (like find a prediction function for data set subsets where ‘difference types’ are estimated by boundary lines or average/base lines to be likeliest to be different, given known difference types like constant/exponential or negative/positive change or missing/present data)

Functionality to find/derive/build functions to translate net/emergent operations of a network like ‘aggregating small into big features’ into variants of those operations like ‘opposite of aggregating small into big features (decompose big into small features)’

meaning, how to translate ‘reverse’ or ‘opposite’ of a network's emergent/net/explicit function (‘aggregate’) into a network configuration, in other words, how to implement ‘semantic relevant automatic generation of neural networks’

such as by keeping the first ‘combine input features’ layers to create as many of the big features as possible, but then splitting & filtering component features after that, to align the input/output data types by adding an opposite operation of ‘aggregate’ (decompose) once the input (big features) is created

for intents like ‘implementing a neural net for each basic core structural operation like combine/aggregate, find/filter, decompose, connect, reduce’ by auto-generating each neural net config for these operations with interface queries, or intents like ‘changing the position of features or filters emerging from a network to maximize filtering or optimize another function like aggregation, such as by changing feature position to maximize explainability coverage of earlier features similar to decision trees’

interface query to implement this ‘find opposite function’ operation

find opposite of function ‘aggregate small features into big features’

‘decompose big features into small features’

find requirements of opposite function

‘big features’ are input requirements

create input of target function ‘opposite of aggregate small features into big features’ (‘decompose big features into small features’)

check for existing structures fulfilling requirement (first aggregation layers)

keep first aggregation layers creating big features

‘small features’ are output requirements

convert big feature inputs to small feature outputs

add decompose operation

add feature split/filter operations to create small features

Examples of additional solution automation workflows

Identify useful structures like filters such as ‘problem requirements’ or ‘problem space requirements’ of solution automation workflow implementations (interface queries) that fulfill various optimization metrics of workflows, filters which are particularly useful be there are many ways to implement a workflow

example: there are many ways to implement a workflow such as trial & error (‘try every possible solution’), involving variables of the implementation such as:

the order in which every possible solution is tried & any parallel subset iterations or iterations from different starting points or in different directions

the solution testing function, indicating how to identify what is a solution (a combination of some items in a set, or an item in a set, or a sequence of items in a set, etc)

the full set of the solution space

not every interface query or solution automation workflow that the query implements will produce the same answer for these variables, although some of the answers are requirements by definition rather than variables, like how applying ‘trial & error’ to solve the problem of ‘find the right block position in tetris’ would have a ‘correct’ solution space of the ‘set of available positions that a block can be fit to (in general rather than for a specific block)’ filtered by ‘requirements of that problem space (the game rules and input problem space “game” state)’ like the ‘requirement to be adjacent to existing blocks’ and the ‘requirement to match the current block structure’

Apply differences to solutions or solution-finding methods like interface queries to format them as a set of requirements/sub-queries/sub-problems, change/function sequences, state sequences, input/output sequences, filter/limit/boundary sequences, format sequences, added structures, variable/function networks, parameterized graph traversals, other interface structure sequences like pattern or causal sequences, or other structures depends on adjacent structures and the requirements of the solution automation workflow & interface query applied, so that new interface structures (describing useful structures like the patterns of these solution structures and the cause of the solution success) can be identified

similarly, whether a solution automation workflow is applied to various problem/solution structures—such as to connect the problem-space and the problem (‘differentiate a problem space so that the problem is easily solved by generating adjacent required functions’) or the problem & a solution (‘convert the origin problem state into the target solution state’) or a standard solution & an improved solution (‘apply changes to an existing solution until its improved’) or a general solution intent (‘find a line connecting subset averages of this data set’) and a specific solution implementing it (code implementing a particular definition of ‘subset averages’)—depends on the problem/solution structures required by that workflow

example interface query of formats, requirements, metrics, variables & filters applied to tetris problem/solution structures:

select solution format as ‘set of states (moves & rotations) of a block’, ‘set of final positions of a block’, ‘set of possible value of other solutions not used (options invalidated or opportunities closed by a solution)’, ‘set of possible positions of all blocks once games is over’

for the ‘set of final positions of a block’ solution format, the solution space is:

‘set of available final positions that a block can be fit to (in general rather than for a specific block)’

apply filter by ‘specifying values of variables’ (such as which block is referred to, in which position) to the above solution space

‘set of available final positions that a specific block (currently selected block, in its current motion trajectory & rotation) can be fit to’

optionally apply variables (moves and rotations) to expand or filter the solution space depending on what filters were previously applied

‘set of available final positions that the currently selected block can be fit to, once all possible changes (rotations and moves) are applied’

optionally apply filters in the form of solution metrics of other solution formats (impact on other future block positions rather than just the position of the current block)

‘set of available final positions that the currently selected block can be fit to, once all possible changes (rotations) are applied, and once impact on solution spaces of next incoming blocks is identified & optimized’

Index particularly useful structures by their interface attributes like ‘cause’ to find the interface structures associated with particularly useful structures to apply by default when selecting useful structures to apply in a workflow

the ‘minimal set’ of ‘maximally different’ structures is more useful than any other arbitrary set of ‘maximally different’ structures

find the ‘cause’ of why some structures of useful structures (like the ‘combination’ of ‘injected’ useful structures such as a ‘minimal set’ of ‘maximally different’ structures) are more useful than others (like a ‘sequence’ of ‘maximally different’ structures)—the minimal set of maximally different structures creates another useful structure like ‘archetypes’ or ‘core structures’ or ‘interchangeable alternates’ be of the way that ‘minimal set’ and ‘maximally different’ are interactive

‘minimal’ & ‘core’ and ‘maximally different’ & ‘unique’ are components/users/alternates/attributes of each other's definitions

these causes of usefulness (‘solution success cause’) may have patterns like ‘allowing a high degree of reduction of input variables’ which is useful for filtering intents, or ‘allowing a high degree of variation without changing its core functionality’ so the structure can act like an interface

once these patterns of useful structures are known, they can be used to find/derive/generate new useful structures, just like the ‘causes’ of useful structures can be used to find/derive/generate useful structures

Apply variables to find/derive/generate useful problem/solution structures like solution filters (‘possibility/probability/requirement’, ‘fulfills multiple general or specific solution metrics’, ‘usefulness for other problem-solving intents than the original problem’, ‘multiple structures of usefulness like causation/reduction/adaptation intents’)

possibility: is it a ‘possible’ structure

are its inputs possible, required, or unknown

is ‘a system or inputs that could sustain/create the solution’ possible

diversity/robustness: does it fulfill ‘multiple’ metrics or fulfill optimization structures across multiple interfaces

most solutions are better when multiple interfaces are applied, to avoid errors like ‘missing a variable be the current system hadnt made the variable isolatable from randomness yet, but the causal interface indicated a variable would soon emerge’, so applying the ‘function/system/cause’ interfaces would be better than just applying the ‘function’ interface, as interfaces can fill in the gaps in information if they exist on one interface (such as where ‘not all functions are found/generated/derived’)

this workflow applies structures of un/certainty (like structures of probability such as ‘commonness’—as in ‘is it a solution in many systems or just one’, and structures of robustness as in ‘can changes be applied without impacting accuracy’, and structures of requirement/importance/usefulness as in ‘would multiple intents benefit from it or is it useful for multiple reasons’) to solution attributes like ‘solution success’ and structures that can be used as inputs to determine un/certainty structures (like ‘usefulness for other intents’) which make it likelier or less likely to be true to find/derive/generate problem/solution structures like solution filters

Find/build/derive different solution structures that enable different problem-solving workflows, to apply as the target output of another workflow

known optimal state (solution state) and deriving functions to get to that optimal state, or reverse-engineering from that solution state, or identifying interim structures between problem/solution states

known functions (like functions that reduce a structure like a problem) to improve problem state toward improved/solution state which can be applied in various structures like sequences to get to the improved/solution state

derive optimal states and derive the states surrounding them to build interaction structures (state sets that can fill the field of possible states)

derive optimal states and other states (like core states) and derive the changes of other states that would produce the optimal states

identify ‘directions of improving changes’ and make changes in those directions until a state is found that fulfills the solution metric value (the core function behind gradient descent)

identify ‘maximal change’ state-changing functions to make changes quickly to quickly identify if a change in a direction is useful

identify ‘optimization patterns’ (like whether a solution state is frequently surrounded by error states or what variables of differences produce optimal states/improvements) and apply to fill a field of possible states with these state patterns

optimal positions (states), changes (functions, differences), patterns (abstract functions) are core structures, and when applied to useful structures like optimization can be used to derive related (alternate/input) optimization structures

a function network to apply changes to the problem/solution can be more useful than a function sequence to connect problem/solution be the function network can make changes in parallel, which may identify an alternate version of an optimal state, an alternate problem that is easier to solve, an alternate solution metric, or another problem/solution structure that may be more useful than a function sequence would have found, even if the value of the function sequence was more obvious in adequately fulfilling a solution automation workflow

out of all the equivalent alternate solution automation workflows (equivalent for their ability to solve problems with variables like available info, problem-solving intents fulfilled, core interaction functions, solution success cause, success metrics of the workflow against various problem types, etc), identify endpoints and changes applied to these endpoints that filter the workflows to find the optimal workflows

identify how to adapt a workflow when one requirement of the workflow is missing

use alternate structures to find solutions (identify input/output structures of a solution to find a solution, identify reason for a solution to exist and a system having that reason, etc)

Identify structures such as problem formats that require minimal information to fulfill a problem-solving intent (problem formats that dont require anything other than adjacent/available changes with known functions) and apply these structures as default structures of a solution automation workflow/interface queries/solution

formats that only require info about ‘differences/similarities’ or ‘input/output examples’ or ‘input/output example differences’ or ‘connection-finding functions’, rather than info about ‘how those variables interact’, in order to solve the problem (apply the solution automation workflow)

for example, accurately representing a problem (in ways that ‘accurately represent all of its variable interactions’) requires the info of those variable interactions as its input, so such a representation isnt particularly useful unless its already known

patterns of differentiating a problem representation with additional info could be useful in automatically connecting approximate/accurate problem representations

‘similar but inaccurate’ structures like ‘abstractions’, ‘un/certainty structure mixes like a combination of a variable & a specific attribute value’ are useful for intents like ‘approximating a solution’

Identify useful structures such as ‘differences’ in standard problem/solution formats like ‘problem/solution differences’ which are useful for problem-solving intents like ‘find if a difference can be resolved (connected/reduced) by a function’

identifying differences between problem/solution that can be resolved/connected by known difference-reduction/connection structures, as opposed to those that cant (requiring that new difference-reduction structures be created), can ‘identify whether the problem is in the correct format’, as well as ‘identify whether sufficient info is available to solve the problem in that format’

this connects interface structures of problem/solution structures with interface structures that make them useful for intents like ‘calculating the structures of difference required to create another difference’ which are useful for multiple problem-solving intents

maximally difference-reducing structures (like high-level functions like organize, standardize, etc) can be applied as an initial step to determine the useful structures of difference like ‘problem/solution differences’ and whether the problem can be solved with those structures or if its in the incorrect format

differentiation: this workflow involves a useful structure of an ‘exclusive alternate condition set’ in the form of the exclusivity between alternate condition structures like ‘condition of maximally difference-reducing structures as solution structures’ and ‘condition of incorrect problem format’, where the alternate conditions contradict each other, forming another useful structure of a ‘contradiction’

similarly, applying problems to such a problem that cant be solved with maximally difference-reducing structures can detect whether the structure has any structure at all or is a structure of randomness

if the info about a problem creates randomness when inputs such as variables or problems are applied, its likely to be inaccurate info

for example, if applying randomness to a data set (applying the problem of ‘making it randomly inaccurate’ by applying ‘random changes’ to a sizeable ratio of the data set), which applies the opposite of the ‘organize’ function, doesnt change the distribution of the data set, it was likely to be random to begin with (lacking structures that would differentiate it from a random set of points), therefore other functions arent required, as the input info is random and the problem-solving intent of ‘find a prediction function’ for the data set is invalid (random data has no patterns except in its probability distribution).

Identify useful structures like priorities that differentiate connected structures like ‘interchangeable alternates’, as fulfilling the intent of ‘differentiating connected structures’ is useful for many problem-solving intents just like its alternates (‘variable connection structures’) are similarly useful

example:

identifying the ‘generative function’ and a ‘description function’ as interchangeable alternates leaves out the info of the usefulness of those functions for different intents

‘generating a data set’ and ‘predicting a data point’ are fulfilled to varying degrees by their common implementations, given their prioritized structures

a ‘pattern-identification function’ might assign an incorrect pattern to a random data set as it priorities ‘patterns’

a ‘generative function’ might better fulfill intents like ‘predict a point’ in a random data set, depending on how it generates points (sequential points, point subsets, adjacent points, differences from averages)

identifying ‘predict an output for a new input, given other inputs/outputs’ is a useful alternate intent to identify as a more ‘structural’ intent variant of the ‘find a prediction function’ intent (‘structure’ useful for adding clarity), and therefore a more prioritized intent than other intents which are interchangeable alternate intents to fulfill in the ‘find a prediction function’ problem space as opposed to ‘find a prediction function coefficient vector of original input variables to predict original output variables’

this intent clarifies the usefulness of the ‘point prediction’ as a useful structure to prioritize in the ‘find a prediction function’ problem space

‘predicting a point from adjacent points’ might be a component function in the ‘predict an output for a new input’ intent, where the ‘find a prediction function coefficient vector of original input variables to predict original output variables’ (predicting adjacent points from a subset of input examples as prioritized in relevance, rather than from all of the original independent variable examples) is less likely to include that function as a component

Identify useful structures like ‘combinations of certainty/uncertainty structures of interface structures’ (like a mix of variables and variable values such as ‘clear differences’) which are useful for problem-solving intents for some cause (like ‘being a variant (like a clear version) of a core structure (like difference) of a function format (like a difference sequence)’, or ‘being a useful structure (certainty/uncertainty mix) of useful structures (interface structures), given that certainty/uncertainty mixes are useful for problem-solving in general’

example: identify useful structures like ‘clear differences’ which are useful for problem-solving intents like ‘fulfilling core functions’ (such as ‘select’, ‘find’, ‘filter’, ‘identify’, ‘differentiate’) which are some structure of usefulness (generally or commonly or importantly useful) or ‘differentiate sub-optimality/error/solution’

‘clear differences’ make core computations like ‘determining difference/similarity’ trivial, so are useful across functions as all functions can be formatted as a set of connections which can be formatted as a set of differences

differences like ‘unit differences’ (such as ‘integer points’ in an ‘area’) or ‘maximal differences’ (such as ‘maximally different function types within a solution metric range’) are useful for ‘identifying changes to apply to identify a solution or solution space’ or ‘identifying base solutions to apply changes to’

differentiation: this workflow identifies the useful structure of a combination of ‘interface structures’, ‘problem/solution structures like problem-solving intents’, and ‘solution success causes’ as components of a solution automation workflow, similar to how ‘structure/intent connections’ are a component of solution automation workflows, on a different interaction level (the interaction level formed by an interaction between different interface structures that can fulfill a workflow, such as by ‘connecting inputs with problem-solving intents’)

Identify useful structures like ‘structure/intent connections’ and ‘functions to derive them’ that are useful for fulfilling solution automation workflows, given that workflows are composed of these structures & this difference created by the ‘component’ & ‘combination’ attributes (‘structure/intent connections are a combination of workflow components like interface structures and problem-solving intents’) creates a different interaction level to generate solution automation workflows at

example: applying the ‘abstract’ interface to a problem-solving request can identify the structures of a ‘problem/solution’ as more useful to solve than the original problem (‘solve the problem of “converting the original problem into a solution” so it can be applied to other problem-solving requests’), just like applying the ‘structure’ interface can identify a structure useful for implementing that intent (‘connect the problem/solution’), which varies the original problem-solving request in two different directions that are useful when changed in those directions, as a ‘structural way to connect problems/solutions in general’ is more useful than a ‘solution to the original problem’ if those two changes are applied to those two components and if there are adjacent structures (like available or easily derived functions such as component/core functions, filtering functions like iteration/testing/comparison functions, abstraction functions like type/pattern-identification functions) that can be applied to fulfill such an intent

this workflow involves identifying variables of useful functions like ‘derivation functions’ which can derive structures (like input/output connections, changes, and combinations of these, such as by applying ‘changes’ to ‘input/output functions’ such as ‘applying abstract/structure interfaces’ to the ‘solve the original problem’ intent to create the ‘finding a solution-finding method’ intent) that are useful to derive, like ‘structure/intent connections’, thereby identifying a new interaction level of variables of solution automation workflows (the interaction level composed of ‘structure/intent connections’ as opposed to the entire workflow or its components)

this can be fulfilled in multiple ways, such as applying an ‘opposite’ to the ‘direction’ (reverse-engineer) when connecting useful structures (like ‘interface structures’ & the ‘intents theyre useful for’)

identify inputs (like available functions) and find intents theyre useful for

identify useful intents and filter by required or otherwise useful inputs of those intents

Identify useful structures of interface structures like ‘negative problem states’ and ‘pre-problem sequences of interface structures (like state, priorities, or errors)’ as useful for problem-solving intents that require more resources or cause errors (intents like ‘predicting & preventing problems’) but are worth the extra possible errors/requirements/sub-optimalities/resources

example: identify that ‘imagination’ is useful for intents like ‘predicting problems’ and ‘preventing problems before they become important, harmful, or impossible to solve (negative problem states)’ and interface structures that can fulfill these useful structures like ‘imagination’ (like functions fulfilling the predict/prevent intents)

identifying the ‘inputs of a problem’ as being useful to know before the problem-solving query is possible when resources are available to identify problem-solving sequences, identify pre-problem sequences, and other useful structures is required to identify that functions other than ‘copy’ are useful for fulfilling solution metrics like ‘robustness’ and ‘adaptability’ of a solution

this applies a variable to the ‘problem state’ that describes its degree of negative impact (from a ‘possibility’ to a ‘system-destroying error’ to a ‘handled error’ to an ‘inconvenience’ to a ‘sub-optimality’ to a ‘solution’)

‘pre-problem sequences’ are structures of cause which may or may not be particularly causative, having variation of causal structures such as the degree of cause (where the lowest degree of cause is only causing an error by ‘using resources’, as opposed to ‘always or directly causing errors through a requirement of an error’), but when applied in various contexts can become causative (‘causative structures of causative structures’)

this involves identifying sub-optimal/error structures that are compatible with a solution of a problem according to solution metrics (like ‘errors within an accuracy range’ compatible with a ‘solution metric (accuracy) threshold value’)

Identify useful formats that fulfill solution metrics like ‘accuracy’ of useful structures like ‘descriptions of useful interface structures like state changes created by a function on a particular interface (like the structural interface)’

example: identify that ‘adjacent areas/squares representing a function input/output connection possibility space (the area of possible solution functions)’ are a useful structure to implement a graphical function representation, to indicate to what degree the function step can fulfill the ‘filter the solution space’ intent, where steps that dont reduce the solution space like ‘iteration’ structures are represented in graphical formats (the whole area filled, a set of adjacent areas representing each item in the input) or the repetition of the input structure (the same function state representation as the previous state)

this structure doesnt describe inputs but rather describes the ‘possible impact on inputs’, which is a useful intent for intents like ‘connecting adjacent function states’ and ‘identifying function intents’ and ‘identifying function change potential’

the problem-solving impact of each function step can be formatted in other ways than ‘reducing an “area” structure’ to represent ‘filtering the solution space’, such as the ‘filters or other structures applied’

Identify structures that are useful for multiple causes (have multiple ‘overlapping intent-fulfilling structures’ or multiple ‘causes of solution success’ or multiple ‘causes of structure usefulness’) as an improved structure of usefulness for problem-solving intents like ‘find useful structures’

example: an ‘overlap’ structure is useful for determining function sets to fulfill an intent

the ‘find’, ‘store’, ‘access/view’, ‘copy’ & ‘apply’ functions are useful as a set of functions when existing functions are sufficient for all intents, which is almost impossible to find in reality, as ‘change’functions are almost always required to adapt existing solutions to a new context or problem

another useful function set is ‘format’, ‘identify changes/differences’, ‘merge’, and ‘reduce’, which are useful for intents like ‘fit into an existing system’, applied for intents such as ‘creating a function index’

these functions have interface structures like ‘overlaps’ in their fulfilled intents & other benefits, their requirements & other costs, as well as other interface structures like the ‘contexts’ in which they are useful (as these function sets can act as interchangeable function sets in many contexts)

‘overlaps’ are useful for identifying common intents, similarities, and other useful interface structures connecting two sets of interface structures like function sets

they are also useful bc of their similarity/adjacence to known useful interface structures like ‘interchangeable function sets’ which are useful for known intents like ‘find alternate structures’

Identify structures useful for intents like ‘connect interface structures’ given the relative usefulness of that intent compared to other problem-solving intents

example: priorities are a useful structure for intents like ‘resolving ambiguities’ (which is relevant to intents like ‘filtering the solution space’) such as resolving the ambiguity between two alternate descriptions of a system with a function network, where one network fulfills a priority better, bc of the core attribute of primary interface structures like priorities which leads to their importance, causative potential, and therefore the probability of their contribution to other structure's attributes/functions

identifying useful structures like ‘importance’, ‘causative potential’, and ‘probability of relevance’ are ways to connect uncertainty structures like the ‘ambiguity’ error to resolve and the certainty structures like the ‘probability of the relevance of one structure as likelier to be a solution (an accurate description in this case)’

these structures can connect other interface structures effectively, accurately, & adjacently and are therefore useful for determining what structures to apply, in the absence of a more directed interface query than ‘find related structures’

the ‘priority’ of the system, like ‘efficiency’, can help filter which structures are likelier to be true (‘if one system network is more efficient than another, its likelier to be an accurate description’), so this ‘priority’ is a useful connecting structure between an ‘ambiguity between alternate solutions’ and a ‘filtered solution space’ or ‘connect interface structures’

Identify alternate structures to fulfill problem-solving intents like ‘find an alternate implementation or variant of another solution automation workflow’

example: apply ‘feedback/response’ structures as an opposite structure to ‘recursive/self-reference request’ structures representing the ‘limit’ on those structures, as a way of fulfilling intents like ‘determining if changes to existing resources are necessary’

this structure can be an alternative in solution automation workflows that use ‘opposite’ structures to determine other useful structures like ‘limits of change of variables of a system’ to make inferences and estimates of other structures like ‘changes within probable limits’

finding alternate versions of a workflow by applying change structures to its components in a way that doesnt violate or fundamentally change the workflow is a useful problem-solving intent

these structures are examples of ‘opposite’ structures in the ‘function’ interface that would be useful for known useful intents such as core intents like ‘find change limits’ or ‘find self-reference limits’ such as when an existing resource is insufficient to fulfill an intent adjacently

Identify useful structures that have a reason to be useful and apply other structures that increase the reasons of that structure to be useful or integrate them with other valid structures that have a reason to be useful

example: applying a ‘randomized’ filter of a solution space that reduces the solution space to n solutions, applied x number of times, increase the chance of finding a semi-optimal solution function with far less required computation, given the usefulness of random selections and the usefulness of extremely reductive filters, and given the probability of a random selection to output a function within a ‘function within a semi-optimal or optimal accuracy range’

the ‘reason to be useful’ is the probable reward/cost ratio of the outputs/impact of each structure applied, both in isolation and when combined in an integration structure

generating a 100 random solution functions using extremely reductive filters that select 10 functions 10 times is likelier to produce a semi-optimal solution function before iterative solution function generation is (improving on ‘trial and error to a slight degree by using randomness and extremely reductive filters’), especially given that ‘iterative solution function generation’ is likely to check adjacent functions in its iterations

the reason randomness is useful in that position and structure is it improves the change of generating/checking a set of different functions in sequential solution function tests, whereas iterative function generation is likely to check similar functions in sequential solution function tests

additional usefulness structures can be applied at various positions, like ‘apply a “difference” filter to generated solutions, to filter out randomly generated function sets that are similar’

this workflow, like other workflows, applies a standard structure like a ‘network’ to problem/solution structures like ‘solution function’, ‘solution space filters’, ‘solution function generators’, ‘solution function iterations’, solution function tests’, ‘solution space’, ‘solution optimality’, ‘solution optimality ranges/areas’, ‘solution computation requirements’

it then finds useful sub-intents like ‘useful alternative problem-solving intents’, & applies structures like ‘randomness’ in the position of the ‘solution function generator’ implementation logic & ‘multiple’ in the position of ‘logic’ applied to the generator logic to increase the value of the random generations, and ‘extremely reductive filters’ as an implementation structure of the ‘solution space filters’, to fulfill those sub-intents

alternate queries to identify useful structures for the ‘find a prediction function’ problem

how to identify that ‘randomness’ is useful in that position, if the other structures are also applied

apply the ‘number of probable computations required in trial & error across various solution functions & iteration variables’ as a ‘limiting requirement’ on possible solution structures, to check solutions for optimality/improvements against, meaning solution structures should be as different from this limit as possible

identifying the usefulness of the ‘quickly identifying a function within an optimality range’ problem-solving intent, as opposed to the ‘find an optimal function’ problem-solving intent

identifying the usefulness of ‘checking different functions’ as an improvement to ‘checking very similar functions’ for the intent of ‘quickly identifying a function within an optimality range’

then checking the input/output structures of available functions to identify ‘highly differentiating functions’ like ‘randomizing functions’

checking for core structures applied to the random function like ‘iteration’ which could optimize its usefulness, without increasing computations to equal the original ‘number of computations’ limit being improved on

how to identify other useful structures, like structures of certainty such as ‘limits’, ‘boundaries’, or ‘requirements’ that when combined or when intersecting, create a shape that acts like a ‘solution template’ or ‘solution range’

apply useful structures like ‘differences/similarities’ to identify multiple boundary limits which create a ‘template’ structure (the solution is a structure somewhere within the boundaries, so the ‘structures required by all possible structures inside the boundaries’ act like a template)

the ‘solution function’ should be ‘different from most randomly generated functions’ but ‘similar to the data set’

these two boundaries act like ‘opposing boundary structures’ to vary the solution between, as the solution is defined to be between them

how to identify the useful structures that adjacently derive the structures to optimize (causes of solution errors, like solution inefficiencies)

identifying the ‘structures that reduce computations’ and the ‘structures that reduce solution spaces’ is trivial once the causes of these structures’ increase (‘adjacent iterations’) are known

applying ‘opposite’ structures to the ‘causes of solution-finding method inefficiencies’ is another way to generate these useful structures

identifying these alternate queries is trivial with the structures ‘difference’, ‘similarity’, ‘limits’, and ‘random’ applied in various problem/solution structures such as ‘solution filters’

this is not a coincidence but is related to the fact that ‘random’ function generators are likely to generate different functions, compared to other functions like a default ‘generate & test every possibility’ function

the concept of ‘random’ is related to ‘difference’, and ‘difference’ is related to ‘similarity’, and ‘different from limits’ is a structure frequently found in other solution automation workflows, such as ‘different from requirements’, ‘different from solution state or solution metric value’, etc

given that these structures are core, common, related, and also related to structures commonly found in highly useful structures like solution automation workflows, they can be derived as useful to apply as possible improvements to a standard workflow

the relatedness of these structures means they are probably adjacent when applied, as in ‘applying randomness to a function’ is likely to adjacently produce ‘differences’, given the relatedness of these concepts, and ‘adjacence’ is a reason that structures are useful, as in ‘adjacently producing useful structures’

differentiation: these structures applied together (the ‘reason’ adjacence is useful, the ‘reason’ structures are related, the ‘reason’ structures are found in useful structures like solution automation workflows) differentiate this workflow

Identify structures that can fulfill problem-solving intents like ‘identify error structures’ to apply in other problem-solving intents like ‘filter solution automation workflows’

example: ‘trial and error’ should be applied when limiting structures (the ‘search space is small’, a ‘solution-checking function is available’, when an ‘error is high-cost/unacceptable’, or other structures of error structures like ‘high cost/reward ratio’ that would be avoided with this workflow) apply, which create a ‘requirement’ to use this workflow, if enough ‘limits’ or enough ‘extremity of limits’ applies to create that ‘requirement limit’

identifying the ‘high cost/reward ratio’ as a useful structure is trivial, given an example of the limiting factors that filter the solution space of workflows so much that it creates a requirement to use ‘trial and error’

identifying ‘requirements to select a particular workflow’ would adjacently derive this ‘high cost/reward ratio’ structure (an ‘attribute value’ of a ‘combination of variable attribute values’)

‘identifying requirements to select the trial & error workflow’ is also trivial given an example simple/unit workflow like ‘trial and error’

‘identifying adjacent inputs of requirements to select the trial & error workflow’ is similarly trivial, especially given the low dimensional search space of basic interface structures like ‘embeddings’ of ‘combinations of attribute values’ and ‘attribute values’ (creating the basic structure of a ‘attribute value of (a combination of attribute values)’) which would identify the ‘high cost/reward ratio’ as a potentially useful example of that structure, and therefore adjacently identify that as a useful structure in ‘finding inputs of requirements to select a workflow’

Identify structures like ‘variable subset combinations’ that can be used as a filter to rule out or identify other impossible/unlikely/probable/required/certain structures, given that ‘filtering possible variable subset combinations’ fulfills the problem-solving intent of ‘searching a filtered solution space’ as it involves searching fewer combinations be the combinations are bigger and fewer possible functions can be built from them, which applies ‘requirements’ to the structure of the problem-solving intent ‘filtering the solution space’

apply ‘reverse’ to ‘requirement’ structures to find ‘inputs’ of a ‘solution space filter’

what is required to filter the solution space—a structure that reduces the number of functions in the space

what is required to reduce the number of functions in the space

reducing variables of the functions

what is required to reduce the variables of the functions

increasing the size of components of possible solution functions

Identify structures of interface structures (like ‘change types’ and ‘change direction’) as other useful structures like ‘requirements’ to be applied in structures like ‘combinations’ to fulfill intents like ‘maximizing their usefulness for solving problems’

example:

a change has to be adjacent in a ‘continuous’ function which is a solution requirement

a change has to move the problem state toward the solution state rather than away from it

however, not every change has to, just all the changes when aggregated

so ‘combining adjacent changes’ or ‘finding net changes’ of a set of related changes is more useful than calculating whether every change improves progress toward the solution

this is be changes that lead away from the solution can be more optimal if they find structures that make conversion to the solution from that other point more trivial than the combination of the extra step away and the conversion

Applying variables like a structure of cause such as a ‘degree of cause’ to identify alternate structures that are useful for solution automation workflows to generate new workflows that dont violate the requirements of the workflow definition

multiple ways to identify that a ‘causal problem’ would be useful for solving the original problem

identify that ‘adjacencies’ are useful as ‘similarities’ and ‘similarities’ are unlikely to invalidate a connection (like the connection between the problem/solution), apply ‘adjacencies’ to create a ‘different but similar problem’, and check if ‘connecting the different problem to the solution’ can still be fulfilled, which is a requirement of the original workflow which ‘connects problem/solution’, or check if other workflows can be fulfilled with the ‘adjacency’ applied to the causal structure formed by the ‘dependence’ and ‘degree’ causal variables

identify that ‘input-output sequences’ are a useful structure and determine the inputs of the problem and whether theyre more solvable than the problem

Identify that ‘solution-finding methods’ are a lower-variable space (involving interface structures in a problem space system), and identify that solving the problem of ‘finding a solution-finding method’ or ‘applying changes to a suboptimal solution-finding method’ is more trivial to calculate (fulfilling the intent of ‘filtering a solution space’), than solving the problem using a suboptimal solution-finding method

similarly, ‘finding useful structures like components/requirements of successful solution-finding methods’ is a more reduced search space

these structures can be identified as useful by applying interface structures like ‘input/cause’ to change the problem into a more solvable problem, given the input concept of ‘solution automation workflows’ or the set of ‘interface structures’ to identify the relatively lower cost of ‘searching generative functions’ than ‘solving the original function’, (requiring interface structures like ‘generative functions’ as input to identify this)

Identify useful structures that can be adjacently connected to other useful structures like problem/solution structures in fulfilling intents like ‘generating new solution automation workflows’

example: a ‘combination of variables and constants’ is useful for resolving the variations based on those constants, as its the problem-solving intent to find the constant structures of these variables which are useful for a related problem-solving intent like ‘connecting variable sets’

for example, a ‘find a prediction function’ solution-finding method may inject constants/certainties like ‘limiting the possible functions to a function range’ while allowing variables within that range to vary, which allocates variables where uncertainties are and allocates constants where certainties are, given that certainties like ‘limits (which act like filters) of possible functions’ are useful for the problem-solving intent of ‘filtering the solution space’

these ‘certainty structures’ can be applied to determine where variables can/cant be applied

determining that a ‘combination of variables and constants’ and ‘allocating constants to certainty structures like “solution space filters”’ are useful independently but also when combined

identifying these structures which are particular useful when interacting in a structure like a combination is useful for problem-solving intents like ‘finding useful structures’

these structures can adjacently produce other useful structures like identifying ‘variable combinations once limits/constants are applied’, so that once identified, it can be adjacently connected to problem/solution structures as a ‘search space of possible functions’

Identify variables of alternate useful structures and check these structures for usefulness in a known problem format like ‘find a prediction function’ using a known solution format like ‘apply neural networks to find a prediction function’

example: the ‘starting point’, the ‘tree structure’, the ‘local change function’, and the ‘boundaries’ of a brain can be used to predict the structure of a brain, as the brain connections follow the same interface/symmetry pattern of ‘applying local changes to a more stable global change’ which can be used to derive the connections once the starting point of the base structure (the ‘tree of symmetries’) is known, and applying this pattern until the known limits (boundaries of the brain) are reached

similarly, the ‘local interaction functions’ of neurons can also be used to determine the connections of a brain, once a subset of data points are known

how to determine these two structure sets are capable of deriving the full set of brain neuron connection info

these change structures can be applied to neural networks to create new network configs/algorithms

train a neural network to predict ‘weight changes’ after a ‘info threshold’ is reached (info about differentiated weights from random or other initialized weights)

train a neural network to predict the ‘weights of a neuron/layer’ from ‘adjacent layers/neurons’

train a neural network to predict ‘emergent filters’ applied by the final neural network model, such as ‘general boundary lines of an optimal function range’, which can be used as a way to filter the solution space

Identify filters of useful info formats to determine more optimal info representations that are likelier to make other intents trivial to fulfill

trees/networks/tensors are useful be they are simple, reflect real structures and real interaction functions, composable, and more optimal at fulfilling more common intents than other structures

identify whether changing the sequence of connected vectors indicating variable changes can be a useful format for representing information in the same structure

storing a high-dimensional data set as a set of connected vectors in a low-dimensional space, where variables are represented as changes in direction, and connected to apply the insight of the ‘integration’ of these variables in the original problem space system, as well as the ‘connectedness’ of these variables in the original problem space system, and reflects the ‘differentiation’ of variable values captured by the ‘unlimitedness’ of the ‘direction’ variable, even if chaining them in a sequence doesnt reflect meaning beyond those similarities

this format would have problems like whether an overlap/intersection with itself has meaning, as these structures would necessarily develop with some data sets and variable connection sequences

it could be filtered by causal dependencies detected in the data, such as co-changing variable subsets being more adjacent in the connection sequence

Identify useful structures to inject differences in, identify variables of those structures, and vary those structures to create useful differences to fulfill the problem-solving intent of ‘resolving differences (creating a difference in a problematic difference, as in a solution)’

example of identifying useful structures like ‘workflow implementation functions’, ‘error structures’, etc and applying variables to these useful structures, given their high-variation:

apply variables to error structures

determine variables to apply to error structures (like over-simplification structures) to convert them into more useful structures

an over-simplification structure is ‘combining common structures’ or ‘identify high-variation structures as important variables’ to create a solution to any problem

identifying limits of the usefulness of this structure (counterexamples) is a way to provide an ‘opposite’ structure to drive the structure toward, which will determine the actual limit of changes to apply in that direction

identifying limits in many directions identifies the changes that can be applied in those directions, as well as directions that changes can be applied in without negatively impacting the solution structure

in summary, identify variables with a determinable limit to their usefulness and apply changes within that limit once the limit is determined, as variables with less determinable limits are less useful

apply structural variables to solution automation workflow in structural formats, like applying a structure variable (‘sequence’ vs ‘set’), ‘position’, ‘dependence’, etc to the components of the ‘break a problem into sub-problems’ workflow, so that the sub-problems can be solved in variable ways, like one at a time in a sequence, all at once in parallel, as inputs to each other, or with an exit condition (until the original problem is solved beyond a certain degree)

this can be applied to the various implementations of the workflow as well (such as by varying the ‘break’ function implementation, implemented as various filter sets to identify structures to keep in a sub-problem, filters like differences in sub-problem attributes like solvability or differences in the problem attributes like a ‘causal problem sequence’ problem structure)

apply variables to standard implementation functions of a workflow

standard functions to implement a particular workflow like ‘convert problem to a more solvable format like a common problem format where solutions are known and apply the solutions once in that format’

identify problem cause (difference/error structures, complexity structures, ambiguities, incomputabilities, etc)

map problem to common problem structure

map the ‘find a prediction function’ problem to the ‘solution embedded in the problem structure’ (solution has fewer variables than the problem inputs), given that a problem cause is the ‘high variable count’

identify common problem/solution structures representing a problematic difference, and convert a standard workflow into each structure so it can be applied to solve it

example:

a problem that is too complicated may need attributes removed to become the solution or more similar/adjacent to the solution (the solution may be embedded in the problem structure), and the solution method is the ‘set of conversions to create that solution structure from the problem’ (implementing the workflow ‘connect the problem & solution structures’)

a problem whose position is very different from the solution position may need functions to move it or the solution, where the solution method is the ‘set of function sets that could fulfill either intent (move problem or solution)’

apply the solution structure to resolve each problematic difference (remove variables until the solution variables are found, then solve for the prediction function with the reduced set of variables)

Identify ‘cause’ of a solution's benefit/cost ratio that justify the errors/costs of that solution when compared with the ratio of other solutions, such as ‘pursuing counterintuitive changes’ in ‘conditions’ like ‘when probable costs are calculatable as lower than probable benefits’, to fulfill problem-solving intents like ‘filtering solution-finding methods’

example: identifying the ‘causal problem’ as a useful problem to solve may change the direction of steps, leading away from the solution (the ‘causal problem’ may be even further from the solution on the causal interface), so it may seem like adding extra steps to solve the problem, but solving the causal problem may invalidate all the steps connecting the original problem and solution, if the solution to the causal problem also solves the original problem (if the solution to the causal problem makes the original problem trivial, such as if they are caused by an equal/similar structure)

filtering solution automation workflows to apply can be done by identifying these structures (the ‘similarity in causal problem and original problem cause’, and ‘whether solving the causal problem is more computable/trivial than solving the original problem’, making a workflow involving solving the causal problem worth the extra steps to identify the causal problem, the similarity, and the computability of the causal problem)

these variables can determine the optimality of a particular workflow, so can be used in identifying optimal workflows and generating new workflows

identifying that structures of cost (like ‘navigating farther away from the solution toward a causal problem, thereby increasing the cost of reaching the solution’) are justified in conditions, like when benefit/cost variables are optimal, implies that when these benefit/cost variables are computable to some degree of certainty, these cost structures can be applied in a solution-finding method (as opposed to only applying generally or commonly useful structures), given the specificity of the usefulness of some structures which creates ‘conditions of usefulness’ that may be useful if theyre computable

checking if these conditions apply, where a structure like a ‘solution to a causal problem’ would be useful, may involve fewer steps (like ‘checking if the causal problem and the original problem have causal variables in common’) than solving the original problem with another solution automation workflow

Identify structures that are useful for implementing a solution automation workflow when applied in a particular position (like as a workflow variable) and abstract the connections between these useful structures and the solution automation workflow theyre useful for to identify variables that can be used to generate these connections trivially, to trivially identify useful structures for implementing other workflows

identifying ‘adjacent changes’, ‘similarities’ and related structures of relevance/usefulness as alternate structures useful for deriving that the ‘causal problem’ may be more trivial to solve is useful for determining how to identify other useful structures, like ‘related but similar problems’, as these structures are useful for finding ‘alternate start/end (input/output) points of a solution automation workflow’ which is a useful structure for solution automation workflows like ‘identify & solve a related problem’

this connects interface structures ‘adjacencies/similarities’ with other useful structures like workflow variables such as ‘alternate input/outputs of a workflow’ as a variable creating a workflow like ‘identify & solve a related problem’

these structures ‘adjacencies/similarities’ can be derived as useful given the definition of ‘related’ which would involve ‘similarity’, and applied to workflow variables like inputs/outputs (problem/solution structures) given the workflow variable that could use these ‘adjacencies/similarities’ as a source of ‘alternate’ structures, as a way of generating new solution automation workflows

Identify useful structures to identify like ‘probable structures’ and apply related insights (like insights about probable structures being useful as more computable alternatives to certainty structures) and apply to interface structures to connect them with problem/solution structures

example: the variables of a causal problem are likely to be variables of the problem, as the connection sequence of variables between the causal problem and original problem are unlikely to resolve/correct those variables

the ‘causal problem’ of the ‘find a prediction function’ problem is the ‘high dimensionality of inputs’, a variable (‘input variable count’) that is a problem in the resulting problem as well (the ‘find a prediction function’ problem also has a problem of ‘solution-finding method inefficiency’ when the input variable count is high)

solving this causal problem by ‘finding representative variables’ also reduces the problem of ‘solution-finding method inefficiency’ in the resulting problem, which becomes a problem of ‘find a prediction function connecting the representative input variables with the output variable’ instead of ‘find a prediction function connecting all input variables with the output variable’

the reason these variables of the causal problem are likely to be relevant in the resulting problem is that they are unlikely to be randomly fixed by the connections linking the problems, which is a rare occurrence

so ‘relevant/important variables’ of a problem can be found by determining that ‘causal problem variables are likely to be relevant in resulting problems’ by applying the insight ‘causal problem variables are unlikely to be fixed in resulting problems, given the rareness of that circumstance’ by applying ‘probability’ filters to identify probable structures (causal problem variables also causing problems in related problems like resulting problems), these probable structures being particularly useful when finding other useful structures, as they provide certainty-adjacent structures to base solutions on

‘identifying & applying probable structures like “unfixed resulting problems and their variables” to find useful structures like “probable connections” (like the ‘connection between causal/resulting problems and their variables’) and “important variables”’ is therefore a useful intent

Identify structures of useful structures using problem/solution structures to generate new solution automation workflows

example: useful structures such as ‘adjacencies’ connected to structures commonly used when implementing solutions like ‘interactive’ structures to the problem/solution structures commonly using those implementation structures like ‘problem-solving intents that use the connect function’

‘adjacencies’ are a specific ‘interaction’ structure, interaction structures being useful as an input/component to build ‘connection’ structures

having structures on varying interaction levels (the ‘structural’ adjacency level, the ‘problem-solving intent implementing’ interactivity level) already derived as connected to problem/solution structures (like the ‘connect’ function in various workflows/problem-solving intents) reduces the requirement to find these structures, identifying these structures as particularly useful to prioritize them as an initial set of useful structures to try

differentiation: this specifies that at least one problem/solution structure has to be in the ‘structure of useful structures’ so these structures can be integrated into solution automation workflows, such as when implementing the workflows, generating new workflows, or designing interface queries implementing the workflows

generalization: identifying that ‘connection sequences’ of ‘cross-interaction level’ structures connected with useful structures like ‘problem/solution structures’ is an abstraction of this workflow, which allows variation to be applied in these structure positions

Identify opposing structures that could convert a problem into a more solvable state, which can be reversed once solved to create the original solution structure

example: structures like ‘break’ and ‘merge’ are opposing functions that can convert the problem into another state (a set of sub-problems) and once solved can convert the solved sub-problem sub-solutions into a structure (solution) on the original interaction layer

another example is the ‘reduce’ (simplify) and ‘expand’ (apply in the more complex interaction layer) function set, which can convert a problem to a reduced version that can, once solved, be expanded into the original interaction level structure of the solution

another example is the ‘randomize’ and ‘organize’ opposite structure, which applies random changes to make a problem more solvable (altered to be a more trivial problem, or so the solution is more robust to more problem variations), which has to then be organized into the original solution format (a generalized solution function, or a randomization-reversal function to identify structure in randomized structures like images with noise)

another example is the base solution (‘state a solution’) and change/improve the solution (‘identify how the solution is suboptimal’) opposite structure, where the base solution makes the problem more solvable, as ‘finding the changes to apply that improve it’ as opposed to ‘filtering possible functions’ or ‘identifying functions describing subsets and connecting/integrating them’

another example is the ‘solution component/input/cause’ and ‘solution assembly/change/dependence’opposite structure, where the solving the problem of ‘find the solution components’, once solved, results in the need to convert those components into the solution format (the ‘assembled solution’)

other examples are ‘assert abstract connections and refine/specify’, ‘vary & standardize’, ‘standardize & compare differences’

solution success cause: the reason these opposite structures are useful is that there are formats which make a problem more trivial to solve, but these formats are unlikely to be the solution format, which means the solved converted problem has to be converted back using an opposite version of the function

many of these involve ‘applying an interface and converting back to the original interface’

like applying the abstract interface in ‘asserting abstract connections’ and then converting back to the original specific problem system

Identify probably useful functions in the problem that indicate useful structures to apply in a solution automation workflow

example: solving the ‘find a prediction function’ problem involves ‘connecting’ the input variables & the output variable, so given that this solves the specific problem, ‘connect’ functions are likely to be generally useful, even when applied in other positions (other structures) of the solution automation workflow, like:

connecting a problem with an even bigger (expanded) problem, in which case the ‘opposite’ function can be applied to identify steps that would ‘reduce’ the problem (solve it), given that the opposite of the ‘expanding’ changes would likely have the opposite ‘output effect’ on the problem as the ‘expanding’ changes had

from this ‘connection structure of the problem & a bigger problem & the solution’, further connections can be derived:

any connection between problem/solution structures can be useful, not just this specific connection between these specific problem/solution structures

a variable is therefore identified as the ‘problem/solution connection structures’, so other workflows can be generated by varying this variable to identify other problem/solution connection structures (connecting problem & solution requirements, connecting problem & solution space, etc)

connecting a base solution function and an optimal solution function

connectible with ‘change sequences’ applied to the base solution function

connecting the data set format with the prediction function coefficient format

connectible with ‘math function sequences’ to convert value set values (vectors) into another value set values (vector) or ‘format-changing structure function sequences’ to convert formats (multiple value sets) into other formats (one value set)

connecting the problem state (‘missing prediction function’) with the solution state (‘having a prediction function’)

connectible with structures like ‘changes applied to the inputs (the data set, the solution requirements, the problem type)’ to generate the output ‘solution state (an optimization point)’

connecting the problem space (‘unfiltered possibilities’) with the solution space (‘filtered possibilities that are possible solutions’) with the solution (‘filtered solution space’)

connectible with a ‘filter state sequence’

connecting useful structures that would fulfill another intent like ‘find a solution-finding method’

connectible with connection structures, useful functions, optimization structures, interactive structures, integration structures, sequential structures, adjacent structures, etc

a reason the ‘connect’ structure is useful even when varied is because the original ‘input/output connection’ structure is similar enough in intent to these other connection structures to benefit from re-applying the ‘connect’ structure (the original ‘input variables’ have enough similarity to the ‘data set format’, ‘problem state’, ‘useful structures like solution components’, etc that they can be replaced with these, if the same replacement is applied to the corresponding original ‘output variable’ structure to generate the corresponding structures being connected to, as in ‘prediction function coefficient format’, ‘solution state’, ‘more useful structures like a solution-finding method’, etc)

another reason is the ‘core’ and ‘common’ and ‘composable’ attributes of the ‘connect’ function (and other functions on this interaction layer like ‘reduce’, ‘break’, ‘remove’, ‘filter’)

another reason is that the ‘connect’ function is one of the functions that can be applied to solve any problem once the problem is converted to a particular format (problems being a ‘problematic difference’ of some structure, which can be definition by resolved by connection structures that produce similarities/equivalences)

this format is particularly useful to identify be once the ‘connect’ function is identified as useful, and problem/solution connection structures are identified, the direction of required changes is clear

for example, once the ‘problem connected to the solution requirements’ is identified as useful, the paths connecting the problem, solution, and solution requirements is clear (‘connect the solution to solution requirements’, and ‘connect the problem to solution requirements’) as well as the sequence of those steps in the path (‘find the solution requirements first’, so the ‘problem can be connected to them instead of the solution’) as a circuitous route to the solution rather than the simpler straight line of ‘connect the problem with the solution’

these reasons of usefulness of these structures can determine other useful structures

Identify useful structures that fulfill functions commonly used/required in solution automation workflows as a probable component of other workflows

example: if a common useful structure is ‘change the intent structures like the output/direction’(applied in workflows like ‘solve a different problem’ or ‘solve a different solution’ or ‘find an approximate solution’) which is often used in workflows, store that structure and use it to generate new workflows

another example is ‘change the connection structures (find an alternate route between structures) without violating equivalence (interchangeable alternates)’

another example is ‘changing the position of a structure’ like applying a solution automation workflow to connect the problem & solution space, rather than the problem & solution, which fulfills the intent of ‘reducing the search space’ as it applies filters but doesnt complete the filter sequence, which is a variable that can be applied to the ‘connect problem/solution with filter sequences’ workflow

varying the ‘completeness’ of a workflow is a way to generate workflows that are more computable, quicker, better at generalizing, better at over-specifying/over-filtering solutions, better at providing conditional/alternate/multiple solutions, or otherwise optimizing some solution metric

this can be identified by finding an ‘alternate path’ to generating this useful structure of ‘changing the position of a structure’ when applied to workflows (‘connect the problem & solution space’, placing the ‘solution space’ in the position of the ‘solution’ in the workflow), at which point, the ‘completeness of a filter sequence’ is clear as being variable, and its benefits can be similarly derived by identifying problem-solving intents this variation fulfills more optimally than the original (like in cases where a conditional-alternative solution structure is better than one static solution, and when the workflow can filter the solution space to an extent that this structure is useful, meaning there arent an extremely high number of possible alternate conditional solutions, or where computing the solution to use in a condition is trivial)

these variables (‘position’, ‘intent’, ‘direction’, ‘accuracy’, ‘completeness’) are particularly useful when combined with other structures and applied to useful problems like ‘finding new solution automation workflows’

differentiation: this workflow involves finding & storing the optimal combinations of these variables & structures as useful structures to apply to fulfill problem-solving intents

this workflow can be further refined with variables like ‘relevance for a particular problem format, problem type, problem frequency, and solution attributes like computability’, as some structures generated by this workflow would be better for some problem types (with fewer variables, like ‘generate new solution automation workflows or solution-finding methods to find a prediction function’) than others (‘find a prediction function’)

Identify interface structures like ‘cause of solution success’ in very useful problem-solving intents like ‘identifying new solution automation workflows’ (interface structure combinations that fulfill requirements of a workflow and requirements of workflow components in some optimal way) and apply that cause as filters of solution automation workflows

example: ‘identifying a useful structure and finding a new way to derive it or connect it to other useful structures’ is a common generator of solution automation workflows, which is particularly useful to identify

a specific example of this workflow is ‘identify a useful structure like requirements and find a new way to connect it to structures that are likelier to be available/computable, like available functions, as a way of fulfilling problem-solving intents like “determine structures that definitely exist in the problem space” (to better describe the problem space, making it more solvable) by applying those requirements’

another very useful structure to identify is the ‘level of abstraction’ & other structural variables connecting the structures composing solution automation workflows which make these particularly useful workflows for solving problems

example: what structures determine/connect the problem-solving intent and the interface structures and the interaction functions and the problem/solution structures of a workflow that make that workflow particularly useful for solving problems, more than other combinations of interface structures? in other words, how could you derive the structures that will be particularly useful in combination when positioned as these components of a workflow?

some variables determining optimal positions of interface structures in solution automation workflows have been documented already, as structures of usefulness/relevance, including other specific structures like:

input-output sequences between sequential steps of the workflow:

the interface structures generated in one part of the workflow which are used as inputs in another part of the workflow (like when fulfilling the problem-solving intent that references those structures generated in another part of the workflow)

definitions: structures that are more clearly defined are more useful, which can be used as a filter of useful structures or a filter of possible solutions (the solution that is definable/structural/computable is the more optimal solution)

structures of usefulness like adjacencies & other efficiencies: a structure that reduces the work required in another part of the workflow

relevance structures: structures that are relevant to another structure, such as being an input/requirement/component of another structure (like a solution requirement)

generation/derivation structures: more optimal/alternate ways to generate/derive structures

variables/change structures: finding variables of a useful structure like a workflow, or, to apply input-output sequences or causal chains, variables finding variables finding useful structures like a workflow, etc

useful structures for fulfilling specific known variable values, like a structure that is useful for fulfilling specific problem-solving intents

determining interim connecting functions or functions on another interaction level, which is useful for describing a set of all useful functions on different interaction levels, where a problem can be solved as an alternative to another interaction level with fewer knowns functions, and where interim functions are useful to compute for determining an abstraction level of a function or some other function metric that is useful for solving a problem and solving the problem with functions found/built/derived as having that attribute value, and useful for other intents like ‘implementing a general function like ‘merge’ with core functions like ‘reverse’, ‘replace’, ‘vectorize’ (core functions being a different interaction level of functions, this interaction level being possibly more adjacent to implement the high-level function on than the original or another interaction level)’

not every combination of interface structures would be a problem-solving workflow, its only those combinations that fulfill the requirements of a workflow (‘being a new way to derive useful structures’ fulfills the workflow requirement of ‘fulfilling a problem-solving intent’, which itself has requirements like “being an intent that improves on ‘trial and error’ in some way”)

a variant of this workflow would be to apply other solution automation workflows given these structures causing workflow success, (apply workflows that involve requirements now that workflow requirements are more clearly defined)

Identify useful structures like ‘alternate verification methods’ for intents like ‘finding certainty structures (like proofs, insights, facts)’ which are useful for common variants of problem-solving intents like ‘connect a problem/solution with known structures for solution metrics like accuracy/reliability’

example: one verification method is to check all possible inputs to test if the outputs are expected by the hypothesis function that connects inputs/outputs

another verification method is to check a representative sample of possible inputs

another verification method is to identify possible causes of why the hypothesis function might be correct/incorrect, such as ‘requirements’ already verified that require it to be correct, and connect these causes with the hypothesis function using logical structures like assumptions/requirements/possibilities/causes, and filter these causes instead of filtering possibly true hyptohesis functions

these alternate methods of identifying certainty structures are useful for intents like ‘find certainty structures to base a solution on’ or ‘identify if certainty structures can connect a problem/solution (rather than deriving missing uncertain structures)’

these alternate methods apply solution automation workflows to solve the problem of ‘find certainty structures’, which is useful for other problem-solving intents

a related workflow is determining variants of problem-solving intents that there are known or trivially findable/derivable/buildable useful structures to fulfill, such as problem-solving intents that optimize for a particular optimization or solution metric, which may use a particular interface structure to fulfill that metric

once these variants of problem-solving intents are found/built/derived, they can be fulfilled with variables applied to the interface query/queries fulfilling the original problem-solving intent, as these structures are a useful structure of a ‘corresponding’ or ‘reflective’ structure (the interface query implementing a problem-solving intent in a workflow is a structure that reflects/mirrors the problem-solving intent/workflow it implements, as it retains some of the info of that intent/workflow)

a related workflow is identifying useful structures such as ‘reflective’ structures which can be used to avoid ‘structural similarity queries’, as theyre the results of ‘structural similarity queries’ which have corresponding attributes/functions in the corresponding reflective structures, and extend the ‘structural similarity’ as the reflective structures are related by definition rather than only by structural similarity

a related workflow is identifying the outputs of interface queries to find/build/derive/apply useful structures, such as how the outputs of an interface query to find ‘structural similarities’ would be useful to store, as useful structures in and of themselves

Identify useful structures like ‘adjacent interaction levels’ such as how ‘prepare’, ‘respond’, ‘fix’ are adjacent functions on the same interaction level, a level that is adjacent to other function interaction levels having functions like ‘handle’ which are more abstract, as these functions are components of the ‘handle’ function which is why theyre adjacent and useful (‘building the handle function’ is simpler when you have a ‘prepare’ function to prepare for an error/input)

another example is concepts on an interaction level adjacent to a solution, such as ‘concepts directly composing a solution concept’, like how ‘infinite series’ are a useful concept for ‘integration’ problems and ‘derivatives’ are a useful concept adjacent to solving ‘find change rate’ problems

this workflow involves applying ‘cause of solution success’ to identify interaction levels that are useful be theyre adjacent in some way like being ‘direct components/inputs of a solution structure like a solution requirement or interface structure that is required in an optimal solution implementation’

differentiation: this workflow focuses on the ‘cause of solution success’ applied to the problem of ‘finding useful structures’ such as adjacent structures, focusing on the reasons why these structures are adjacent and therefore useful for determining the solution, reasons such as being ‘direct components/inputs’ of the solution structure

Identify useful structures like impossible structures, given intents that are useful but difficult, as impossible structures are useful for determining limits, and difficult structures are likelier to be adjacent to these limits

other structures of difficulty exist, such as ‘complexity’, errors like ‘missing information’, ‘solving a problem without being given an interaction level of concepts that are adjacent to the concepts required to quickly solve the problem’—impossible structures are another example of a structure of difficulty

differentiation: this workflow applies variables to useful structures find other useful structures (applying variables to attributes like ‘adjacence’ to determine different structures like ‘difficult’ that might also be useful for some intents), applying the insight that ‘there is not usually one reason why a structure like adjacence is relevant to an abstract concept like usefulness, there could be other reasons/interactions like opposite which indicate non-adjacent structures like difficulty structures are useful’ or alternatively ‘there is not usually one way that an abstract structure like usefulness takes shape in a particular system like the structure interface’, to derive the existence of ‘alternate useful structures’ which may have a ‘contradiction/opposite’ structure relating them to another useful structure, as these contradictory useful structures are useful in different contexts

a related workflow is to identify variants of useful structures like structures which are ‘conditionally useful’, such as only being useful in ‘opposite/different contexts than a structure which they contradict’, and use these to filter useful structures and to generate alternate useful structures

Identify structures that dont contradict each other, as possible useful structures like interaction/coordination structures, given that difficulty structures arent necessarily false/truth structures or un/certainty structures, just like simplicity structures arent, given that the definition of neither concept contradicts the other

this applies a ‘requirement’ structure to find structures that are required to fulfill some intent like ‘having a specific structure’

this workflow applies variables to suboptimal workflows to improve them, applying variables to suboptimal workflows like ‘the simplest solution is the best solution’ to change them in a more optimal way that better reflects truth

alternatively, this workflow applies variables to structures like ‘contradictions’ which are useful for intents like ‘finding opposing implications/outputs (structures that make another structure impossible given the requirements/implications/outputs/etc)’, given that variants of a useful structure are also likely to be useful

differentiation: this workflow identifies adjacent structures like ‘not definitively contradicting structures’ of useful structures like ‘contradictions’ to find structures fulfilling different intents than ‘contradiction’ structures fulfill, such as ‘coordination’ or other interaction intents, to fulfill useful core intents like ‘find structures that co-occur’ or ‘find structures that can be combined’ or ‘find structures on the same interaction level’

Identify useful structures like error structures such as ‘hidden barriers that limit functionality’, such as when a function is the same as another function but doesnt have the same functionality, given error structures like ‘hidden barriers in place preventing its functionality’

these error structures are useful in that they connect interface structures such as errors with specific interface structures like functions and conditions for identifying the error, which is more useful than just storing error structures

a structure that ‘would’ fulfill a function in a standard system or in isolation of a particular context, but ‘does not’ fulfill that function, is an example of a structure that could have a ‘hidden barrier’ error structure

error structures can be derived from identifying assumptions of a structure that are not fulfilled be of how the expectation was constructed

assuming a structure to retain its functions/attributes in a system compared to the functions/attributes in isolation of a system is an unrealistic expectation that doesnt integrate required structures like a ‘system context’ where the structure is found

‘structures that dont integrate required structures’ can be identified as possible sources of error (like when a dependency is tested in isolated and then applied to a system)

‘required’ structures are ‘realistic’ structures, so the reason this structure is likely to cause errors is be its unrealistic in the definition route of ‘not integrating required structures’

determining alternate structures that could fulfill an error structure is a useful intent that can be fulfilled once specific interface structures connected to error structures are identified

differentiation: this workflow derives useful structures related to error structures like ‘causative assumptions’ and ‘structures likely to be found connected/adjacent to the error structure’ and the ‘probable inputs/outputs of the error’ and ‘enabling functions/structures of the error’ that make the variant of an error structure in a particular system/interface more trivial to identify, as the related structures may be more identifiable than the error structure itself

Identify useful structures like ‘adjacent structures with similar outputs/intents’ as other useful structures like ‘possibility filters’

example: if a structure is suddenly ‘invisible’, possibilities like that it ‘disappeared’ can be ruled out as impossible, given that physical laws prohibit such a possibility

however, other structures like the ‘invisible’ attribute are possible given the possibility of fulfilling a ‘visibility change function’ such as an ‘obscuring function’, given that visibility is a variable and can therefore be changed like all other variables

structures that could fulfill such a ‘visibility changing function’ include ‘hidden mappings’ which map info or info components to other hidden positions than their original positions, or obscuring structures such as structures bigger than the structure to obscure positioned in between the observer and the structure being obscured

‘determining if a hidden mapping is possible’ is similar to ‘determining if invisibility is possible’, but determining ‘hidden’ is more possible than determining ‘disappeared’ structures

an alternate to a ‘possibility filter’ is a structure with similar outputs, like ‘requirement filters’, ‘filters using known fact similarity/confirmation/compliance’, ‘contradiction filters’, which can be identified as useful alternates using the similarity in useful structures like outputs for intents like ‘find alternate structures’

a ‘hidden’ (possible) structure and a ‘disappeared’ (impossible) structure both have similar outputs (‘the structure is not visible’), and useful for similar intents, so finding structures with similar intents/outputs of impossible structures can reveal their possible counterparts which are useful for some intent

differentiation: this workflow involves identifying useful structures that are useful to relate to or store with other structures, such as storing the outputs/intents (or similarities of outputs/intents/other interface structures) of a set of structures to fulfill intents like ‘determine alternative structure to use when one structure isnt accessible’, given insights like ‘outputs are a proxy structure of intent, given that the outputs of a function may be the intent of using that function, so storing outputs can fulfill intents like “identifying what intents a function can be useful for”’

Find variables to identify useful structures like ‘alternate interchangeable interface queries’ to fulfill problem-solving intents like ‘implement solution automation workflows optimally’

example: the optimized interface queries like those in the below workflow can be derived with commonly useful interface structures as variables, like:

input/output similarity

logic similarity (‘find an example of relevant structures like inputs/outputs or solutions and find a pattern/structure/change fulfilling common intents applied to those structures, intents like ‘connecting’ them’)

finding interface structures of known problem/solution examples

applying alternative interface structures (‘patterns’ being an alternative to the ‘useful’ interface be patterns are a useful structure, as indicated by the fact that theyre a primary interface) as variables to generate other interface queries likely to be interchangeable alternates

differentiation: this workflow focuses on identifying useful structures like ‘alternate interchangeable interface queries’ that are useful for workflows like those that ‘find optimal interface queries implementing a particular solution automation workflow’, given that ‘interface queries’ are an input to those workflows

Identify structures that can be applied to implement solution automation workflows optimally

example: the solution automation workflow ‘apply changes to a base solution to find an improved solution’ can be implemented in many ways, many of them suboptimal, involving such methods as applying any change, which creates a large solution space to search

optimal structures like ‘interfaces’ can be applied to restrict the implementation of this workflow to interface queries that are likelier to be successful

applying the structure of an ‘interface’ to the ‘base solution structure’ restricts changes that alter the base solution, but not so much that its identity fundamentally changes

for example, a linear representation line of a data set changed to have curvature would still resemble the original linear function, in its general change type of an ‘increase’ or ‘decrease’, and may retain other similarities like similarity of its endpoints/averages to the new function endpoints/averages

identifying an ‘interface’ as a useful structure to apply to a ‘base solution structure to apply changes to’ is as simple as retrieving the definition of structures, and finding structural similarities between the ‘base solution’ and an ‘interface’, which is a structure on which changes are applied without breaking the structure itself

without these definitions, the ‘interface’ structure can be derived as useful by identifying that through interface queries:

apply the ‘pattern’ interface to known problem/solution examples: usually base solutions arent changed much in their improved variants (low change rate that doesnt change certain attributes like averages/general change type beyond a certain degree), so a base solution probably shouldnt be changed much in whatever interface query implements this workflow

alternatively, derive this by applying the ‘structure’ interface to identify these ‘limit’ structures of ‘change’ structures between these base/improved solutions

apply the ‘useful’ sub-interface of the ‘meaning’ interface to identify that a ‘base solution’ would only be a useful structure if it was similar/adjacent to the improved solution, otherwise it would create high computation costs

any of these interface queries could replace the definition of an interface+an interface query to find ‘structural similarities’ between definitions, to find corresponding structures to apply in similar definitions

Identify interface structures that are useful to identify which make other problem-solving intents like ‘find useful structures’ trivial to fulfill

example: extreme changes can be applied to a function that fulfills opposite intents than ‘representing’ a data set to generate a function likelier to fulfill ‘representation’ intents, and small changes can be applied to a function that fulfills similar intents to ‘representing’ a data set

this applies changes at the level of interface structures like the cause of why a function is successful (it ‘represents the data set’) for an intent without interface structures like ‘find the prediction function’, fitting changes according to the level of change required to produce a similar or different function, using changes to connect functions known to be different/similar on an interface structure metric like ‘intents fulfilled with interface structures’

this workflow finds interface structures like relevant structures such as the ‘cause of a solution success/failure’ and applies functions to connect those interface structures found (‘representing a data set’ intents of the solution function solving the ‘find a prediction function’ problem) given that those interface structures are likelier to be a better base for change than the non-interface structures stated in the problem (‘find a prediction function’), given that the relevant interface structures reflect understanding and meaning like the cause of why a solution is successful, and encapsulate more information about the problem than the original problem statement, given that ‘representation’ of a data set can be implemented by finding structures with less information than the data set (the prediction function, data set statistics like averages and distributions) which summarize/fit/represent the data set to the extent that it can be used as an explanatory/prediction structure of the data set, since ‘representing a structure’ is likely to have usage intents like ‘reduce info needed to describe/explain a structure’

this workflow finds the most ‘aligning’ (relevant) structure with an intent (‘representation structures’), once that intent is derived (once ‘representing the data set’ is found to be a useful intent for ‘find a prediction function’)

once these useful aligning structures are found, other workflows can be applied to these structures, like ‘find a base solution to apply changes to in order to find an improved solution’, as the changes between a ‘known error’ (like ‘randomizing’ or ‘non-representative’ or ‘obfuscating’ structures) and a ‘similar solution’ (like structures that ‘summarize a data set’) would be known at least in their degree of difference, which is useful in generating different structures like solutions to the original problem

example: a ‘random point selection function’ is less likely to be a part of a ‘regression’ function, given that ‘regression’ functions dont require random structures, unless theyre approximation solutions (similar solution to the ‘find a prediction function’ problem, with solution metrics like accuracy for the original data set), or have requirements like ‘robustness of the solution function across different data sets’, which isnt part of the standard ‘regression’ solution requirements

so a difference applied to the ‘random point selection function’ is likelier to be part of the ‘regression’ function solution (the solution function, which finds a regression line, as in a solution-finding method for the ‘regression’ problem), such as an ‘opposite’ difference type, which would produce structures like a ‘sequential point selection function (iteration in a direction)’, which is likelier to be involved in a regression solution function given the relevance of adjacent data in determining useful structures like local averages, sequential change rates, and local prediction functions (predicting the next item from the previous n items, as opposed to a prediction function which may predict an item from all other sequences of data points), which a ‘random point selection function’ treats as irrelevant unless used in a specific position, where the ‘sequential selection function’ is likelier to be useful when applied in more positions of a possible regression solution function

differentiation: this workflow involves identifying interface structures that are useful in generating certainties, like how intents such as ‘randomizing’ are different from intents like ‘representation’, so that structures of ‘representation’ can be derived from ‘randomizing’ structures using adjacent transforms like ‘opposite’, using these certainties generated by useful structures (like ‘meaningful interface structures of solution success cause’) as an input to other solution automation workflows like ‘apply changes to a base solution to find an improved solution’

Identify useful structures like ‘structures commonly produced by various solution automation workflows that prioritize finding useful structures’, given the usefulness of structures like ‘commonness’ as a proxy of determining other useful structures like patterns and related structures like relevance/importance, and the increased usefulness of these structures when applied to structures like outputs of useful processes like solution automation workflows

example: the common outputs of solution automation workflows like ‘find core/common/composable structures, given the usefulness of these attributes’ and ‘find adjacent transforms like combinations of useful structures like core structures given the usefulness of adjacent transforms like combinations of useful structures’, these having outputs in common like ‘tensors’ or ‘interfaces’, and this commonality is a useful signal of the truth and importance of these structures, given the usefulness of repeated structures like common structures and patterns for intents like ‘predicting next/future/caused/created structures’, which can be derived as useful by applying the ‘opposite’ structure to the known useful structure of ‘dependency structures’ (finding previous/past/causal/creating structures of a structure)

given that these useful structures (‘tensors’, ‘interfaces’) are determined to be useful by multiple & simple/adjacent & core workflows to find useful structures, that indicates theyre more useful, given the usefulness of these attributes for useful intents like ‘composing structures’ (simple structures are likelier to be composable)

Identify & apply useful structures like interfaces that align with useful structures like problem-solving intents to describe useful structures like variable interactions which are useful for other problem-solving intents like ‘describe variable interactions (change types, related changes) in the problem space’

example: apply useful structures like core structures such as ‘interfaces’ to a problem space (like the graph of a data set) to identify useful structures for common intents like ‘describing/explaining/identifying alternate sets of change types (alternate variable sets) in the data set’

an interface has a structure of ‘changes applied to a foundation’ (where changes applied on that foundation dont invalidate the foundation, therefore the ‘foundation+change’ structure fulfills the ‘change invariant’ definition of a symmetry), which structurally looks like a structure such as a horizontal foundational line with a vertical change applied to it (similar to a tensor shape) like ‘_|_’ or ‘-|’ which, when applied to a data set, might depict the meaningful interim change types present in that data set

this structure is useful for ‘finding related orthogonal vectors’ which is useful for problem-solving intents like ‘find changes that when applied to a base solution improve the base solution’, such as vectors applied to a base linear function that improve that function's ability to represent a data set

a data set described by these vectors is likelier to identify explanatory change types (variables and variable interactions) in the data than traditional methods like ‘finding coefficients of a line of best fit’, which may identify coefficients/exponents/operators to create a line of best fit function, but the change types in that function may not align with the explanatory variable interactions of the data set, even if they have a coincidental overlap, as a ‘line of best fit’ doesnt mean a ‘representative/explanatory function’, it just approximates one or provides a semi-useful alternate to one

this structure is useful for various reasons, such as being common, being core/foundational, being similar in structure, being composable, being descriptive, being useful for common intents like ‘finding independent change types’, ‘find related change types’, ‘find dependent change types’

a variant of this workflow would be to identify structures that are useful for more reasons than other structures & apply those structures

another variant would be to identify alternate routes to deriving these useful structures, like identifying core structures (such as tensors) derived by applying changes to core structures, like ‘multiple lines in different directions with a common endpoint’, applying ‘multiple’, ‘different’, and ‘equivalent’ change types to the ‘line’, ‘direction’, and ‘endpoint’ structures

generalization: an abstract variant of this is to find structure that align with these problem-solving intents (an interface structure obviously aligning structurally with the ‘apply changes to a base solution to improve the solution’ problem-solving intent, due to the common usage of a ‘base/foundational structure’ to ‘apply changes to’)

a variant of this would be ‘identify the structures describing a solution (like the ‘complexity’ structure embedded in a ‘curve’ being likelier to explain a data set than a linear function) and apply those as requirements of a solution

“a solution is within some degree of change applied to ‘complexity’ structures as solution requirements without invalidating those structures, using those structures as an interface to apply changes to without changing the foundation of those requirements”

differentiation: this workflow applies the ‘meaning’ interface to identify the reasons why a change type would be useful (they depict interim variable interactions more semantically related and adjacent to the representative/explanatory function, rather than input variable interactions which are related to the explanatory function using operators/coefficients/exponents that may not actually indicate meaningful variable interactions) and apply those reasons to describe changes in a different way than theyre normally described

Identify structures like ‘integration’ structures which are useful for problem-solving intents like ‘combine existing solutions to create new solutions’

example: ‘integration’ intents can be fulfilled by functions like combine, mix, merge, apply, inject/embed, use, overlap, and other core interaction functions

deriving these functions, variants of them, their variables, and alternate implementations of these functions is useful for fulfilling intents like ‘combining existing solutions to create new solutions’, which is an alternate to intents like generating solutions using solution variables to create new solutions, applying changes to a base/standard solution to create a new solution, etc

once derived, these functions can be applied to input structures like solutions

for example, a default implementation of a ‘merge’ function might be to include all unique attributes/functions of both solutions, and to create ‘merge’ variables capturing differences in attributes/functions

another implementation might be to abstract the solution object so its variables can hold both copies of the solutions rather than merging them, such as abstracting the solution to a ‘solution example set’ or a ‘solution set’

another implementation might ‘combine’ different values of attributes/functions, such as by creating an aggregate, average, or other combination structure, or ‘similarize’ different values of attributes/functions

another implementation might be a generative structure that generates these two alternate solutions when given their inputs

these alternate implementations (‘standard/base’, ‘generative’) are useful for different intents (‘change a base solution until its more optimal’, ‘generate alternate solutions’, ‘retain original solution info’, ‘retain representative (average) solution info’), which can be selected for if the problem-solving intent is specified according to structures like requirements

this workflow involves identifying useful structures like ‘integration’ structures, useful positions to use them in (‘combining solutions to create new solutions’), and intents these structures are useful for which can be used as a filter of these alternate integration structures, as opposed to other problem-solving intents like ‘applying changes to a base solution’

Identify useful structures to find/build/derive a solution structure (like a function/rule) and apply them in an integrated solution which fulfills more solution metrics given that specific structures are usually useful for one solution metric at a time

example: structures like high-variation-capturing structures across interfaces (intent, requirements, opposites, networks) which are not explicitly variation structures (variables, functions) are inherently useful, and everything can be formatted in terms of these structures, but other structures are equally useful, such as derivation structures (deriving changes using available info and info connection structures), connection structures (connecting changes), generation structures (generating structures like variables or high-variation capturing structures), invalidation structures (invalidating changes), change-creation/control structures (creating changes) which can act like interchangeable alternates to these useful high-variation-capturing structures

similarly there are other structures which can replace a useful structure, like how ‘exceptions to a rule’, ‘rule requirements’, ‘rule assumptions (input constants to finding/deriving/generating the rule as useful for the rule intent)’, ‘rule input/output examples or base rule implementation examples’, and ‘general rule patterns’ can be used to fulfill intents like ‘derive the rule’

deriving these structures which are useful alternatives can be implemented by applying interface structures, for example:

the ‘opposite’ of a ‘context’ requiring the rule is where the rule doesnt apply, as in an ‘exception’

the ‘requirements’ of a rule determine its ‘differentiating variables’ from other rules and the ‘input-output connections’ it has to express in/directly and differently from other rules

the ‘assumptions’ of a rule can be used to determine what ‘components/inputs’ the rule can use (components/inputs which are alternate determining variables to the logical steps implementing the rule), given the context implied by those assumptions

the ‘examples’ of a rule or its ‘determining structures’ can be used to derive a ‘variant’ of the rule (like a specific/abstract version of it)

‘general rule patterns’ can determine ‘probable structures’ implementing a particular rule, which can be modified with ‘change patterns’ to implement its solution

these structures are more useful when used together to create implementations that fulfill the ‘solution requirement’ using more than one useful structure, as some of these solutions contradict each other but are likely to be components of more optimal solutions that fulfill multiple metrics, bc by definition a set of solutions that fulfill one metric optimally are suboptimal compared to solutions that fulfill more than one metric and/or superior metrics

for example, a solution that fulfills the examples, requirements, and exceptions that determine a rule is better than a solution that fulfills one of those structures

so these interchangeable alternate methods of deriving/finding/generating a structure are useful when integrated (like an ensemble method) bc they usually optimize for one solution metric, even if there is some overlap in metrics optimized by a particular derivation/finding/generation structure

Identify useful structures that reduce some problem structure (like a difference) to fulfill problem-solving intents like ‘reducing steps required to solve a problem’

example: ‘checking every item in a filtered set’ or ‘checking every item in a set until a solution is found’ involve applying useful structures (‘filter’, ‘iteration exit condition’) that reduce the steps required to implement a base workflow like ‘try every possible solution’, since these useful structures reduce the steps required

‘filter’ reduces the number of solutions to iterate, the difference between the ‘number of solutions to check’ and the ‘optimal solutions’ being a useful problematic difference to reduce

‘iteration exit condition’ reduces the number of solutions to iterate, the difference between the ‘last solution tested’ and the ‘last solution in the set’ being a useful problematic difference to reduce, given that a threshold to determine the optimality of a solution is available (to determine that an optimal or sufficient solution has been found and no more solutions should be tried to improve on the threshold value)

deriving a ‘filter’ or a ‘iteration exit condition’ is trivial once these differences are identified as useful differences to reduce, given that these differences present a problem in the form of requiring more resources than is absolutely necessary

differentiation: this workflow involves identifying the differences as ‘problematic but not required’, and identifying/applying the structures which can reduce those differences to fulfill the problem-solving intent of ‘reducing the problem’

Identify useful structures specific to a specific problem format in which all problems can be formatted (like ‘find a prediction function’) and apply as components/inputs to a solution automation workflow (like ‘identify adjacent/probable solution components and apply them to build a solution’)

example: ‘change rate connection’, ‘adjacent subset average connection’, and less relevant objects like ‘line-data set intersection connection’ patterns are useful structures to determine a prediction function, given the different information they use and contribute to determining the error-reducing function

‘change rate connections’ between adjacent change rates are useful bc they encode info about adjacent probable changes, which is useful for filtering possible functions

this can be made more useful by finding the ‘change rates in high density areas’ which are likelier to be ‘accurate change rates’ or ‘influential change rates’ present in the output prediction function, given the contributory influence of density as a structure of usefulness in determining the output bc of its ‘probable proportion of truth’ and as a result, ‘influence on truth’

‘adjacent subset average connections’ are similarly useful bc averages encode info about surrounding data points in the subset

these structures can be made more useful by filtering which subsets are used, using isolatable subsets that are particularly likely to have an accurate average (given that the reason for the isolation is robust if the isolation is extreme and likely to replicate across data sets) or just to be isolatable from other subset averages (given that the isolatability is likely to have a reason for the difference)

other structures that encode data about other points, like ‘intersecting lines with maximal data point counts in data set subsets’ can similarly be useful for determining the prediction function without applying standard methods like regression

these structures can be derived by identifying which structures (like averages, data subsets filters, density, and adjacent changes) encode info about other useful structures that are likelier to be given structures of the problem space (data sets), these encodings reducing the steps to the solution structure (prediction function)

differentiation: this workflow is similar to other workflows that involve identifying useful structures of a particular problem format useful for solving all problems, but involves specifically prioritizing the structures (‘encoding structures’) that are known to be useful for problem-solving intents like ‘reduce the steps required’, using interface structures (‘cause’) of these problem space structures to determine which interface structures (‘density’, ‘average’) would be particularly useful, rather than searching all structures of the problem space

this means applying ‘cause’ as a filter of useful structures, to find structures that have a reason to be useful for intents like ‘encoding information’, structures that ‘reduce many inputs to one output’ (like an average or an intersection line's slope) having a reason why they would be useful for ‘encoding information’, if the output reflects the inputs to some useful degree rather than removing most information about the inputs, such information as a ‘probable value (average) of a data set’ or a ‘probable change rate of points in a data subset (intersection line slope, intersecting with a maximal number of points)’

so the interface query could start like this:

find a default workflow to find a prediction function from a data set (should point to standard methods like regression, applying incremental changes to a base function, taking averages of maximally different equivalently accurate functions, or other methods)

apply changes to this workflow to reduce some steps of the computation

apply cause interface to find structures with a ‘reason’ to be useful for some problem-solving intent

find structures that have a reason to be useful for some problem-solving intent

find structures that have a reason to be useful for the ‘reduce steps required’ problem-solving intent

find structures that ‘reduce steps required’

find structures that would encode information

find structures of encoding information

condensing info about many inputs into one output

example: a representative metric of the inputs, where info about the inputs (set of values) can be derived from the fewer outputs (min/max, average, etc)

apply filter for relevance to problem space

is a ‘condensing’ structure that produces representation metrics useful for this problem? (is it adjacent to or between any structures that are useful)

a ‘value set’ is present in all the variables of the data set

is a ‘representation metric’ of a ‘value set’ useful for this problem (‘find a prediction function’)

a ‘representation metric’ (average) of a ‘value set’ (variable) would be useful for intents like ‘reducing steps to check all variable values’ (like checking each variable value for compliance with a metric, as is done in other workflows), which aligns with the original interface query intent of ‘find useful structures for some problem-solving intent’, as ‘check all variable values’ is useful for many functions implementing problem-solving intents that improve on ‘trial and error’ or involve iteration like ‘checking every item in a filtered set’ or ‘checking every item in a set until a solution is found’

find structures that would be useful in determining relevant structures in the problem space

find structures that would be useful in determining relevantly adjacent structures in the problem space

‘probable value of a data subset’ (average)

find structures that would be useful in determining relevantly connecting/interim structures in the problem space

‘average points of data subsets’ would be a useful connecting structure between an input data set and an output prediction function, as connecting these structures is more efficient than connecting all data points to a prediction function

apply structures that encode information to fulfill steps to connect problem inputs with solution outputs that can be fulfilled with encoded information

Find structures that are useful as alternatives to structures, where other structures cant be applied, given structures like differences connecting the structures without violating the intent of the original structure

example: apply ‘definitions’ as ‘requirement’ structures, where structures that cant be determined by ‘requirements’ derived from definitions are required to use different terms than defined terms (‘requiring new terms’)

apply useful structures like ‘differences’ to useful structures like ‘requirements’ to fulfill intents like ‘identify when alternate structures of meaning than definitions (new definitions, position, implications, similarities, connections, system fit) should be derived/applied in place of more certain structures of meaning’

‘implications’ are useful in place of ‘definitions’ to determine ‘structures adjacent to or approximating requirements’, without violating the intents of the definition (like ‘to find requirements’)

the ‘position’ of a concept in relation to other concepts can act like a definition (in the position of ‘opposite’ to another concept, as in ‘not the other concept’) without violating the intents of applying definitions

Identify useful structures like ‘positions’ of useful structures like ‘uncertainties’ in problem/solution structures (like ‘prediction functions’), given related structures to those useful structures (like the ‘lack of/gap in requirements’ of a solution)

example: a prediction function usually has multiple equally good alternate values with the same fulfillment of solution metrics, so an ‘uncertainty’ in the form of a ‘variable’ applied to the solution parameters (‘coefficients’) is useful in that it aligns with the uncertainty structure of a ‘gap in requirements’ of the solution, where this uncertainty adds value in the form of flexibility in the solution, which may mean a particular solution is more optimal for different contexts like different data sets, and allows different solution structures like a ‘network of conditional different solutions’ to be applied as the output solution structure

identifying useful structures like ‘equivalencies’ (between alternate equivalent solutions, between solution structures & solution requirements, etc) is useful for intents like ‘determining areas of difference/equivalence’, where the areas of ‘difference’ in solution metric fulfillment like accuracy would indicate areas where more optimal solutions than the equivalent solutions are possible (as well as allowing for more suboptimal solutions), and determining areas where structures like ‘differences’ (variables) can be legitimately applied to improve the solution (converting one solution prediction function into a network of conditional prediction functions), without violating a constraint (variables applied to the solution structure dont contradict the variables allowed by the solution metric requirements, but rather align with them, as these solution & solution requirement structures are adjacent and should be aligned)

a variant of this workflow identifies the useful structures of a problem space (which structures should be equivalent, similar, different, neutral, adjacent, opposite, etc given known structures like requirements) to make other calculations connecting these structures trivial

Identify overlaps between functions that fulfill various solution metrics, like overlaps between functions fulfilling ‘accuracy’ and ‘speed’ metrics

example: a solution-finding method for the ‘find a prediction function’ problem that is perfectly accurate will likely involve ‘simplifications’ of the problem that convert it into a linear variant so its more calculatable and verifiable, or tests of every point that allow no room for error at any input

this is be ‘accuracy’ has limits in how much it can be measured, so more calculatable/simpler functions will likely be involved in its solution-finding method, and more iterations of these functions will likely be involved to ensure ‘complete accuracy’, as in ‘accuracy at every point’ (‘every’ implying ‘iteration’)

similarly, other functions with specific attributes are likelier to be involved in fulfilling other metrics, like how a function fulfilling a speed metric is likelier to perform fewer/simpler operations

given the overlap of ‘simplicity’ in functions likely to fulfill these intents, ‘simple’ functions like linear functions will be likelier to be involved in solution-finding methods that fulfill both metrics

Identify specific examples of useful structures that are useful for general/common/core/other useful intents like ‘build’ that are useful in fulfilling problem-solving intents

example: the ‘build’ function is the ‘opposite’ structure of the ‘isolate’ function, so if you have the ‘build’ function and need the ‘isolate’ function, it can be adjacently derived with structures like the ‘opposite’ structure, so any functions that fulfill the build intent can be reversed, negated, inversed, or invalidated (or other structures opposing some attribute like how ‘reversal’ opposes a ‘direction’ attribute) applied to generate functions that are likely to fulfill the opposite intent (‘isolate’), given that identifying the ‘opposite’ structure that connects the build/isolate functions is likely to be fewer steps than deriving the ‘isolate’ function using another method, like combining components to incrementally increase progress toward the function, applying changes to some base solution, generating possible functions & filtering them by some testing method or solution filter, connecting the ‘isolate’ function using another less adjacently connected function than its opposite, or applying another solution automation workflow to generate the ‘isolate’ function

this workflow involves checking existing structures for adjacent connections to the target solution structure to reduce the need for other interface queries with more steps, prioritizing these adjacency calculations as less steps than other workflows if there is an adjacency, since some functions like ‘finding an opposite structure or other useful structure’ make the work of ‘deriving a structure’ trivial, so these functions can be prioritized before applying other workflows, given that adjacencies like ‘opposites’ are one step away from another useful structure, which is likely to be more useful than other base structures to apply changes to when deriving a solution

another example of adjacencies that make a solution trivial to calculate are ‘error patterns’, such as ‘areas of a graph known to be errors given adjacent filters to apply like a required accuracy level of a prediction function, which makes some areas off-limits with trivial calculations’, and makes the remaining areas of the graph likely to contain a solution, given error/solution patterns like how solutions are less common than errors (solutions being optimal states) and are likelier to be surrounded by errors than by solutions

for example, points far outside a cluster of points representing the majority of the points of a data set are unlikely to be included in prediction functions with a particular degree of accuracy

a variant of this workflow involves taking advantage of storage to reduce these useful adjacency calculations further by indexing adjacencies between existing structures so that new structures can be fit in easily without re-calculating all adjacencies, and gaps in adjacencies can be initial candidates for new structures, checking the structures adjacent to the gap rather than checking all structures to determine where the new structure fits, as adjacencies indexed like this would make it trivial to calculate where an ‘opposite’ structure or other useful structure would be positioned, and once these useful structures are trivial to determine the position & identity of, their existing functions can be used to generate functions fulfilling the new structure

Identify useful structures (like questions particularly useful for identifying errors as in ‘filtering information for errors’) that can be applied to optimize any solution-finding method or solution

example: questions like ‘what is the net effect of these variable interactions if applied at scale or in different probable contexts’ are particularly useful for identifying errors of ‘interactions with no limits on their scaled interactions’

these error structures are derivable by applying interface structures like ‘extremes’ but can be adjacently generated by these questions as useful ‘information filters’ to quickly identify other useful structures like ‘priorities’ or ‘meaningful/relevant information’, given the relevance of error structures and the importance of ‘filters’

these questions can be generated as useful structures for intents like ‘identifying error structures’ in contexts where the conditions (‘scale’) applied in the question are possible/probable, given structures like ‘lack of limits’ which make these structures relevant/important to consider as possible error structures

identifying structures (like ‘lack of limits’ on structures like ‘scale’) which make these questions possible can be identified as common error structures (‘missing’ error structure applied to common ‘limit’ structure), and identified as particularly relevant for a particular problem space (does the ‘lack of limit’ apply to any structures in the problem space, like the ‘scale of a variable’)

deriving questions from applying common error structures is an interim step to identifying useful structures like ‘errors produced by variables applied at scale’ which are not adjacently generated by common error structures and may not be relevant for all problems, thereby filtering the possible error structures to consider for a problem by checking for causal error structures in the problem space before applying derived error structures from those causal error structures as possible changes to variable interactions

Identify useful structures that determine solution automation workflows (like ‘changes to solution-finding methods’ such as neural network configurations) which are generally useful (such as being applicable to standardized problem formats that any problem can be standardized to) to fulfill problem-solving intents like ‘generate & filter solution automation workflows’

example: every useful structure like a change that makes a structure more trivial to solve is a possible solution automation workflow, like how every change that filters a solution space (to avoid testing every possible solution) is a possible solution automation workflow, and the variants of these changes (like the ‘generative functions’ of these changes) are also solution automation workflows once generalized to a structure that can be applied to every problem, or once converted to a format that can be used in a problem format like ‘find a prediction function’ which every problem can be standardized to

every structure of useful structures that can be altered in these ways (generalized or converted to a useful standardized problem format) qualifies as a useful structure to apply as a solution automation workflow

anything that makes a useful intent (such as common intents) trivial to fulfill is a possible component of these workflows, meaning every possible neural network configuration that improves on ‘trial and error’ for a particular intent like ‘finding a prediction function for classification problems’) is an alternate solution automation workflow given the usefulness of ‘find a prediction function’ as a format that every problem can be standardized to, and every possible generative function of these useful improving network configurations is similarly an alternate solution automation workflow

these workflows can be filtered by their usefulness for multiple intents & other useful filters, to reduce the number of workflows to consider in an interface query that solves the original problem

Identify error structures like gaps in useful structures, like ‘interim structures’ that have not been optimized by identifying useful structures fulfilling intents like connecting inputs/outputs of the interim structures, which can be used in intents like ‘connecting structures’ which are useful for problem-solving intents like ‘connect problems/solutions’

example: identify that ‘isolation structures’ (like partial derivatives) applied to change structures like ‘variables’ is useful for reducing the ‘find a prediction function’ problem to ‘finding isolated variables’ and ‘finding linear combinations of isolated variables’, given the reasons that:

‘linear combinations’ are more generatable/derivable/testable/changeable/interactive than other change structures, given the standardization of these structures

‘linear combinations’ describe variable interactions for intents like ‘building aggregate variables out of component variables’ which are common intents

identifying these structures as being useful can use either of the above reasons as a target structure to generate as input for identifying useful structures, for example:

identifying more generatable or standardized structures as more useful, and finding which variable interaction structures fulfill these attributes (linear combinations), given that ‘variable interaction structures’ are default structures of the ‘find a prediction function’ problem space

identifying useful intents and the variable interaction structures that fulfill them (linear combinations), given that ‘variable interaction structures’ are default structures of the ‘find a prediction function’ problem space

once ‘linear combinations’ are identified as useful, identifying which structures would fulfill these structures would be additionally useful, to connect input data sets with a useful structure like ‘isolation structures’ that, when implemented, makes ‘linear combinations’ especially useful, these ‘linear combinations’ fulfilling useful intents like ‘finding alternate variable combinations’ which are useful for solving the ‘find a prediction function’ problem

this identifies particularly useful ‘interim target structures’ (‘linear combinations’) to solve for that can fulfill common intents like ‘connect other structures’ (like data sets and prediction functions)

differentiation: this workflow involves identifying generally useful structures (like ‘standardized structures’), identifying those structures in a problem space (‘linear combinations’), and building solutions around these specific useful structures by finding a way to apply them in a problem-solving structure like a particular position (such as in between data sets and prediction functions in a format sequence to fulfill format-connection intents) that applies and optimizes the usefulness of these structures, to make these useful structures relevant to problem-solving structures like problem inputs (data sets), solution metrics (accuracy of a prediction function), and solution formats (prediction function)

Identify filters (like work/resource investment to fulfill an intent) of useful structures (like intents) as a way of fulfilling intents like ‘finding useful structures’

example: intents are fulfilled by agents with a reason to want that intent (the reward achieved or cost avoided once the intent is fulfilled) and these agents are willing to expend costs to reduce other costs, so if an intent is actually an intent of an agent, that agent will give up resources to fulfill the intent (stakes or investment) given the expectation of the future value of their investment

so if there is no investment input by an agent in the implementation process of the fulfillment of the intent, the intent is unlikely to be an intent of that agent, so this can be used as a filter of possible/probable intents of an agent

similarly if the agent doesnt achieve the reward or avoid the cost (or use these resources to fulfill other intents) after fulfilling the intent, the intent is unlikely to be an intent of the agent

other structures can be filtered in a similar way, by identifying useful structures by applying useful concepts like ‘usage’ to generate a useful structure of ‘using/implementing a process’ to identify useful structures

the ‘expectation’, ‘investment’, and ‘future value’ structures are relevant to the ‘intent’ structure, though theyre not in the standardized definition of the intent (intent as a direction toward a target state/position involving a reward achieved or cost avoided, given a starting state/position resulting in that direction), they are involved in the implementation process of the intent (working to fulfill the intent)

applying the actual process of fulfilling the intent would make these structures more clearly useful

applying a ‘test’ or ‘simulation’ process can identify other useful structures in a similar way that standardized/limited/alternate definitions might not, which can add to the definition routes of a structure which are used to identify/determine/describe it

Identify useful structures like ‘different versions of a useful structure’ useful for different related useful intents like determining possible/probability of a structure being a particular useful structure (like a requirement) as a way of fulfilling problem-solving intents or other problem/solution structures using that structure (workflows using ‘requirement’ structures)

example: identify useful structures like useful differences to apply to change a structure into useful variants of it, like applying useful differences to generate structures useful for intents like ‘determining requirements’, ‘finding approximate structures of requirements’, ‘finding out if something is required given its common input-output causal relationships (does an input always or commonly cause an output, if so it may be a possible requirement)’

given the input of ‘requirements’, applying useful structures like ‘approximations’, ‘opposite’, ‘options’, and other useful structures generating useful differences to generate useful versions like ‘definitively not requirements’, ‘approximations of requirements’ and other versions of requirements given variables of requirements that are useful for intents like ‘determining structures that definitely exist (given that theyre required)’ as a way of generating structures of certainty like ‘structures that definitely exist’ given the certainty added by other structures of certainty like ‘requirements’ which can be used to generate these other structures of certainty

Identify structures that fulfill useful structures like core interaction functions of useful structures like problem/solution structures to fulfill problem-solving intents like ‘connecting problem/solution structures’

example: any structure (like ‘variables’, ‘causes’, ‘requirements’, ‘alternate routes’, ‘approximations’, ‘adjacencies’, ‘interactions’, ‘combination/interaction structures’) that fulfills a core interaction function (like ‘filter’ or ‘build’ or ‘connect’ or ‘change’) applied to useful structures like ‘problem/solution structures’ is itself a useful structure

determining methods of finding these structures (‘variables’, ‘requirements’) is itself a useful structure to fulfill the problem-solving intent of ‘fulfilling core interaction functions applied to useful structures’, core interaction function being highly likely to be useful when applied to useful structures

differentiation: this workflow involves applying ‘identifying solution-finding methods’ to solve the problem of ‘finding structures fulfilling core interaction functions of useful structures’, identifying ‘core interaction functions of useful structures’ as a useful structure when applied to useful structures like problem/solution structures

Apply structures like variables and combinations of problem-solving intents to find all useful structures of problem-solving intents (like ‘alternate interchangeable input-output sequences of problem-solving intents’) to fulfill problem-solving intents like ‘identifying useful intents to fulfill’

example: some sequences of problem-solving intents are more effective or otherwise optimal than other sequences, and these sequences have variables like ‘implementation difficulty’ in varying problem/solution structures, so finding optimal problem-solving intents in general and for specific problems is useful to filter solution automation workflows fulfilling these problem-solving intents

for example, fulfilling problem-solving intent sequences like ‘finding problem causes’, ‘finding useful structure causes’, ‘generating useful structures’, ‘generating differences in problem causes (generating solution causes) using generated useful structures’ is more useful than fulfilling other problem-solving intent sequences like ‘generate solutions’ then ‘filter solutions’, which may be too general or complex to be useful in particular problem spaces

identifying which problem-solving intent structures are more usable, solvable, or otherwise useful in general and for particular problems is useful to filter possible solution automation workflows fulfilling those problem-solving intents before implementing those other workflows

differentiation: this applies ‘intent’ as a useful filter and generative structure to determine other useful structures like ‘problem-solving intent sequences that are more solvable in a particular problem space’, which are useful for problem-solving intents like ‘filtering solution automation workflows to implement’

Apply interface structures like ‘cause’ to identify variables of problem/solution structures like ‘problem sets to solve the original problem’ that optimize problem-solving intents like ‘filtering problem sets to solve’

example: some problems are useful to solve for different reasons (solving them fulfills a solution metric like ‘accuracy’, solving them is easy, solving them is required), these reasons being applicable in different contexts and implementing different problem/solution structures like problem-solving intents

the variables determining the various ‘problem sets’ which are useful for these different reasons can produce useful different interface queries which can be filtered by solution-finding method metrics

every problem will have these alternate ‘problem sets’ which can be solved to solve the problem with varying levels of success/resources, and these problem sets can be derived by their defining attributes values and the more optimal problem set to solve can similarly be filtered

differentiation: this workflow applies cross-interface structures like ‘connections between cause, problem/solution structures, equivalent alternates (problem sets being equivalent alternates of the original problem), and variables’ to identify useful structures that connect these useful structures to fulfill problem-solving intents like ‘generate & filter alternate problem sets to solve the original problem’ and ‘find alternate problem sets given the defined alternate problem sets that exist for every problem’

Identify structures of useful structures that are useful to fulfill problem-solving intents like ‘finding error structures’ using variables of useful structures

example: ‘alternate’ structures are useful when applied to ‘causes’ to determine ‘alternate causes’ like a ‘requirement’ for a structure to develop given system interaction rules (indicating it was not intentionally created but was required) to determine structures like ‘lack of intent’ structures, which are common error causes

a ‘complete set’ where all items in the set can be identified as passing/failing a metric (except the item to identify) is a useful structure for intents like ‘identifying an item that fulfills a metric without the ability to directly identify whether it fulfills the metric’

variables of this structure include ‘completeness’ of the set, and ‘validity’ of set membership/definition, and ‘validity’ of other sets compared to the original set, which can identify more complete sets than the original set to use useful logic rules such as ‘complete set filters, to determined items that the filter cant be applied to’

functions to convert between variable structures (converting an incomplete set to a complete set) are similarly useful variables of these structures, so that useful rules in one variant can be applied

‘requirements applied as alternate causes’ are a useful structure of interface structures to apply as a common structure to check for when determining attributes of a structure like its causes to fulfill intents like ‘filtering alternate causes of a structure’, similar to how ‘clear optimals applied as alternate causes’ are useful to check for useful structures like ‘lack of intent structures’, as a ‘clear optimal’ would likely be a default or common selection even if its not required

variables of these structures of interface structures can determine other useful structures like approximations, variants that act like interchangeable alternates, etc

finding variables of these structures (like interface structures used, structures of variability in attributes like ‘required/optional’, and useful structures fulfilled with variants) is useful for intents like ‘finding alternate useful structures’, ‘finding input structures fulfilling useful structures’, ‘finding interchangeable structures’, etc

differentiation: this workflow involves fulfilling problem-solving intents like ‘finding error or error cause structures’ by finding structures of useful structures (‘alternate causes’ like ‘requirements’) that provide inputs to determining variants of structures in the intent like ‘different error structures’ such as ‘lack of intent to cause a structure’, given the useful structure of a complete set determined by ‘requirements’ and ‘options’, which is useful be once requirements are determined, optional structures are known by the completeness of that set, and using useful structures like variables (like required/optional/default/optimal) to determine alternates/differences (like options) of useful structures like requirements that can fulfill various useful intents like approximation, substitution, and filtering structures given logic (like the logic of filtering items in a complete set to identify remaining items)

generalization: this can be generalized to ‘find formats like complete sets or requirements that have useful associated structures that solve many problems related to that format, like filtering complete sets or determining options’

this involves finding problems (‘filtering complete sets’) solved by specific structures (‘complete set filters’), and determining whether those problems are useful (‘adjacent’, ‘accurate’, ‘required’) to solve in order to solve the original problem (‘filtering an incomplete set’), where those structures can be created by converting existing structures of the problem space (‘incomplete sets’)

Identify useful structures that are more useful when used in a structure like a combination in a particular structure (like endpoints of a problem formatted as a problem of connecting the endpoints, using structures like an input-output or function sequence)

example: identify that ‘solution requirements’ and ‘requirements to fulfill common required intents’ are useful structures when used together to reduce the differences (in the form of the steps required) to connect the ‘common intent requirements’ (structures that have to exist, given ‘common intent’ information) and the ‘solution requirements’ (structures that have to exist to solve the problem)

the difference between these two structure sets can be formatted as a difference that causes a problem for intents using those structures (the ‘common intent requirements’ arent sufficient to solve the problem on their own, as there is a difference between available inputs, like common intent-fulfilling structures, and the required solution structures to solve that sub-optimal usage problem)

the common intent structures in a system can be derived (what variable interactions are likelier to be required, given known common intents of other systems or known functionality indicating intents fulfilled in the original system)

the problems resulting from these differences (between intents already fulfilled & solution requirements) can be derived (what problems would occur if differences were applied to these common intent-fulfilling structures)

the usages that make these differences into actual problems can also be derived (would those problems be a problem for any actual usage of these common intent structures, meaning is there any structure that benefits from this usage)

this is a way of deriving ‘existing structures’ which can be used as ‘solution components’, using the similarity in ‘solution structures & existing structures’ requirements, the similarity generated by the input of ‘common intents’ in determining ‘structures that are required to exist in the system having the problem’

generalization: applying differences to known structures like derived intents already fulfilled by a system is a way of generating possible problems in the form of these differences if the problem impacts any actual usages, as well as the methods to connect the available structures with the solution structures (formatted as differences from the problem, or alternate differences reducing the problematic differences, or alternate differences invalidating the problem, or other problem-solving structures)

problems can be filtered by additional filters like the problems which are adjacently solvable using known structures of the system, in order to identify the most destructive problems that can be solved given available inputs

a variant of this is ‘deriving the problems and filtering the problems by usage and solvability’ to identify routes to & from problem states that can act as solutions to the original problem

solution success cause: this workflow involves identifying structures that are useful when used together (like ‘solution requirements’ and ‘known existing required structures of the system having the problem’ and ‘common intents indicating a requirement’, or ‘differences’ and ‘problems’) given the similarity of the structures which reduces the work of fulfilling problem-solving intents like connecting the structures

identify that ‘similarities’ of structures are useful for intents like ‘connecting’ structures given that similarities reduce the steps required to implement the ‘connection’ function is a subset of this workflow

identifying inputs of these usefully similar structures (‘common intents indicating requirements’) is an input to finding these similar structures (‘solution requirements’, ‘existing fulfilled system requirements’) that can then reduce the work of functions that benefit from those similarities

identifying inputs/components of problem-solving intents (like how ‘existing structures’ are useful for intents like ‘recombine or alter existing solutions to create new solutions’ or ‘build a solution out of existing components’) is a way of determining which structures (like ‘existing structures’) would be useful to determine, using structures like ‘similarities’ that fulfill core interaction functions like ‘reduce’ applied to problem structures like ‘differences’

differentiation: this applies structures of useful structures to determine useful structures to derive to fulfill problem-solving intents before deriving them, using known useful structures like input-output sequences to fulfill ‘connect’ intents and components to fulfill ‘build’ intents, as a way of filtering out less useful interface queries, ‘filtering interface queries (filtering solution-finding methods)’ being a problem-solving intent

Identify useful structures like causes (such as ‘system differences in input requirements of an optimization structure’) of error structures (such as errors related to ‘efficient solutions in a particular system’ like ‘copying a solution to a different system where that solution is suboptimal, as the original system inputs making that solution optimal dont exist in the other system’) of problem/solution structures (like structures of optimization like ‘efficiency’) to identify when those problem/solution structures like optimal solution metrics shouldnt be applied or should be applied as components of an integrated solution metric

solution success cause: this is useful be identifying the cause of errors and identifying the error structures useful for identifying the errors can make intents like ‘avoiding error structures’ trivial to solve

these state sequences make it clear why a solution is sub-optimal and in what contexts it would be sub-optimal, making these state sequences useful to store

differentiation: this applies interface structures (like ‘cause’ and ‘error’) to find useful structures (like specific state sequences relevant to those interface structures like ‘copying a solution to a different system where that solution is suboptimal, as the original system inputs making that solution optimal dont exist in the other system’) related to problem/solution structures like solution metrics such as efficiency to identify when a particular solution would be sub-optimal to fulfill intents like ‘filtering solutions’

Identify useful structures like ‘alternate function sets to solve a problem’ and ‘requirements of function sets’ as particularly useful to avoid common steps in interface queries like ‘finding optimal function sets to apply in solving a problem’ (where functions act as solutions to solve sub-problems, where problems/questions/functions/solutions are alternate components of interface queries) so common tasks required for implementing interface queries like ‘finding info such as whether a particular function set can be applied using available inputs’ are trivial to solve, as ‘requirements of function sets’ are already stored so the problem becomes a problem of ‘comparing available inputs to requirements of function sets’ to find function sets that can be applied adjacently to solve a problem

solution success cause: this is useful be identifying the functions to apply to solve a problem is useful for comparing function sets to find function sets that optimize for some solution metric such as ‘accuracy’ and ‘availability of required inputs’, before finding/building/deriving those functions, as functions as alternate structures as problems/questions in interface queries and can act as components of interface queries

Identify structures (like ‘high benefit-cost ratio’, ‘low actual/optimal solution difference’) that commonly fulfill solution metrics (like efficiency, accuracy) which are useful specific structures implementing these solution metrics which can be used in place of these solution metrics to fulfill problem-solving intents like ‘filter solutions’

solution success cause: this solves the problem of ‘filtering solutions’ applied to the problem of ‘finding the optimal definition route of a concept to implement’, applying the usefulness of ‘approximation’ structures by finding ‘approximation structures of useful structures’ as a more useful problem to solve than ‘testing all definition routes of useful structures’

generalization: find specific structures that fulfill other useful structures like ‘problem-solving intents’, ‘interface queries’, ‘solution automation workflows’, ‘useful structures’ to use those as approximations of the original structures, instead of finding/building/deriving the optimal structure implementing those useful structures each time or iterating through all definition routes of the useful structure

another variant is to ‘find useful structures like positions of structures that make a structure more useful’ such as by placing ‘useful structures’ as an input to an ‘approximation’ function, ‘approximations’ being generally useful, and ‘approximations of useful structures’ being even more useful, by reducing the steps required to find/build/derive useful structures

another variant is to find the ‘optimal structures’ of these useful structures (a structure that integrates ‘high benefit-cost ratio’ and ‘low actual/optimal solution difference’) to find an optimal integrated structure to apply rather than finding/building/deriving/applying these structures independently of each other, which applies the insight of ‘most solution metrics are insufficient on their own in isolation of all other solution metrics’

this involves standardizing the useful structures to the same interface (‘high positive output to low negative input’ and ‘low difference in actual solution output to optimal solution output, given a particular solution method and optimal input-output examples’) to find a structure that integrates them (high positive output (high rate of accurate solutions) and low negative input (minimal information required to generate high rate of accurate solutions)) to find other structures that can fulfill the integrated optimization structure (which re-formats the problem as a problem of ‘finding what solution methods require minimal information but reliably & commonly produce accurate solutions’ which would have solutions like ‘solution methods applied to useful input structures like existing solutions’ and ‘solution methods that avoid common errors’ and ‘solution methods that use known useful structures like function networks’ and ‘solution methods that optimize for known optimization metrics like changeability of the solution to adapt to differences in inputs to optimize for accuracy’)

Identify useful structures (like ‘differences’, ‘variables’, ‘change-triggers’, ‘solution metrics’) to fulfill problem-solving intents like ‘make finding/building/deriving other useful structures trivial’ and apply these structures across interfaces (like the subset of the ‘system’ interface involving a system of agents) to find these useful structures (like ‘cost/benefit analysis’), which can then be abstracted (‘efficiency’) and applied generally across interfaces

example: the ‘cause’ of the usefulness of a structure like ‘cost-benefit analysis’ is that it uses equal/similar inputs and generates equal/similar outputs as other useful structures like ‘efficiency’ (a structure which involves outputs that optimize the benefit/cost ratio using benefit/cost info as input) but exists in a different interface position (the agent position as a decision-maker), where efficiency is more abstract and can be directly applied across interfaces

similarly, the ‘cause’ of the lack of usefulness of that structure is its difference from other concepts in the ‘reduced optimal set of concepts’ as well as its differences in implementation optimization (difference between input requirements and output value created) as well as its differences from more optimal methods like more optimal ‘analysis types’ or ‘change rules’ or more optimal structures like its abstraction to concepts like ‘efficiency’ which makes it more generally useful

identifying ‘costs/benefits’ and the ‘benefit-cost ratio’ as particularly useful structures to store is trivial, once the ‘cost benefit analysis’ is identified as a useful structure given its simplicity & efficiency, if not its accuracy in alternate states (given its lack of a built-in ‘change’ concept leading to a more useful version like ‘past/future state change cost/benefit analysis’)

similarly, identifying ‘similarities/differences’ as particularly useful structures to store is trivial, once the ‘differences in cause of usefulness/lack of usefulness’ are identified

so identifying useful structures like ‘difference in cause of usefulness’ and ‘useful changes to apply to make a structure more useful’ and ‘useful metrics like benefit/cost ratio’ that make other useful structures trivial to find/build/derive can be reduced to their common problem of ‘finding high-variation (variable) structures’ (variables being a useful structure) and ‘finding high-variation (difference) reduction structures’ (differences being a general problem structure and difference-reduction structures being therefore useful), applying these structures across interfaces to identify useful versions of these structures on those interfaces (‘find difference-reduction structures on the system interface’ would identify ‘cost-benefit analysis’ as a primary difference-reduction structure as it reduces differences in ‘change triggers’ to explain the cause of changes on that interface (‘most agents are applying cost-benefit analysis to make their decisions given that cost-benefit analysis is a useful predictor of their decisions’))

Identify useful structures (like ‘decision functions’) on specific interfaces that fulfill useful intents (like abstract/compress/reduce problem-solving processes) given the adjacent structures (‘analysis types’) of those useful structures and the cause of that usefulness (‘decisions made by intelligent agents may be more useful than other change-triggers like random change-triggers or change-triggers produced by application of known optimization rules’)

example: identify ‘decision functions’ (change-triggering functions useful for intents like ‘filtering solutions’) that would be useful for deriving changes to solution structures (like solution methods or solution-finding methods or solution automation workflows) as an alternative to standard interface queries, which this interface query involves ‘find a decision function to find changes that improve solutions’ to avoid deriving the decision function with an interface query that doesnt explicitly refer to the concept of a ‘decision function to find changes that improve solutions’, which is similar to finding a change/state change/input-output/function that improves solutions but abstracts the process to find a function that can select changes to apply in that sequence, which is normally a task done by the interface query, decision functions being particularly useful as change-triggers of important variables like direction/priority that an intelligent agent usually makes decisions about, decision functions using adjacent useful structures like ‘analysis types’ such as ‘cost/benefit analysis’ which fulfill useful intents like ‘compressing info’ and ‘reduce problem-solving costs’

this differs from a typical interface query by taking place specifically on the ‘agent’ interface in the ‘system’ interface where useful structures like ‘analysis types’ and ‘incentives’ are adjacent to generate solution structures like an ‘interface query that finds improving changes to solution methods’, decisions being useful as ‘solution filters’ to test a particular solution, wherever all solutions cant be tested

generalization: other structures with adjacent structures that make problem-solving processes trivial include structures like ‘optimized systems that include the reduced set of optimization concepts’ where applying such a known/stored system can solve most problems trivially, ‘applying the optimized system to solve problems’ being the associated workflow using those known structures, as applying such optimized systems can act as an alternative to finding/building/deriving a new or known optimized system in an interface query

an example of this applied to the ‘find a prediction function’ problem would be applying the concept of ‘state changes’ to change a prediction function so its robust to state changes in its input data, given that ‘state changes’ are a useful concept present in the ‘reduced set of useful concepts’ of optimized problem-solving systems of variables (such as a system of variables like ‘solution metrics’, ‘solution requirements’, ‘problematic difference to resolve’, etc)

Identify structures of interface structures that are useful for finding/building/deriving useful structures like ‘prediction functions’ or ‘change-triggering (decision) functions’ that are generally useful for problem-solving intents

example: identify the most reduced set of concepts that result in generally useful systems, like how including the concept of ‘potential’ or ‘change’ can avoid the error of ‘cost-benefit analysis of the current state’ to include ‘future/past states’ or ‘state changes’ as a useful structure to analyze as well, where ‘cost-benefit analysis of current state’ commonly produces errors like ‘not seeing opportunities to increase benefit/cost ratio in adjacent states as well as distant states’, so identifying a reduced set of concepts (like ‘change’, ‘cost/benefit’, and ‘state’) would be a more optimal system of variables than ‘cost/benefit’ on its own

generalization: identify alternate versions of structures like ‘sets’ of interface structures like ‘concepts’ that would be useful for common useful intents like problem-solving intents, where alternate concept sets would be useful for solving problems in complex systems as opposed to the ‘most reduced concept set’ which is useful for solving simple problems

identifying different useful structures for ‘solving problem types’ or ‘solving problems in certain contexts’ applies a new variable to use in solution automation workflows (problem-solving contexts) to make it clear how some workflows are more useful in some contexts than others

Identify useful structures like ‘analysis types’ (as ‘important change inputs’) and identify useful structures like ‘error causes’ of those useful structures to fulfill problem-solving intents like ‘find important change inputs to determine causation’ for problems in a particular format like the ‘find a prediction function’ problem format or to fulfill other problem-solving intents like ‘solve the cause of the problem instead of the problem’

example: identify structures (like ‘over-simplification to cost-benefit analysis’) that result in other errors like ‘inability to see usefulness of other structures like other analysis types (future/past cost/benefit analysis) in other contexts (future/past states as well as state histories)’ to identify related error structures (like ‘sequences of cost-benefit analysis that result in errors’) and alternate analysis types that can act as interchangeable substitutes or act as an improvement on that analysis type as it lacks that error structure, despite the limited advantages of the original analysis type in rare improbable contexts (like where agents are protected from risk be of risk buffers)

Identify useful structures and the useful structures they can fulfill like ‘important functions’ (change, cause, use, derive, generate, determine) which result in negative outputs (costs like function loss) to fulfill problem-solving intents like ‘find error structures to avoid’

example: identify useful structures like ‘error structures that cause other errors’ such as an error of prioritizing incentivized actions that cause other errors, errors like ‘loss of function to detect errors’ where the incentive prioritizes actions to ‘avoid using those functions so the functionality is lost’ given insights like ‘structures which are used are less likely to be lost, as lack of usage results in function loss’

Identify the usefulness of various structures (like clarity/specificity) for various problem-solving intents like ‘building a structure that fulfills a solution metric’ given its adjacent intents fulfilled like ‘build a structure with an attribute’ once useful structures like ‘an example structure with that attribute’ is an available input

example: identify useful structures like ‘examples’ as structures of clarity and specificity, which are adjacent structures to structures of certainty

generalization: find structures that fulfill the most problem-solving intents/useful functions and store the output structures as a way of avoiding deriving new implementations of these functions (store structures of specificity in addition to its alternate definition routes)

related alternate workflows: find structures like ‘concepts’ and ‘generative variables’ that make difficult (high computation requiring) functions trivial to solve, as storing structures is mainly useful in situations like where deriving the structure is high-cost, to avoid the problem of deriving high-cost functions by reducing the cost of deriving these functions, and storing examples is only useful when the variables of a function are not completely known, as knowing these variables enables other more useful intents that invalidate other less optimal intents like ‘storing examples’, these variables enabling more useful intents like ‘making the function trivial to derive’, improving the accuracy of deriving these functions in addition to the triviality of deriving them, where ‘identify the concepts generating a function’ only makes the function more trivial to derive but may not completely optimize the accuracy of that derivation like the variables would

Identify useful structures to store like ‘examples’ or ‘the reasons to apply a common interface structure like a intent in a system and the reasons not to’, which are useful ‘interim’ structures to store, which could be generated by a query but are useful enough to justify storing to avoid requiring that query

example: identify that ‘changes likely to produce error structures given that these changes fulfill intents likely to produce errors like unnecessary intents’ are useful to store for a particularly common or useful structure (‘changes (applied to that structure) which are likely to produce error structures’), given the usefulness of structures like commonness

Identify useful questions to ask that highlight useful structures that are adjacently useful for fulfilling problem-solving intents

example: questions like ‘find useful structures like core structures’ are useful to apply as intents that are adjacent to or assist with fulfilling problem-solving intents, as these questions often precede ‘finding useful structures’ or solving useful problems like ‘find useful structures for problem-solving in general’ and can be applied as inputs to these useful outputs, given that ability to trigger these outputs

these questions which would produce a useful structure can be derived by applying differences to the useful structures and formatting those differences as a question that is resolved by the useful structure

Identify related structures of useful structures like opposite structures & error structures of ‘intent to not change’ in a system that contradicts an ‘intent to change’ and the variables like ‘reason why that intent is useful’ or ‘reason why that intent would produce an error’

example: ‘abstracting a structure’ may be a generally useful intent but there are reasons not to apply it, such as where the solution to a problem is accessible with a path that doesnt require it

so structures like ‘requirements’ can be applied as a ‘reason to change’ as in a ‘reason to apply a structure that fulfills a different intent’

these structures would not be associated with an error so can be stored with the original structures as a useful or solution structure

similarly, in the opposite, applying changes to fulfill unnecessary intents may be associated with errors, so ‘changes fulfilling unnecessary intents’ can be stored as ‘possible error structures’ of the original structure

Identify relevant structures like ‘difference-resolution patterns between ambiguously similar structures’ of useful structures adjacently relevant to problem/solution structures like ‘questions’ as a way to generate new solution automation workflows, as all problems can be formatted in formats like a set of differences resolving a set of questions/queries/sub-problems

asking questions like ‘are all common structures important’ highlights the difference between common structures and importance given their definitions, which at first may seem ambiguous (whether theyre different or similar is ambiguous) without additional information like the interactions & definitions of those structures

the answer is that they are conditionally similar and different, since theyre not equivalent terms, and these similarities & differences are useful for different intents

the intent of solving the problem of ‘finding important structures’ can be partially fulfilled by ‘finding common structures’ in a problem space where ‘common structures’ are the only given input

generalization: identify structures like ‘sequences/combinations’ or interface structures like ‘variables’ of useful structures to identify useful structures like the ‘field of similar useful structures’ in order to identify structures for an intent like ‘finding adjacent structures to these useful structures’ or ‘finding useful structures having these structures’ in the field of useful structures with some degree of distance from problem/solution and other interface structures

for example, ‘questions’ are adjacent to ‘problems’ in this field, so given an input of only questions, useful structures can be found to link questions to problems and therefore solutions

Apply definitions to find useful structures like similar relevant structures of useful structures

asking questions like ‘are all simple structures also core structures’ identifies useful similarities between structures given their definitions that would be useful in finding relevant similar structures

‘find core structures by first finding simple structures’, as simple structures are likelier to be composable to create core structures or be core structures than other structures, given that core structures must also be composable

variations of this workflow: identify relevant questions to these questions that would identify alternate routes to derive the useful structures

for example, asking the question ‘find structures that are composable to find core structures’ is another useful structure to find core structures, which might result in an answer including ‘simple structures’

this question depends on identifying the important attributes of a core structure (‘composability’) and running an interface query to find structures having those attributes

the original question ‘are all simple structures also core structures’ can be generated by iterating through all possible combinations of structures and checking for equivalence, so its less optimal than the second question

it could also be generated by applying a pattern interface query to determine the pattern of ‘core structures being simple in their structure’

the related question ‘are all core structures simple’ is a different format of the question that focuses on ‘identifying attributes of core structures’ rather than ‘checking for equivalence between structures’ (‘checking for equivalence’ being more useful for more intents, given that different formats tend to be useful for different intents)

to derive the more useful question ‘find composable structures’ from the original less useful question ‘are all simple structures also core structures’, apply an interface query like the following:

apply the abstract interface:

‘are all structures having this attribute (simple) equal to structures of this attribute (core)’

apply the change interface (add a variable, find an alternate) or the structure interface (make a structure multiple), or the ‘definition’ structure of the ‘meaning’ interface

‘what other attributes does each structure (simple, core) have’

‘what is required for this structure (core) given its definition’

the resulting attributes (composability) of the structure (core) offer a filtered set of solutions to search for equivalence or other usefulness to ‘finding core structures’

with this set, questions like ‘find structures with this attribute (composability) to find core structures’ can be asked instead of iteratively ‘checking all structures for equivalence/usefulness to find core structures’

finding alternate questions (alternate problem to solve) using these interface queries can be useful for finding more efficient questions

finding the original question ‘find simple structures to find core structures’ can be useful to fulfill useful functions like ‘find proxy/similar structures of a structure to avoid finding that structure’ which are useful for intents like ‘find useful structures to solve a problem’, ‘core structures’ being useful in general to solve all problems

Identify useful structures (like ‘variable value ranges’ and ‘common variable values’) that can be used to fulfill problem-solving intents like ‘filter solutions’ given the useful structures fulfilled by those structures (‘probabilities’ determined by ‘variable value ranges’ and ‘common variable values’) which are useful for those problem-solving intents

example: identify the range of variation that intents tend to exhibit in a particular system to determine useful structures like probabilities of a particular new intent that differs from the existing intents

differentiation: this workflow applies ‘degrees of change’ (x fulfills y fulfills problem-solving intent), ‘input-output sequences’ (x is an input to y is an input to problem-solving intent) or ‘specifications’ (‘filter solutions by probability’ is a specification/implementation of problem-solving intent ‘filter solutions’) of problem-solving intents to find structures that are useful for those intents, ‘change degrees’, ‘input-output sequences’, and ‘probabilities’ being useful interface structures, interface structures being variables that can be altered to create alternate ‘structures (like sequences/combinations) of useful structures’ to fulfill problem-solving intents

Identify structures that can determine useful structures (like structures of certainty such as ‘probabilities’) to fulfill problem-solving intents like ‘create a base/template or limiting structure of a solution to fill in using requirements of the solution’

example: identify robust/invariant structures that wont change even when incentivized to do so (even when a variable interaction is incentivized, it still is unlikely to occur in a particular system) as an adjacent structure of truth as ‘requirements’ (structures that are required to be true given their importance for a particular intent)

generalization: identify alternate proxies of certainty structures with variable degrees of certainty, like the variable certainty of ‘certainty structures like requirement structures’ to ‘certainty-adjacent structures like invariant structures’ probable structures like common structures and other useful structures’, as alternative structures of certainty to apply in solution automation workflows for various problem-solving intents

example: if a structure cant be found by composing certainty structures but can be found by composing certainty-adjacent structures like probable structures, those structures can be used in place of certainty structures while certainty structures are being derived

a further generalization is to find useful structures (like ‘networks’ or ‘spectrums’) of useful variables like ‘certainty’, variables which are a good approximation or alternate of less adjacent variables like ‘usefulness’ or ‘meaning’, as these structures of useful structures are themselves useful for intents like ‘finding an alternate/adjacent version of a variable value on the field of possible variable values, given that one variable value isnt computable/usable/determinable’

Identify alternate structures to identify variables that can be used to fulfill problem-solving intents like ‘generate alternate solutions’

example: ‘find a prediction function’ can be applied to derive the useful structure of a problem-solving intent like ‘find a prediction function for solution-finding methods (interface queries)’ by:

connecting it to problem/solution structures to make it a problem-solving intent (‘solution-finding methods’)

aligning the outputs (‘solution finding methods’) of the new derived intent with the outputs of functions (‘prediction functions’) applied to those structures (‘predicted structure’) so that the ‘prediction function outputs’ are ‘solution finding methods’

connecting it to inputs that would be useful for fulfilling the intent such as ‘known solution-finding methods’, ‘known solution-finding method components’, ‘known problem-solution differences’ etc, which can be derived as the inputs to the output ‘solution-finding methods’ since any cause or generative function or component or descriptor of a solution-finding method could be used as an input to generate solution-finding methods

Identify useful structures of interface or problem/solution structures like ‘degree of deviation from previous known insights’ as a useful structure for intents like ‘filtering solutions’

example: most new insights comply with known insights to some degree and extreme legitimate deviations/contradictions are rare, so any solution or solution component has to use mostly legitimate and probable structures and have minimal deviation from known structures

exceptions to this exist in cases where a new interface is about to be discovered or an unknown threshold is about to be crossed triggering a phase shift that could explain extreme deviations, which would indicate a legitimate reason for an extreme legitimate deviation

this degree of deviation/difference can be used to filter out less probable solutions which dont have a reason to justify considering them, such as indications of a hidden interface/threshold or other exception structures

the ‘state changes of insight sets’ is a useful problem/solution structure to predict the next insights discovered

applying the core structure of ‘set’ and ‘state’ to the core interface structure of ‘insight’ is one way to derive this useful structure

another way to derive it is identifying the usefulness of a ‘prediction function for the next insight’ and applying that useful structure as a way of fulfilling problem-solving intents like ‘find new insights to use in solving problems’ implemented with common prediction structures like ‘applying patterns in existing sequential data to predict the next value in the pattern’, substituting ‘insight state changes’ as the data

Identify useful structures like similarities between alternate solution formats (like ‘generative functions’ and ‘prediction functions’) that can be useful for problem-solving intents like ‘filter solutions’ or ‘find probable solution components to build a solution’ or ‘generate solutions’ or ‘change the solution-finding method to an alternate substitute’

example: identify the potential of any given generative function of a dataset to be converted into the actual solution prediction function and the variables in common of the generative functions that are useful as prediction function substitutes/alternates, as a way of determining alternates to the original solution format, or as a way of filtering probable solutions (solutions are likelier to overlap with generative functions to some degree or otherwise be similar enough to make conversion trivial)

a generative function of a dataset (for example, generating the next point from the previous adjacent point in a sequence, or generating points using changes applied to a set of base points that are most descriptive of the most differences in the dataset) isnt likely to be equivalent to the prediction function (using causal variables of the output variable) but they will have some similarities, which may be enough to use the generative function instead and possibly use the generative function or its variants like its abstraction to substitute for other prediction functions

this workflow answers the question ‘whats the probability that any given generative function of a dataset mapping inputs to outputs is similar enough to the prediction function that uses causal variables’

this assumes there is enough of a similarity between the steps of the generative function and the causal structures involved that they can be used to substitute for each other to some degree or in some cases

for example, ‘generating the next point from the previous point’ or ‘generating surrounding points from a central point’ relies on structures like ‘sequences’, ‘similarities’, and ‘change patterns’ which can act like causal structures

there may be a ‘similarity’ structure in a regression method like ‘similarity to the data set line’ and a ‘similarity’ structure in the generative function like ‘similarity to a local average’ which have a similarity structure that makes these solution-finding methods possible interchangeable alternates in some ‘interaction structure’ that integrates the multiple solution-finding methods

for example, the generative function can be used to generate points where there seems to be data missing, and the regression method can be used to come up with a base solution that the output solution should be similar to, to some degree

this interaction structure uses the generative function as a method to fill in for the regression method when the regression method doesnt have its minimum required information (like data points)

if the structures of these alternate solution-finding methods happen to be equivalent or otherwise relevantly similar in intent, cause, or impact, they can be used in an integrated merged solution-finding method like ‘find structures in common between alternate solution-finding methods and use those structures as components of an integrated solution-finding method’

the prediction function may have causal structures like ‘variable subset combinations’ which overlap with the structures of the generative algorithm

some of these structural overlaps can be derived (answering the question ‘what generative function would use similar/equivalent causal structures as a prediction function with accuracy x’) or alternatively, the reverse can be applied, to use common causal structures as a starting set of solution components to build generative functions and prediction functions out of

solution success cause: the reason this works is be ‘generating points in a data set’ and ‘solving for the prediction function’ have aligning intents (predict output from inputs), even if they reach a solution using different solution methods (‘generating one point from the previous point’ and ‘find a function that minimizes total difference between points and the function line’) which might have overlaps in some implementations (like ‘generating a point that minimizes difference in causal structures in a subset of similar points’, as subsets are likelier to have the same generative causal structures than all subsets)

Generate useful structures (like alternate structures such as ‘alternate functions’) using variables like ‘generative interface structures’ in order to fulfill useful problem-solving intents (like reducing tasks such as ‘finding/deriving/building functions’ which are useful for finding/building/deriving a solution)

example: the useful function of ‘re-use’ (copy) can be produced by applying the core structure of ‘repeat’ or ‘multiple’ applied to a core function of ‘apply’ (use)

the ‘copy’ function might not be on a primary interaction layer of functions (like ‘core structural functions like reverse’, ‘core interaction functions like reduce’, ‘primary problem-solving intent functions like find’, ‘problem-solving intent functions like filter solutions’), but it is useful for various intents like ‘re-use an existing solution and apply changes to it’ as an intermediate function that is part of the interface query implementing those intents, and generating it would be useful for implementing those intents, so having the function auto-generated and ready to apply would make implementations more trivial

storing functions in terms of their generative variables where variations of the function have known useful intents is a way to index functions that makes deriving/finding/building functions more trivial

for example, storing functions like ‘apply’ in a network where functions like ‘multiple’ connect the ‘apply’ and ‘copy’ nodes of the network would make the query of ‘find/build/generate a function that uses core structures (like multiple) and functions (like apply) to generate another structure (a copy)’ more trivial, as queries on the function network could be limited to functions/nodes that are core structures/functions

differentiation: this workflow applies the insight that ‘generative structures’ are more trivial to query than the structures themselves, applying this insight in order to index useful structures by their generative structures, these generative structures being particularly useful for intents aligning with the ‘query structure’ that a network makes possible, such as ‘finding/building/deriving a function’ (a ‘query of a network’ and a ‘function’ both being aligned through their common structures of sequences, so a function network is particularly useful for ‘finding/building/deriving functions’, and applying ‘generative functions’ to this structures makes it even more useful)

generalization: abstracting this workflow is useful to find other structures that make intents trivial to fulfill, in identifying the particularly empowering nature of ‘generative functions’ when applied to ‘function query networks’ because of the reduced search space offered by using generative functions instead of other function sets in the position of ‘functions’ in the ‘function query network’, as ‘reducing the search solution (filtering solutions)’ is a known problem-solving intent, so abstracting this workflow would be ‘find structures that make other intents trivial bc the structures fulfill known problem-solving intents or other useful intents’ (which also has an aligning structure in the intent of fulfilling problem-solving intents, as both the original structure of a function query network and the new structure of a generative function query network both fulfill different & overlapping problem-solving intents)

alternate workflows: insights derived from this workflow include ‘find aligning structures (like function network queries and functions)’ to identify structures that are usable for multiple useful structures like interchangeables or generators (as a function can be represented in the format of a function network query, and functions can also be generated by a function network query)

Find/derive/build useful structures (like ‘structures of certainty’) of problem/solution structures to use as useful structures like ‘filters’ to fulfill problem-solving intents like ‘filter solutions’

example: a solution that has a net positive impact across probable contexts is likelier to be true because it is more stable across different contexts, which is a structure of truth

for example, a solution that includes (or is robust to) a common variable interaction pattern as opposed to a unique one is likelier to be true bc of the stability of common structures, and this commonness contributes to the net positive impact of the solution across probable contexts (positive in the sense of coordinating/interacting with other structures, being stable, and otherwise being true), probable contexts similarly being synergistic with common structures

given the randomness of systems, alternate contexts should be considered as any given particular solution is likelier to be wrong than one that includes multiple solutions (a conditional network of solutions), as reality is often too complex for any one solution to describe, even when describing one connection at a time

a ‘conditional network of solutions’ and a ‘alternate context-robust solution’ (which applies a ‘conditional network’ of another problem/solution structure, specifically problem space systems (contexts)) are structures of truth/certainty applied to ‘solution’ objects, and are therefore useful for intents like filtering solutions

generalization: whatever a solution structure is, its known that it has to have some ‘structures of certainty’ and other structures that determine solutions, which in general applies the structure of ‘requirements’ to a problem/solution structure given the definitions of problem/solution structures (given the definition of a solution as a ‘useful structure’, it has to reflect truth in some way or to some degree, or its unlikely to be useful)

Identify alternatives to useful structures (like adjacencies) such as structures that contradict those structures in their metric of usefulness

example: adjacencies are useful be they are ‘low-effort’ solutions to create another useful structure (requiring minimal effort such as minimal conversion functions)

the reason they are useful is that they require minimal resources

an opposing structure would be a structure that requires non-minimal resources

how would such a structure be useful?

if it creates other useful structures before/while/after those non-minimal resources are being found/derived/built or used

for example, if learning how to solve a particular problem pays dividends that using an existing solution does not, this is a more effective & possibly more useful structure than the existing solution, even though its adjacent

deriving other alternatives to other useful structures can similarly apply opposing structures to their solution metrics (the reason why theyre useful, or the metrics they fulfill)

Identify alternate paths (in the form of interface queries) to useful structures and variables of these alternate paths to generate useful structures to fulfill various problem-solving intents

example: an alternate path to derive the structure of an ‘interface’ is:

applying core structures (like a line) and applying core changes (like vacillation in another dimension, meaning ‘perpendicular’ to that line or ‘embedded’ in the changes of the line like ‘changes in change rates of the line’) to those core structures by applying useful structures like similarities (vacillation with an average aligning with the line) to the core change types, to generate the concept of a symmetry as a base for other change types

this alternate path uses the core interface (core structures), the change interface (changes to core structures), the meaning interface (applying useful structures to core change types), then formats the output on the change interface (base for other change types), all on the structure interface

its also derivable as:

the ‘unit change applied to the unit one-dimensional structure’

the ‘alternate structure (vertical line vs. horizontal line) used to create a unit two-dimensional closed shape using right angles’

alternate paths to derive ‘recursion’ or ‘self-reference’ as a useful structure is:

deriving the structure of ‘fractals’ by applying the core function ‘embed’ to the structure of an interface (apply a ‘change’ to a ‘change’ to get the ‘change rate of a change’)

these two structures are useful opposing structures which can act as an alternative to other opposing structures (like solutions vs requirements, or changes vs limits, or locals/unit/specific/one vs. absolutes/extreme/abstract/all)

variables of these useful structures can include:

adjacent interface structures that can create useful structures like core structures, as core structures are particularly useful given that theyre a primary interface

Identify variables of problem-solving intents to quickly find a set of problem-solving intents that are more efficiently fulfillable with an interface query than other sets of intents

example: problem-solving intents like ‘changing an existing solution to improve a solution metric value (optimizing/improving a solution)’ can be more efficient than ‘filtering the set of possible solutions’ in cases where the existing solutions is already close to optimal

variables of these intents include the interface structures used in the intent, the adjacent functions fulfilling the intent, the general/core/other function types used in the intent, the workflows which the intent can be effectively used in, the problem/solution structures used in the intent, the other problem-solving intents helped or fulfilled by the intent, the variability of implementations of the intent, the efficiency of most implementations implementing the intent

differentiation: this uses the intent interface to find alternative function sets applied to the problem/solution structure of problem-solving intents, which are a particularly useful structure for indexing solution automation workflows given the usefulness of the intent interface

Identify changes that can remove the requirement for change in an existing solution to another problem which fulfill the intent of ‘optimizing a particular solution’, then identify attributes of those solutions in common that can be used in interface queries to optimize solutions to other problems

example: identify changes to a regression method that would remove the requirement to update the method which would produce reliable/robust results in many maximally different input contexts, to optimize that particular method as much as possible without converting it to a different solution type, then identify the attributes of those optimizing changes and attributes of the optimized solution method that can be applied to optimize other solutions

Identify useful structures to apply in solution automation workflows when deriving new solution automation workflows given structures of usefulness like ‘commonness’ in other solution automation workflows

example: given that ‘approximations’, ‘counterexamples’, ‘combinations’, and ‘requirements’ often appear in solution automation workflows or other problem/solution structures, and given that ‘commonness’ is a structure indicating usefulness, find other common structures in solution automation workflows to use in new solution automation workflows (‘generate a workflow using common structures to other workflows like counterexamples’) and apply changes to the workflow using interface structures like intent until its usable as an actual solution automation workflow

differentiation: this workflow uses useful structures to form a template of a solution automation workflow based on structures of usefulness found in problem/solution structures like other workflows, then fills in that template using standard methods of deriving functionality, like ‘fulfilling functions using intent structures’

Identify error structures in interfaces for various problems and find/build/derive more optimal interfaces to apply for those problems in an interface query that can address those error structures

example: the ‘function’ interface covers interactions of known logical units (‘functions’) but interactions that occur outside of known functionality are not as easily found/built/derived by this interface (for instance, the collision of various function outputs or the parallel compounding outputs of functions on multiple layers of a stack)

so the ‘function’ interface has a ‘missing information’ error type where it cant adjacently predict these interactions unless there are known functions indicating how those output interactions would play out

differentiation: this workflow addresses designing interface queries implementing solution automation workflows to correct known error structures of various interfaces, which on its own can convert a sub-optimal solution automation workflow into a more optimal one with fewer error structures, by fulfilling the problem-solving intent of ‘reducing errors generated by applying a particular solution automation workflow’ which fulfills a problem-solving intent of ‘applying optimization structures (like iterations of error structure-corrections after generating a solution by applying a particular workflow)’

Identify useful structures like similarities between useful structures like function sets common to solution automation workflows to fulfill adjacently fulfilled intents like ‘find a substitute function’ for error types like a ‘missing function’ which could occur in workflows, to generate new solution automation workflows

example: the ‘build/test’ function set is similar to the ‘generate/filter’ function set, so functions fulfilling the ‘filter’ function are likelier to be usable for the ‘test’ function than other functions

differentiation: this workflow uses the ‘sets of general functions’ common to many workflows as an interface to base changes on and derive similarities using, in order to fulfill problem-solving intents

Identify useful structures like mappings between adjacent/useful structures, such as the mappings between structures (counterexample), the tasks theyre adjacently useful for (testing a function for absolute applicability), and the problem-solving intents those tasks are useful for (‘filtering solutions’)

mapping useful or adjacent structures provides a clear path between useful structures using available/adjacent methods, which is why this is useful, given the lack of ambiguity once this path is structured and given the other alternatives filtered out by prioritizing this path

a ‘sequence of adjacent functions connecting useful structures’ is a useful structure to identify

to identify this structure, applying ‘useful structures’ (like adjacent structures) to the intent of ‘find connections between useful structures’, which is useful for the intent of ‘implementing a function on a different interaction level, once the useful structures (functions on interaction levels) are connected’

other useful intents relevant to known problem-solving intents can be identified by specifying the functions required (‘connect interaction levels’, ‘find connecting structures’) to implement a problem-solving intent (‘implementing a function on a different interaction level’)

differentiation: this workflow identifies particularly useful structures for implementing problem-solving intents by identifying required functions to implement problem-solving intents and then applying useful structures to implement those required functions

Identify structures that would be useful for implementing a particular set of structures (like the ‘build’ and ‘test’ functions) implementing a solution automation workflow, as a base implementation to apply changes to when finding more optimal implementations of the workflow

example: if a workflow uses the ‘build’ and ‘test’ dichotomy, identifying which particular tests would be useful for which particular metrics is a useful structure to implement that workflow

for example, a test function that can tell ‘how incorrect’ (the degree of incorrectness) a particular possible solution is would be useful for workflows where the workflow involves incremental changes to a base solution, or a workflow where the test feedback is applied to generate differences from an input solution

Identify structures where substitutions can be made to fulfill problem-solving intents like ‘generate new solution automation workflows using those structures’

example: a useful dichotomy is the ‘build’ and ‘test’ dichotomy, where a structure is created and a test is used to determine if that structure is useful for some intent/metric (similar to the ‘build’ and ‘limit’ dichotomy)

identifying that the ‘test’ component of that dichotomy (which is useful for various solution automation workflows involving ‘filtering generated solutions’) can be injected at multiple positions in the workflow is useful for generating other workflows

for example, the test can be done after the possible solution is generated

the test can also be done during the building of the possible solution

additionally, the test can be used to derive a limiting structure indicating a requirement used to reverse-engineer the possible solutions that start with that test-derived requirement as an input, rather than a function applied to the output

Apply intent as a filter of possible solutions to fulfill the problem-solving intent of ‘filter possible solutions’

if there is no reason to compute a particular solution to a problem (no agents have incentives to compute that), it is unlikely to be a component of a solution or a solution itself

example: if the value obtained by solving a problem (like ‘count all the particles in the universe with this property’) is minimal (like a value unit of 1) and the cost of computing the solution is infinite, it is unlikely that this problem would ever be solved, so its solution is unlikely to be a component of another solution (like ‘predicting what materials will exist on a particular planet’)

the solution is filtered out by applying ‘intent’—there will always be more useful problems to solve (‘predict material ratios in the universe’) as a component of a solution to the original problem (‘predicting materials on a planet’), so the problem ‘count all the particles in the universe with this property’ is unlikely to ever be solved be it will always be less useful than solving other problems, so that problem can be filtered out of possible sub-problems to solve in order to solve another problem, and its solution can be filtered out as a component of solutions to other problems

differentiation: this workflow identifies intent as a useful filter to identify possible useful sub-problems & solution components, to fulfill the problem-solving intent of ‘finding useful structures to fulfill problem-solving intents’

Identify problem/solution attributes like ‘difficulty’ that are especially useful in determining probable related structures like ‘solution structures’ of solutions related to that problem as these attributes are particularly useful through being particularly differentiating of relevant structures, such as structures of understanding

example: identify common structures of ‘hard problems’, like where structures of understanding (structures like ‘interfaces’, ‘interaction levels’, ‘important concepts’, or ‘sub-systems’) are missing, making it falsely appear difficult

for example, the p=np problem falsely appears difficult because people arent working with the concepts or interaction levels that would make the problem trivial to solve (for example, the classification of problems is incomplete, meaning the interaction level of problem types relevant to that problem is incomplete, and the mapping between problem type & absolute computation complexity (meaning calculated across all equivalently optimal computation methods) is similarly incomplete or a method to infer these mappings logically is not available

therefore, given that we know that the structures of understanding we have are inadequate to solve that problem, these known structures must be different from these concepts or interaction levels, so applying differences to these known concepts or interaction levels would likely generate the structures of understanding necessary to solve that problem

if its not true that the structures of understanding we have are inadequate to solve this problem, then all possible combinations of these known structures of understanding have not been applied, and solution automation workflows can be applied to these known structures to test each combination or filter all combinations for the more probably successful combinations using some workflow that filters solutions or some other workflow more efficient & effective than trial & error

for example, concepts like ‘recursion’, ‘self-reference’, ‘completeness’, ‘closed system’, ‘ratio of required computation to computability’, and other concepts relevant to this problems may be inadequate to understand the problem

other concepts can be generated to combine with these known concepts in new ways

given the definition routes of these concepts:

recursion: function self-reference

self-reference: function to differentiate internal from external structures (identify a boundary between internal/external structures)

completeness: fulfillment of a set definition

closed system: system that does not interact with other systems

ratio of required computation to computability: physical resource limitations

they can be combined or combined with other concepts to generate new concepts:

an existing combination is the combination of ‘infinite’ with the concept of ‘recursion’ to create an ‘infinite recursion’ error

a combination of these known concepts would be an ‘incomplete closed system’ which eventually degrades into chaos as it cannot sustain its independence from other systems

a new conceptual combination might be a ‘universe’ combined with a ‘ratio of required computation to computability’ to create the concepts of ‘computing a plausible universe where this computation is not required’, or a ‘universe-simulation machine to compute this required computation’ or ‘high variation or highly chaotic systems (like black holes and quantum particles) where this computation is likelier to be computable’ or the ‘limits of entropy reduction in creating a machine capable of such organization as that which would be able to compute the computation, applying “structures of organization” as an alternative metric to complexity when evaluating computability of a computation’ (can a machine be created that is capable of such organization that the computation is more computable)

differentiation: this workflow finds attributes that are particularly useful for the intent of ‘differentiation of usefulness of structures’ which is useful for problem-solving intents like ‘finding useful structures’

Identify useful structures like ‘states adjacent to solutions which include info that makes calculating the remaining info trivial’ that are useful alternative problem/solution structures like ‘proxy solution targets’ to replace those problem/solution structures in other problem/solution structures like solution automation workflows/interface queries in order to fulfill the problem-solving intent of ‘generate new solution automation workflows’ or ‘generate new solutions’

example: proximity to solved problems or states which are adjacent to solutions (states like ‘remaining information is adjacently determinable from existing information’)

differentiation: this workflow involves finding alternative structures (like ‘proxies’ and ‘solution-determined states’) to replace other structures in solution automation workflows to generate new solution automation workflows or other problem/solution structures

Identify identifying/determining/generative variables of useful structures (like opposites, spectrums, networks) of useful structures that are found to be common across problem-solving structures to fulfill problem-solving intents like ‘find/derive/generate new solution automation workflows’ and ‘finding useful structures to adjacently fulfill problem-solving intents’

example:

dichotomies/opposites like the dichotomy between ‘variables/requirements’ and ‘generative/limiting functions’ are particularly useful in problem-solving

networks like ‘equivalent alternate interchangeable functions’ or ‘functions forming interaction layers’ are particularly useful in problem-solving

interfaces like ‘structures that can support high variation’ are particularly useful in problem-solving

the interface variables of these structures are:

corresponding math structures of each structure (an ‘opposite’ structure might have a corresponding math structure of a ‘decision tree fork’ if they are mutually exclusive or a ‘spectrum’ if its a continuum)

structural variables

an ‘opposite’ structure can vary in terms of its exclusivity, continuity & other variables

other interface variables

a structure can vary in terms of its usefulness (composability, coordination with other structures, uniqueness, commonness of usage intents for which the structure is optimal)

what interface structures can be used to construct them (a ‘network’ is a ‘set of connection pairs’, an ‘interface’ is a ‘change-supporting structure’)

what intents theyre adjacently useful for (an interface is adjacently useful for ‘compare intents’, a ‘network’ is useful for ‘finding connecting paths’ and ‘finding similarities/differences between network nodes’)

what structures they can adjacently be converted into (an interface can be adjacently converted into a ‘network of networks’)

this workflow finds interface structures (‘variables’) fulfilling useful intents (‘identify’, ‘generate’) of interface structures (useful structural interface structures like ‘opposites’) applied to problem/solution structures (‘variables/requirements’) in order to fulfill problem-solving intents like ‘find/derive/generate new solution automation workflows’, and applies optimized variable values as filters (such as favoring core structures) to find probably useful structures

this workflow fulfills the problem-solving intent of ‘finding useful structures to adjacently fulfill problem-solving intents’ (like ‘variables/requirements’) to fulfill other problem-solving intents (like ‘connect problem/solution’) which those useful structures can adjacently fulfill

Find/derive/apply limiting structures like ‘requirements of problem/solution structures’ to fulfill problem-solving intents like ‘filter structures that can fulfill other problem-solving intents’ (problem-solving intents like ‘connect problem/solution’)

example:

find useful structures like core functions that can fulfill common problem-solving intents (like ‘connect’, ‘reduce’, ‘break’ applied to problem/solution structures) as initial/core components of solutions in the problem system to filter the set of possible components that can be used in solutions, as functions that can be combined to fulfill these common problem-solving intents are likelier to be legitimate/probable/realistic than other functions, as these intents are known to be fulfillable with any problem, so a solution is likely to adjacently use functions that can be combined to fulfill these common problem-solving intents

meaning: any solution whose core functions cant be used to build a solution using another solution automation workflow is unlikely to be an optimal solution be its unrealistic to find a system where one workflow can be applied and another cant

find input/output sequences of problem-solving intents like ‘find useful structures for problem-solving intents’ to fulfill problem-solving intents like ‘generate new solution automation workflows’ as a way of fulfilling problem-solving intents like ‘generating new solution automation workflows’, since ‘input-output sequences’ of problem-solving intents are a requirement of that particular problem/solution structure

this is related to applying interface structures to other interfaces, applying the requirement that if a structure is actually compliant with the definition of an interface, it will have a corresponding structure as that found on other interfaces

the difference is that the requirement is being applied to interchangeables like functions that can fulfill problem-solving intents, rather than interchangeables like interfaces

workflow differences: this workflow uses useful functions like ‘applying similar structures’ (‘limiting structures’ to fulfill similar intents as limiting such as ‘filtering’, given the structural similarity between limits/filters), applying it to problem-solving structures like ‘interchangeable problem-solving intent functions’

Identify probably useful structures (like common structures) of problem-solving structures (like solutions or solution automation workflows) that can be found/derived/generated first given their probable usefulness for other problem-solving structures

example: the following workflows to solve a problem like ‘find a prediction function’ would have some structures in common, such as a ‘function that is changed until its the solution function’, ‘solution components’, and ‘variables’, and the same can be said of other problem-solving structures like solutions or workflow implementations

identify variables of problem space and change until solution function is found

identify previous solutions to similar problems and change previous solutions until original problem is solved

identify requirements of solution and identify structures that can fulfill those requirements as possible solution components, combining them until a solution is found

identify structures that can be combined like interactive, connected, & probable structures and apply them in combinations as solution components until a solution is found

identify variables that solve subsets of the problem or sub-problems and combine those variables in the way that those subsets or sub-problems interact

solving for the common structures (the relevant variables or a filtered list of variables to test, the solution components, and a base function that can be adjacently changed to create the solution function are useful structures to find/derive/build first, after which other workflows can be applied to filter those structures

related workflows:

these workflows can be applied simultaneously and can inform the other workflows (when a ‘trial & error’ workflow identifies a sub-optimal solution, that can be filtered out in other workflows being applied simultaneously)

this set of coordinating workflows can be derived, as workflows that are probably capable of producing information that would assist the other workflows in the set in deriving information

Identify structures that can support variation (like solution automation workflows & their implementations) without degrading their structure as initial prioritized targets for variation (like workflow implementation variables) to apply when generating new problem-solving structures from a base/origin problem-solving structure (like solution automation workflows & their implementations), as indicated in the next solution automation workflow

identify that solution automation workflows can support high variation without violating their definition, so applying changes to these workflows is likely to produce other valid workflows

example: ‘break a problem into sub-problems & merge sub-solutions’ is a workflow that can act like an interface bc it can be implemented in many different ways without violating its definition

variables of this workflow's implementation include:

the sequence of sub-problems, the sub-problems themselves, the breaking/merging functions, the sub-problem solving functions

identifying variables of a workflow's implementation are a useful step in filtering the implementations as solutions to the ‘select a workflow implementation’ problem-solving intent which is solved by the interface query

this workflow includes the step of ‘identifying & applying variables of a workflow's implementation to generate solutions to the “select a workflow implementation” problem-solving intent & then filtering those implementations to design the interface query that implements the implementation of the workflow’

given these variables, the workflow itself can be adjusted, not just its implementation

because some sub-problems may be more important to solve than others, it's possible that ‘selecting one sub-problem to start when solving sub-problems’ or ‘selecting one sub-problem to solve to solve the original problem’ are alternate workflows, if enough variation is applied to make these steps similarly useful as the original step

to make these steps similarly useful as the original step, applied functions/structures need to have a reason why theyre applied (a reason why applying them would be useful, such as a reason why it would make the step similar to the original step)

example: ‘abstracting the sub-problem’ would make the sub-problem more useful bc a general solution is more potentially useful for ‘solving other/related problems’ and for ‘deriving abstract insights’, both of which are useful problem-solving intents that may be fulfilled by ‘abstracting the sub-problem’

applying such functions as ‘abstracting the sub-problem’ might make the new step ‘solve a particularly important sub-problem’ similarly useful as the original step ‘solve all sub-problems’

Identify structures of problem/solutions (like a sub-problem) that can be used in place of other structures (like all sub-problems) if enough variation is applied to make it similarly useful for a particular solution automation workflow using the original structure (like ‘break problem into sub-problems’) to generate other solution automation workflows (like ‘identify & solve a particularly important sub-problem to make the other sub-problems trivial/solved/irrelevant’)

examples of functions/variables to apply to the sub-problem to make it similarly useful as all sub-problems:

abstracting the sub-problem

identifying the most important sub-problem, such as an input sub-problem required to solve other sub-problems or an otherwise particularly required/causative/influential/enabling sub-problem

identifying the sub-problem type to identify the types that other sub-problems are less likely to be, as if theyre different from the other sub-problem, theyre likelier to differ in attributes like problem type as well

generative function of this workflow: apply ‘change’ structures to the original solution automation workflow (‘break a problem into subproblems & merge sub-solutions’)

Identify variables of structures of state changes between problem/solution which form solution automation workflows that are useful such as a ‘linear connection’ (find interim states to connect problem input & solution output) and ‘angular connection’ (find alternate system to convert to & back from) and ‘parallel connection’ (convert both problem/solution to different alternate system and solve problem there) and ‘extended linear connection’ (find cause of problem inputs or cause of solution outputs) and ‘connective lines’ (find solution components or find interactive components) or ‘filtering solutions by reducing items in a set to a single output’ (joining sequences with a fixed endpoint & traversing/reducing items, like a tree) or ‘injecting different/additional inputs/outputs or variables’ (increasing/reducing the problem/solution dimensions) and apply these variables to generate new solution automation workflows

Identify useful structures (like connection between structures) to fulfill intents like ‘find missing information about a full structure’ which combine problem-solving intents like ‘find missing information’ and specific problem contexts ‘the solution structure is the remaining structure to find the full structure’ in a combination (‘find missing information about a full structure’) to use these useful structures to fulfill those mixed/merged/combined intents

example: identify sub-structures (an arc) that can imply another structure (a circle) as a way of connecting structures that are particularly useful to connect, for cases where info about the full structure is missing, to fulfill problem-solving intents like ‘find missing information’ if the problem is formatted as a ‘missing information’ problem format, specifically for the format where the ‘missing information’ is the remaining structure of the full structure

a generalization of this is to find these structural connections that are particularly useful, and find the versions of them in different formats (like when finding ‘information about a full structure’, in which case information about connections between partial/full structures is particularly useful)

Identify structures that can be used as filters of solution structures like solution components, based on insights connecting relevant structures like solutions/errors (‘solutions should be as different as possible from errors’)

example: an ‘optimal/good’ solution function range can be built with a set of functions/variables, but if one of those functions/variables can convert a solution in that range to a bad solution with minimal effort (as in a probable change or adjacent/linear combination), those functions/variables are less likely to be the correct set, be a system that is observable (such as the system described by the variables) is usually more stable & therefore consistent over time & robust to change

Identify structures (‘function sets’) with the same useful metrics (‘differences producible with that structure’) that can be used to connect useful structures like ‘different abstract layers of a problem-solving intent implementation’ or ‘connect inputs/outputs’

example: identify function sets that produce the same difference types/degrees/levels/structures and use these as default alternate abstraction levels of an implementation of a problem-solving intent (the different layers & sub-queries of an interface query)

Identify functions like ‘combine’ that fulfill core structural insights like ‘small components can usually be combined to build larger components’ (with variants like ‘small components can be combined to build larger components, once specific functions are applied at various points in between applications of the combination function’) to determine how input/output formats can be connected and what structures the inputs/outputs can be

example: a ‘function network of function networks’ can be used to represent a ‘two-step combination of components’, where the components are formatted as inputs to the second-degree functions in the ‘function network of function networks’, and the outputs are the outputs of the largest interaction layer (the first-degree ‘function network’), which is how smaller components can be combined to build larger components

another example is where multiple sets are the input and a single object is the output, either through a ‘merge’ function (like ‘average’) or a ‘select’ function (like ‘test/filter’), which fulfills core structural insights like ‘multiple objects can be merged into one object through functions like averaging functions’ or ‘a set of multiple objects can be filtered to a set of one object’

these functions (‘combine’, ‘merge’, ‘select’) also determine what format the inputs/outputs can be (inputs to functions in the function network, objects in a set, a set of similar sets), so if the problem definition states what format the input problem & output solution are, a default structure generated by these core structural insights can be derived to connect the problem input & solution output or an adjacent transform of them to use these generated structures, depending on the likelihood of their applicability to the problem and what structures are available (whether functions that can be used in the function network are known or should be populated with standard/core/common functions)

these structures generated by these core structural insights can be modified according to the problem, such as by adding more layers to the function network if the inputs are very different from the outputs (and therefore unlikely to be fulfilled by the default function network), adding other networks, etc, where a default structure is insufficient, either iteratively using adjacent transforms or by running multiple parallel processes to evaluate maximally different versions of the default structure such as an example of each common solution type (common types of multi-layer function networks)

matching the difference between the problem/solution with the difference allowed by the structures connecting them is an example of applying the intent interface, to find differentiating structures to fulfill an intent like ‘differentiate the problem/solution with these difference types/degrees/levels’ (a ‘function network’ being a structure that fulfills specific intents such as ‘combine inputs with these functions to differentiate with the same degree of difference as the known inputs/outputs’ in fulfillment of general intents like ‘differentiate inputs/outputs using available functions’)

Identify relevant structures of a structure to fulfill useful common intents like ‘identifying whether a structure is complete’ or ‘identifying structures that change another structure’ and ‘formatting a structure in its complete form’ which are adjacently useful for problem-solving intents like ‘identify missing information’ and ‘identify inputs/cause’ and ‘identify the fit of a structure in a system context’

example: a network has relevant structures like nodes/functions, network states, nodes represented as functions or functions represented as structures of common core functions (‘common core’ meaning on a different interaction level that can generate the original function set), structures like combinations of nodes or common structures, and queries on the network as well as the associated input/output pairs & input/output differences associated with those queries, without which its definition is incomplete, not having the ‘intent’ or ‘meaning’ interface fully applied to its core structure of the network

similarly, a tree has relevant structures like variance injection points, where a logical tree representing a function like a script can be interrupted by another logical tree like a process manager function or by a logical tree representing electricity or system usage/wear, so representing functions like a logic tree in isolation of other relevant structures is likely to cause misinterpretation of that function

Identify info adjacencies by mapping interface structures to other interface structures which can be mapped to useful structures like error structures as a filter to find changes to apply to a suboptimal solution

example: derive alternate complexity structures (like a term with a zero coefficient in some cases and a non-zero coefficient in others, which could be created by structures like neutralizing/antagonistic structures) to explain errors associated with those structures (like mismatch errors)

Identify change structures like change potentials and change interaction potentials to filter set of solution components like functions/variables, to filter inputs by rules like ‘whether the components are capable of producing the change types necessary to generate the outputs in a way that fulfills known common/probable system dynamics/intents like how more stable systems tend to be simpler with robust randomness handlers’

example: derive the possible changes (‘increase’, ‘weight’, ‘reverse’, ‘rotate’) that a possible structure (a possible/probable input function/variable, like pixels or pixel groups or pixel difference groups) can create across various systems (like ‘changes in similarity to adjacent pixels’), and whether those systems or changes are reflected in other structures (could other variables be explained by that increase/weight/rotation/reversal, are there anti-structures invalidating its changes), to determine the probability of a particular possible structure (function/variable) as a component of the solution, weighted by the likelihood of the systems/components that allow it to be a component of the solution

Apply useful structures like interface structures (‘cause’) of useful structures (‘difference’) for problem-solving intents that are fulfilled by those useful structures (‘apply differences to generate alternate inputs’ to ‘get more input data’)

example: apply ‘causes of difference’ to generate alternate inputs that are probable to use as additional inputs (such as ‘how a particular size of a component may produce a more smooth surface as it may interact with more components be there are more components at that size it is likely to encounter’ which applies the ‘cause of difference’ of an ‘interaction level’)

this is similar to the ‘apply error distortions to generate alternate inputs given various probable reasons for errors (like randomness or data corruption error or sampling error)’ workflow, but rather than applying differences according to error types, apply differences according to probable causes of differences to generate alternate inputs

Apply useful structures like differences/similarities of problem-solving objects like problems/solutions to generate relevant structures like probable inputs/outputs given either inputs or outputs to fulfill problem-solving intents like ‘derive the inputs/outputs that are missing’

example: if a function is supposed to drastically change the inputs (a high input/output difference degree), generate maximally different outputs according to the inputs and use these maximally different outputs as a default solution space to filter, (if the function is supposed to connect the inputs/outputs using as few changes as possible, meaning the inputs/outputs are supposed to be similar, do the opposite by generating outputs that are very similar to the inputs, and use these outputs as the default solution space to filter)

Apply ‘implied prevention structures’ derived from probable solution components as filters of possible remaining solution components and weight these remaining inferred solution components according to the certainty of the probable components

example: if a subset of a function is probably a particular line and another subset is probably another particular line, and they form an implication of the missing subset between them (like how ‘\/’ implies ‘\_/’), these structures act like a ‘prevention’ structure that filters out the implied_section at a specific probability, which when combined with other probable solution structures & the structures they prevent/filter out, can be used to infer probable remaining structures, especially where probable remaining structures are repeated across many implied structures by probable solution structures, to identify which structures are the most prevented, most implied, most required, and/or most allowed as a determinant of the most ‘probable’ solution components, to use as a solution filter based on probability

Apply useful structures like ‘approximate’ and ‘range’ which combine to form other useful structures like ‘probability’ to existing solutions like ‘averaging existing solutions’ to fulfill generated associated problem-solving intents like ‘find a range of probable solutions rather than one optimal solutions’ (which itself is generated by applying a change ‘multiple’ to the ‘solution’ structure and a change ‘probable’ to the ‘optimal solution’ structure to standard problem-solving intents like ‘find an optimal solution in a solution space’)

example: values for a predicted output variable that overlap with the most ranges of solutions within a range of solutions having a particular accuracy rate

if the set of solution functions of solution type x within accuracy range 10% overlaps in a particular area with the set of solution functions of solution type y within accuracy range 10%, that area should be prioritized as the actual solution area (where individual solutions in the solution area are solutions in the set described by that area)

this also involves applying useful structures (like ‘probability’) to generate new problem-solving intents that can be fulfilled by applying relevant associated structures (‘range’, ‘approximate’) to the problem space

Identify useful structures like ‘information adjacencies’ in solution automation workflows (‘sequences of steps’) that can capture variation that is unlikely to be captured in a standard solution workflow or ‘step sequence’ given available info which may be handled by alternate functions better than the original workflow function

example: ‘predict pieces of the solution’ and then ‘predict the solution from those pieces’ instead of ‘predict the solution’ be the inputs are unlikely to contain all of the info required to generate the exact solution, but either input of the two sub-functions is likely to be able to be used to generate/predict the output of that function, compared to the input/output information difference of the original function

Identify useful structures like ‘sequences’ of ‘information adjacencies’ based on structures like ‘limits’ & ‘filters’ and concepts like ‘completeness’ which produce useful structures like ‘requirements’ and use to derive information required for a solution

adjacencies include:

useful structures like a “combination of an information structures (like insights)+randomness” to account for possible changes to that known structure, where the insight is the adjacent information needed to calculate the target information of the actual version of the insight in a particular system, since another insight is that ‘few insights are absolute and they often have variants depending on context’

a limit that creates a requirement for the complementary/remaining structures (like one-hot encoding or the last remaining piece of an almost complete puzzle), where the complementary structure is the adjacent information needed to calculate the target information

structures like a complete set can be used to infer or guess the remaining items in a set, similar to how sequential patterns can be used to guess missing items in the sequence

an object that differs is likely to be a source of variables, and a set of variables are likely to be a source of solutions in a system, so identifying objects that differ is the adjacent information needed to calculate the variables, which are the adjacent information needed to calculate the solutions in a system

structures that create adjacencies include interfaces, so identifying the interfaces in a system makes other calculations more adjacent, so the interface acts like an information adjacency, where a sequence of interfaces can act like a sequential information adjacency leading to the target information

solution success cause: this works be it applies the insight that ‘all information is connected’, so iteratively calculating sequences of adjacent information can lead to the target information or at least the requirements of the target information that can define it further than its original description in the problem statement, similar to calculating functions earlier/later in a sequence to determine the missing function in the sequence

Identify any differences that could be errors (such as ambiguities or missing information) that can be resolved without violating a solution metric & apply difference-resolution methods to resolve those differences, merging these methods & their results as needed to fulfill such optimization as ‘preserve the original system, avoiding excessive changes where possible’ and/or fulfilling problem-solving intents like ‘avoid violating a solution metric’

example: often an ambiguity may be resolved by applying filters or functions that leave one possibility, creating a requirement in that one possibility, and invaliding further application of functions to resolve the ambiguity as the requirement of the one possibility has been determined already

this applies a general workflow of ‘identifying structures that any problem can be formatted as, such as differences which are a core error structure’ and specifically applies the value of structures likely to already exist or be adjacently derivable in relation to those structures such as difference-resolution methods like ‘connecting a problem state with a solution state’

Apply requirements to solution-finding methods (including interface queries, solution automation workflows, specific solution-finding methods, etc) by finding/deriving/building structures of the solution-finding methods

example: for a problem that can be identified as having a high probability of a complex solution given the simple solutions filtered out (by another workflow/query or by existing failed solution data), apply solution-finding methods that are complex and/or capable of storing/creating complex structures which are likelier to be relevant to the actual structures of the solution

Apply useful structures like ‘changes’ to find/build/derive useful structures like ‘interaction rules’ of meaningful structures like ‘definitions’ which are meaningful in providing structures like ‘limits/requirements/interfaces’to apply changes to, to fulfill problem-solving intents like ‘apply changes to a standard solution to improve the solution’

example: apply ‘randomness’ to generate functions that are random (rather than meaningful) as a way of generating ‘not solution’ structures, given that ‘randomness’ is an opposite structure of ‘meaning’

similarly ‘organization’ structures (like ‘sequences’ which by definition have inherent order) can be a structure useful for generating solutions, given that solutions are by definition not random

a solution to the ‘find a prediction function’ problem cant be a random function of inputs, so it will inevitably be different from ‘random functions of inputs’

in the case where the ‘random function of inputs’ has an overlap with the ‘actual prediction function’, it is bc random structures can by definition create every possible structure (possible solution), not bc it magically found the solution, as a random function has no way of differentiating significant variables/coefficients and predicting whether it is likely to have found a good solution before testing it

applying random structures to ‘interim structures’ like sub-optimal solutions, solution components/requirements, & available/adjacent functions is likelier to produce a solution than applying randomness to the original inputs bc these structures are by definition nearer to the solution than the original inputs and ‘random changes’ are likelier to be useful in randomly generating the solution itself

this means a solution structure should be composed primarily of structures for a particular reason (like that they are core structures or structures which are likely to interact) rather than for no reason (like randomness)

randomness can be applied to sub-optimal solutions once the primary meaning structures have been applied, as a way to temper error structures like ‘lack of information’ or ‘incorrect input information’

this workflow involves applying definitions to find the correct position to apply a structure in (apply randomness to adjust a standard solution to handle error structures, after applying organization structures to create a standard solution)

it also applies the ‘differences in variable structures’ that can create a ‘difference in solution/error structures’ (structures of volatility in crossing the threshold between the definitions, structures of robustness in finding interchangeable alternate variable subsets maintaining a state, etc)

simplification: this workflow identifies differences in useful structures like definitions (specifically interface structure definitions, like the definition of meaning) that can be used to infer structures from other structures

generalization: this uses the variables/functions of definitions to infer rules that can be applied to fulfill problem-solving intents related to definitions, like ‘finding the correct position to apply a structure like a definition’, using insights about definitions like that their structure provides ‘organization’ structures which can be used as a foundation/limit to apply changes to, similar to how a standard solution structure can be used to apply differences to in order to improve the solution

Apply the structure of the ‘inject’ function as a way to find/build/derive a solution, as a core (explicit structural) interaction function (like ‘connect’, ‘reduce’, ‘combine’, ‘change’ or ‘filter’)

example: a ‘neural network’ structure is a ‘sequence of changes applied to (a sequence of changes applied to inputs to connect inputs/output vars) to connect input standard solution to output improved solution’

where ‘sequences’ are a standard structure used to create ‘connections’, so ‘sequences’ are by definition relevant for solving a ‘connect’ problem (like ‘connect inputs/outputs’ or ‘connect states’)

where ‘sequences of changes’ are used to create ‘connections’ between specifically ‘different’ structures

injecting iterative structures of ‘random mappings’ is a way to add ‘randomness’ to a structure

injecting a ‘query for a solution’ in place of a ‘solution’ is a way to add ‘variation’ to a solution structure (like an interface query with sub-queries to ‘find info’ or ‘find a sub-solution to a sub-problem’)

injecting ‘variation’ in structures like functions/inputs adds ‘generalization’ to an output structure

this ‘inject’ function works be ‘injecting’ a useful structure like a ‘variable’ adds a structure that can handle more complexity, making a solution more robust

generalization: the general version of this is to find/build/derive functions that can connect various formats (like ‘injected sequences’) to fulfill core interaction functions (like ‘connect’) in problem-solving intents (like ‘connect problem-solution’) of a solution-finding method (like a ‘neural network’) for a problem format (like ‘find a prediction function’), and use those functions as alternative problem-solving functions

Apply useful structures like ‘solution automation workflows’ or interface structures like ‘variables’ having outputs in common to create interchangeable useful structures like ‘new/different solution automation workflows’ or ‘changes to solution automation workflows’ to fulfill the problem-solving intent of ‘improving an existing solution structure’

examples of solution automation workflows that may have similar output solutions:

changing the definition of a solution as a ‘structure without certain/definitive error structures’

example: a function that does not produce outputs in the ‘known error ranges/areas’

applying complementary structures like errors/solutions to create requirements of what is not a solution

example: known error structures can be used to determine what is not a solution and what is possibly a solution

examples of solution automation workflows with high probability of different output solutions:

applying contextual structures like ‘an error, in the case where the function has this many other errors’

example: some functions would only count as sub-optimal if they produce errors above a certain threshold, so an individual error is only an error if other errors also exist

applying solution structures to filter solution space

example: ‘incremental changes’ are part of the definition of a standard prediction function for a data set, so a solution should have ‘incremental changes’ (ruling out step functions, hyperbolic functions, etc)

applying differences to structures that can be used to derive solution structures like solutions or solution automation workflows

example: if a subset of the data set can be used to derive the prediction function, apply differences to the subset to find out the limits of what other subsets can be used to adjacently derive the prediction function (like a certain level of difference & pattern-compliance across subsets that can be used to derive it)

the ‘different-output’ solution automation workflows have differences in standard structures like different functions/inputs/outputs

the ‘similar-output’ solution automation workflows have similarities in functions/inputs/outputs

if a solution is sub-optimal like a standard solution may be, applying differences to the functions/inputs/outputs of the solution automation workflow may create a more optimal solution automation workflow to apply, once the set & interface of solution automation workflows that can generate the standard solution is derived/found/built so changes can be applied to it

related requirements filter which similarities/differences are meaningful

requirements like ‘identify in what position a definition should be applied’

when a difference is an ‘error structure’ or a ‘sub-optimality structure’, given that a difference can be either (errors dont have to be in very different positions, they can be adjacent to solutions), as a ‘difference’ isnt equal to an ‘error’ by definition, so it can only conditionally be applied to generate/find/derive errors

different workflows can produce the same solution if they are similar in their error structures or solution metrics like accuracy, even with very different workflow functions/inputs/outputs

applying workflows to workflows, like the following is a way to derive more optimal workflows:

‘starting from the solution metric of a workflow like accuracy & reverse-engineering the workflow applied to create that output’

‘applying variables to sub-optimal workflows to create more optimal workflows’

this is be there are ‘ranges/areas of optimality’ in the solution ‘workflows’ to the problem of ‘find an optimal solution automation workflow’ just like there are very different solution ‘prediction functions’ having the same ‘solution metric value’ of the same ‘level of error’ for the problem of ‘find a prediction function’

there are workflows that are similar in some variables (functions) and different in others (inputs/outputs), where the similarities may be meaningful (related in cause) or meaningless (random coincidence or common/required structure)

these similarities/differences can identify ‘volatility’ or ‘threshold’ points where the outputs start to vary disproportionately relative to the outputs of adjacent inputs

at what point does a ‘cause’ become a structure of meaning (direct, unique, functional, unambiguous, variability, limited alternatives, intent, usage) or a structure of randomness (core, common, required, constant, ambiguous, or complex as in ‘not understood’)

what structures can change one or more of these variables across a threshold (solution structures), to overcome alternative structures of those variables (other structures that keep it a solution as opposed to crossing a threshold)

this is a question of the meaning of a ‘definition’ of complementary opposing structures (like solutions/errors)

structural distance: what differences in components/shapes/connections/inputs/outputs do the solution/errors have

change distance (‘conversion potential’): how many variables of a solution need to be changed to change it to an error & to what degree

solution definition variables: how flexible is the solution metric, allowing what variables to be changed while still qualifying as a solution

interchangeable alternates: what variable subsets can replace other variable subsets (how robust is a solution to being changed into an error)

determining capacity (identification requirements): what ratio of variable values is required to determine if a structure is a solution/error (required identifying attributes)

ambiguities: are there overlaps or unresolvable structures of neutrality in solution/error structures

generative capacity: can a variable subset find/derive/generate the other variables, and what variable subsets can be either solutions/errors

cause:

what similarities in cause do the solutions/errors have, given that they exist in the same system

what differences can by definition cause a solution/error even in isolation of a ratio/type/degree of other differences (powerful/robust solution/error causes)

the structures inherent to these workflows (the ‘solution structure’ and the ‘change structure’, respectively) indicate structures that can be applied which can have the same impact on the output

a ‘change’ structure can have the same impact as applying a ‘solution automation workflow’ to a ‘solution automation workflow’, be a solution automation workflow is a powerful source of change as well as a change-resolver (difference-reducer)

simplification: this workflow involves finding useful problem-solving structures with similar impact/outputs and applying those as alternative structures to generate new solution automation workflows, for the problem-solving intent of ‘improving an existing solution structure like a solution automation workflow’

Apply structures like ‘randomness’ which have a connected useful attribute like ‘complexity’ (‘randomness’ having the output of adding attributes/functions like ‘adding complexity’, ‘adding generality’ and ‘offsetting an imbalance in randomness’) to create useful differences in problem/solution structures that are likelier to solve problems in ‘problem space systems’ having those attributes (more complex systems)

this workflow applies useful structures (like cross-interface ‘structure-concept’ connections) to optimize interaction functions specifically between problem/solution structures, so they are likelier to reflect true connection functions (insights)

the more similar a problem space system or solution is to reality, the better it can be used to solve real problems

randomness is a ‘shortcut’ to complexity, not equivalent to complexity, but it is easier to add than a set of insights about the system

Find interface structures that are useful for problem-solving intents like ‘reduce computations required to solve a problem’ such as ‘interaction levels’ by applying ‘solution filters’ (like ‘attributes of interaction levels’) to the solution space of ‘all possible useful interface structures’, in order to find useful interface structures like ‘interface queries that solve multiple problems’

attributes of interaction levels include ‘a level of specificity/abstraction that doesnt reduce the supported complexity’

attributes of useful interaction levels include ‘having a reduced set of structures to reduce the required structures to represent other structures’

applying solution automation workflows to solve the problem of ‘finding optimal interaction levels to run interface queries on, given their definitions or attributes of useful interaction levels’ would also solve the problem of ‘filtering the solution space’ and ‘reduce computations required to solve a problem’

these queries are ‘interchangeable alternates’ generating another ‘useful interaction level’ of ‘interface queries that solve multiple problems’ which are likelier to be useful than other interface queries

Apply interface structures like ‘attributes’ of problem/solution structures like ‘solution automation workflows’ to fulfill problem-solving intents like ‘connect’ applied to other problem/solution structures like ‘specific solution-finding methods like “regression” for a particular problem format like “find a prediction function”’

example: for the ‘find a prediction function’ problem, this would take the form of finding interface structures like ‘interim solutions’ between other solution states created by applying different solution automation workflows, solution-finding methods, interface queries, and other problem/solution structures, then finding ‘connections’ between those solution structures

for example, finding the connection between a standard constant regression line, a set of connected subset lines produced by tangents of input vertexes (important data set points determining or representing the data set), and a solution produced by applying a different error-minimizing metric, different ‘average’ representation definition, or a function-adjusting method like a generalization or regularization method

each of these solutions would be produced by different solution automation workflows, interface queries or other problem/solution structures, and each of these solutions is connectible to the other, and the connections between solutions reflect the parameters of the variables of the problem/solution structures applied to generate them, indicating a ‘solution-connection path’ that is findable & applicable to find solutions from other solutions, to find a particular solution having specific attributes of the problem/solution structures applied and possibly also specific attributes of the solution itself such as solution success probability or a particular solution metric value

for example, the interface structures to produce a ‘standard solution’ may involve applying structures such as a ‘standard/default/unit definition’ of the ‘input requirements’, and the structures required to produce a more optimal solution may be ‘connections between determining/generative/causative inputs’

a ‘connection function’ between these two sets of interface structures would include:

‘apply a definition of “relevant” inputs’

‘fulfill problem-solving intents like “connect problem input data points & solution output prediction function” for relevant inputs’

this ‘connection function’ can be applied to generate other more optimal solutions from a standard solution

a ‘generative function’ of a solution would include:

‘generate a standard solution by applying standard interface structures or a standard solution automation workflow’

‘merge solution automation workflows to reduce the work of applying multiple workflows (such as where steps executed during iterations of solutions are executed simultaneously to reduce iterations)’

this can be used to generate solutions having particular solution metric values, like ‘higher accuracy’ to reliably generate standard solutions & improvements to a particular solution

these ‘solution-generating’ and ‘solution-connecting’ functions can be applied to fulfill problem-solving intents like ‘connect input-output sequences’ applied to solution structures, applied specifically to ‘connect solutions of varying optimality’

workflow requirements: this workflow involves pre-calculating some structures (like ‘solution-connecting functions of solutions produced by solution automation workflows’) to reduce future required computations (‘a full interface query’, as opposed to a ‘solution interface query involving only pre-calculated structures’), by finding the structures that would be most valuable to pre-calculate, out of all the structures that follow rules & can be calculated, like ‘connections between standard & optimal solutions’ or ‘connections between optimal solutions’

Apply useful structures like ‘structural similarities on interaction levels’ to problem/solution structures like ‘interface queries’ to fulfill problem-solving intents like ‘find/derive/generate more optimal solutions from standard solutions’

example:

for the problem of ‘find equivalence between structures’, interface queries to solve the problem would include:

‘define equivalence as similarity of determining structures like interchangeable usage contexts or input-output sequences’

‘check different inputs/outputs of structures to compare, and assess their difference by differences between input-output sequences’

‘define equivalence as zero work required to equalize structures’

‘create the target solution structure (a difference) or an adjacent transform of it (equivalence), and apply the ‘differences required to create it’ as an identifying attribute of their difference’

‘create an equivalence & assess differences required to create it’

‘reduce differences between input structures to compare, then compare the input structures once differences have been reduced, assessing similarity by how many & what type of differences needed to be changed in order to create an equivalence’

‘define equivalence as similarity of values of differentiating attributes’

‘check each attribute of input structures to compare, and apply the comparison function to check for similarities/differences in each attribute’

interface structures like ‘connections’ between various interface structures such as ‘interaction levels’ of these interface queries follow rules which can be automated

for example, the differences in the ‘top’ or ‘initial’ interaction levels of the queries of each interface query (the lines including ‘define’) can be connected by applying different definitions of ‘equivalence’ or other variables (like ‘direction’) to the problem

the differences in the ‘secondary’ interaction levels of the queries are connectible in their usage of specific problem space structures (like inputs/outputs or differences of structures to compare) implementing those definition/direction variables

different interface queries can connect these interface queries on different interface structures like interaction levels using similarities, like how a function to ‘find differentiating attributes of inputs’ is similar to a function to ‘compare inputs’

these interface query interactions such as ‘connections’ can fulfill problem-solving intents like ‘switch to another interface query that is more optimal (as in likelier or known to produce a more optimal solution)’ or ‘test multiple interface queries’

general interface queries to connect interface queries include:

‘apply interface queries that can fulfill a solution metric like “preserve complexity of inputs in outputs” to avoid error structures of a standard solution like “loss of relevant input info”’

‘merge interface queries requiring the same functions or inputs to maximize probability of a query finding an optimal solution’

solution success cause: this works be connecting two high-variation ‘problem-solving’ interfaces like the ‘interface query’ interface and the ‘solution’ interface or the ‘solution-finding method’ interface creates a new interaction level where these structures can be found/derived/generated from each other since theyre connected/comparable & otherwise operable on that interaction level

generalization: fulfilling problem-solving intents like ‘connect problem/solution’ or core interaction functions of problem/solution structures like ‘connect’ applied to problem/solution structures is likely to generate useful structures, like ‘interface queries to find optimal interface queries to solve a problem, given a standard solution & the derived interface queries used to create it’

implicitly, the workflow ‘derive interface queries that can be used to find/derive/generate a known solution, find structures to optimize these interface queries to find more optimal variants, and apply differences to these optimized interface queries to find more optimal solutions, and apply differences like abstractions/specifications to these interface queries to find variants of them like solution automation workflows derivable from the queries’ is referenced in this workflow

Find the variables of change that would determine a solution using a particular solution-finding method in some optimal way & apply those to the solution-finding method

there are two values of the ‘direction’ variable in which a straight line (standard solution) can vary (if the accurate solution prediction function is a parabola with one peak) in order to test whether the positive/negative change is the right direction of change, but there are multiple values of the ‘position’ variable in which the straight line can vary

it is trivial to configure a neural network to support testing these changes in an optimal way, such as using ‘maximal differences’ to find a function of ‘big-change contributing variable’, then ‘minor differences’ to adjust the possible alternate functions produced by the previous change type

Identify useful structures like ‘sequences’ of useful structures like ‘change types’ that would find a solution optimally in some solution metric when applied in some position of a particular problem/solution structure (like a ‘solution-finding method’) in a particular problem/solution format

example:

useful change types include the following:

applying a set of changes in opposing directions & then checking for improvement in the solution metric (like ‘difference from the optimal position of a miminized error’)

applying big changes initially to differentiate solutions and then small changes after the initial change to check for adjacent solutions to initially differentiated solutions

a ‘sequence of these change types’ applied to a useful structure for the ‘neural network’ solution-finding method format in the position of ‘weight updates’ might be more useful than applying them in randomly selected variables

‘applying big changes initially, then small changes’ would also be useful for identifying highly causative or predictive variables quickly in a neural network (as in how some variables explain more change than other variables) and by delaying the application of ‘small change-contributing variables’ until later, we can avoid randomly or generally applicable functions to adjust the function of ‘big-change contributing variables’

first identify a standard solution composed of ‘big-change contributing variables’, then adjust the standard solution using ‘small-change contributing variables’, which is a specific implementation of a solution automation workflow involving ‘applying changes to a standard solution’ applied to the ‘solution-finding method format’ of a ‘neural network’

configuring a neural network or another solution-finding method to enable testing these structures of change structures is trivial, just like configuring a network to support ‘combination’ change types is trivial, or configuring a network to support various weight-update types/degrees is trivial, and configuring a network to support all possible input subsets & n maximally different coefficient sets is trivial (like with a ‘difference-maximizing weight initialization function’), a configuring a neural network to support change types that vary within ranges/positions of determined optimals (by applying optimization structures, solution structures, anti-error structures, etc)

testing every possible useful neural network that uses the structures referenced in solution automation workflows is another adjacent solution

a variant of this is to apply ‘common’ useful change types to create a solution

apply changes to core variables like the ‘count’ of a variable value

apply a ‘position’ change type to the input variables of a neural network to represent variables emergently (as an additional variable to apply to the ‘neural network’ solution-finding method) when they can be constructed by other variables

apply the ‘opposite’ of or ‘differences’ to the ‘negative’ structure (error structures, sub-optimal solutions, neutral structures)

differences in optimality of solutions & converting one to the other by ‘optimization potential’ of one solution

common attributes & other structures of successful solutions and successful solution structures such as ‘successful solution types’, like ‘solutions that optimize for multiple metrics’

paths to connect different solutions & inputs to workflows/queries that create ‘common solutions (solutions to multiple problems)’

Apply ‘interim structures’ of a particular solution automation workflow, optionally in a particular problem format, and/or using a particular core interaction function associated with the workflow to ‘problem/solution structures’ to find structures linking the workflow with filtered interface queries such as for ‘related useful structures’ more directly, as the ‘interim structures’ are inputs or adjacent structures to the useful structures & other query objects, which can be derived once the ‘interim structures’ are found/derived/generated

‘connecting attributes of a problem structure with attributes of a solution structure’ is how to fulfill the ‘connect problem/solution’ problem-solving intent using a ‘connection sequence’ structure in or created by a workflow/query

‘connecting problem state with solution (or at least more optimal or neutral/not-error) state’ in a ‘state sequence (composed of changes, change units like functions, change outputs or their impact on previous objects in the sequence like state)’ in or created by a workflow/query is how to fulfill the ‘connect problem/solution’ problem-solving intent

‘connecting problem space with solution space’ and ‘connecting solution space with possible solution set’ and ‘connecting possible solution set with optimal solution subset’ are ways to fulfill the ‘connect problem/solution’ problem-solving intent using a ‘connection sequence (composed of filters)’

‘connecting problem space system with the optimized problem space system without the problem’ is a ‘state sequence’ in or created by a workflow/query that fulfills the ‘connect problem/solution’ problem-solving intent

‘connecting problem with the problem cause, and connecting the problem cause with a solution to the cause’ is a ‘set of state sequences’ in or created by a workflow/query that fulfills the ‘connect problem/solution’ problem-solving intent

‘connecting problem with all possible optimal solutions’ is a ‘connection network’ structure or a ‘set of connection sequences’ structure (if there is more than one optimal solution)

there is always a way to format a problem as a ‘find a connecting structure’ problem (connecting problem to a related/causal problem or connecting solutions or connect problem/solution or multiple included versions of these), ‘connect’ being a ‘core interaction function’ that is implemented in a problem-solving intent (‘connect problem/solution’) as a way of implementing a useful structure (‘change one state to a more optimal state’)

different problem/solution structures are involved in these examples be different problem/solution structures are used in different workflows/queries to fulfill the ‘connect’ core interaction function, but the problem/solution structures allowed are determined as adjacent (and possibly limited) by the problem format:

‘find a structure that fits another structure’ can connect some ‘attributes’ of the problem to the ‘attributes’ of the solution structure, so ‘attributes’ of the structures are particularly relevant for fulfilling the ‘connect’ core interaction function for this problem format

‘convert problem state into solution state’ or ‘move problem state toward solution state’ can connect the ‘position’ of the problem/solution indicating their ‘similarity’ using ‘changes’ applied to the sequence object (state, format, etc), so position/similarity/changes are particularly relevant for fulfilling the ‘connect’ core interaction function for this problem format

‘filter possible solution set’ can connect a ‘set of solutions’ with a ‘filtered subset of solutions’, so ‘solutions & solution attributes like possibility/probability/relevance’ are particularly relevant for fulfilling the ‘connect’ core interaction function for this problem format

these structures can be stored as ‘useful structures to apply when a particular core interaction function & problem-solving intent combination is applied to particular problem/solution structures’, and they can be found/derived/generated by the functions that can connect a problem with the resulting useful structures (like ‘connecting problem space system with the optimized problem space system without the problem’), at which point the structure is specific enough to be useful & invalidate the requirement for finding the problem/solution structures to fulfill the ‘connect’ core interaction function for, and other related useful structures can be applied to apply the useful structure, such as ‘input-output sequences’ being a relevant useful structure to ‘connection sequences’, ‘state sequences’, and other sequence types

these can be called ‘interim useful structures, given variables like problem/solution structures, core interaction function, and problem format’ which connect a solution automation workflow and help filter the set of possible interface queries

Identify the probability of solution automation workflows to identify different/similar solutions & prioritize structures of solutions like ‘attributes of successful solutions like solutions to multiple problems’

example: ‘trial & error’, ‘break a problem into sub-problems’, and ‘apply useful structures to find interactive structures to connect problem/solution’ may produce similar/different solutions

a variant of this is ‘finding solutions that are commonly produced by solution automation workflows for a particular problem format and applying those as a pre-filtered solution space to initialize the search for the more optimal solutions’ (reversing the logical direction of the workflow, or applying workflows from both directions (optimizing/finding solutions first given solution patterns, or optimizing/finding solutions first then applying standard problem/solution connection functions))

Identify structures that are likelier to be useful in a particular solution-finding method (like ‘neural network configuration’) in a particular problem format (like ‘find a prediction function’) as a way of ‘finding useful/error/solution structures’ for problems in general

example: for the ‘configure neural network as a solution-finding method’ problem applied to the ‘find prediction function’ problem format, how to introduce variation in the ‘prioritized structures’ of a neural network (like ‘combinations’ and ‘subsets’) to cover testing of more possible useful change structures in the network, without reducing the variation in weights applied to other structures (like ‘combinations’)

problem: if you add ‘subset’ structures to a standard dense network that applies ‘combinations’ by default, you get sequences like this, which reduces the number of different possible weights applied to the ‘combination’ structure

subset(all layer outputs) as input for ½ of the next layer nodes

combination(all layer outputs) as input for ½ of the next layer nodes

possible solution space:

you can apply ‘unit’ structures (‘components of original features’ or ‘original features’) that are likely to build the target structures (‘combinations’, ‘subsets’)

subset_and_combination_components(all layer outputs) as input for all of the next layer nodes

you can apply ‘all possible versions of the subset/combination interactions’ to each node output

all_subset_combination_interaction_functions(subset_and_combination(all_layer_outputs)) as input for all of the next layer nodes

you can apply difference-maximization or another function to make ½ or another ratio of nodes sufficient for finding ‘probable’ rather than ‘all’ structures of combinations

‘maximize_differences(combinations(all_layer_outputs))’

you can derive which weight changes would cover the most functions applied to inputs & update weights in the direction of ‘maximum coverage’

‘identify_common_weight_changes_from_different_functions(all_layer_outputs)’

any choices other than default choices introduce a perspective that may reduce the chance of finding certain structures, but the same applies to the default parameters

‘maximally different’ networks that support ‘finding the most possible interaction functions’ in data can be derived by which network configurations are im/probable or required by a structure change

the ‘weight’ variable acts like a high-variation network parameter, but it also acts like a limiting filter on what changes are possible, even when ‘high variation in functions’ is applied to outputs of a particular layer

this is a useful variable type to identify, bc it has that ambiguity built-in and can determine the success of the solution-finding method, even when other parameters are optimized for success

it is a ‘cross-interface’ variable in that it can act like a pro-change (expansion) or anti-change (filter) structure, regardless of other change structures, making it very powerful

these functions applied to layer outputs (which can be formatted as ‘weight changes that maximize difference/coverage’ rather than ‘functions applied to outputs to create priority structures determined to be probably useful like subsets’) can influence the output without regard for other cross-interface structures like ‘meaning’ (as in the impact of the change structures, such as whether they can identify error/solution/useful structures)

alternate functions may optimize for finding ‘maximally different/useful/covering changes’ better than another function (like ‘change (variable) combinations’, such as ‘function combinations’)

Identify other required/possible inputs to the solution by applying other inputs, as any of the inputs can be connected to the solution with different paths, so whichever structures an input is connectible to (solution structures) are required outputs of other inputs as well, so deriving the solution from some inputs can derive other inputs

inputl→solution-finding method→solution

input2→solution-finding method→solution

once the ‘input1→solution’ path is known, the ‘solution→input2’ path can be derived if the inputs are high-variation causative or cross-interface inputs

‘other inputs’ and the ‘paths to connect one input with the solution’ are useful structures for the problem-solving intent of ‘identifying missing inputs to a solution (like other components or changes)’

solution success cause: this works bc everything can be connected

all variables all connectible with the right functions & information

just like one particular insight like ‘structural problems are automatable problems’ can be used to derive all other insights (by applying interface structures like cause/function/concept, etc)

this interface query is an example of how to find important structures (like ‘cell cycle limits’) causing an error structure (like ‘cancer’)

find attributes (‘systemic’) of the error structure (‘cancer’)

apply relevant interfaces (‘system’) of those attributes (‘systemic’)

apply the ‘system’ interface (to find systems related to ‘systemic’ error structure, standardizing the data type for ‘comparison & connection of inputs/outputs’ to fulfill ‘connect problem/solution’)

find related structure (metabolism) of the same type (system) of an input (diabetes) in an input-output sequence (diabetes→cancer) where an error structure (cancer) is the output’

apply the ‘function’ interface (including inputs/outputs)

‘find related structure (cell cycle regulation) of an input (cell division) to the error structure’

apply the ‘structure’ interface (including ‘opposites’)

‘find opposite structures of cell cycle regulation (like cell cycle disrupters and the inputs like triggers/requiring structures of both processes)’

this query is more complicated than a standard useful structure like ‘input-output sequence’ but is more specific & useful and is adjacent to that useful structure, requiring only a few conversions to create it

Apply specific structures for a problem format that are inputs to deriving other solution automation workflows to generate/find/derive other workflows

example: identify the specific structures of a problem format (like ‘find a prediction function’ problem format) that can be used to derive other workflows/queries (a small or unit data set can be used to derive different solution-finding methods of prediction functions since all thats required in a minimal degree of variation in the data set to accurately represent the complexity & variation of the problem format leading to multiple alternative solution-finding methods and solutions)

Apply explicit structures like ‘definitions’ to identify structures like ‘requirements’ (required inputs like ‘core functions’ to an intent like ‘build a structure’) that can be useful structures for problem-solving intents like ‘identify useful structures’

example: for the ‘find a prediction function’ problem this would take the form of identifying ‘core functions’ as structures ‘required’ to be useful for some intents, since any structure is necessarily constructed from the only available core functions, so identifying core functions is useful for intents like ‘identifying components/subsets of a structure’ or ‘building a structure’

Apply interface structures that are useful in identifying useful structures like ‘individual variable causative potential (impact)’ to identify structures useful for multiple intents like ‘preserving info’ and ‘adding info’

example: for the ‘find a prediction function’ problem, this would take the form of a ‘variable network that isolates variables, where each data point is represented as a horizontal sequence of the variable network, where differences in a variable value are depicted by vertical differences’, allowing the change structures such as ‘change patterns’ of each variable value to be represented separately from other variables, so the interface structures like patterns of each variable can be more clearly identified, as a ‘variable’ is a change structure, so isolating the change structures (like ‘patterns’ and ‘causative potential’) of each ‘variable’ change structure is a useful application of the ‘change’ interface (resulting in the ‘individual variable change patterns’) to the ‘change’ interface application (resulting in the ‘variable network’)

this structure is an alternative to structures like ‘clusters’ of a data set, which indicate ‘similarity of data points’ but reduce the clarity of change structures of each variable

this structure would make it more obvious when a variable is near an asymptote, minimum, average, sub-type, or other attribute of its change patterns, while retaining other useful info like ‘variable interaction functions’ and ‘co-occurrence of variable values’ (as a horizontal & vertical query of the variable network)

Apply useful structures like ‘alignments’ between problem/solution structures to find alternate solution-finding methods to apply

example: for the ‘find a prediction function’ problem, this would take the form of ‘aligning input variable values in the same order to create multiple aligned input vectors, where the output variable is the next item in the sequence, then apply sequential prediction functions to predict the next item in the sequence (the output variable)’

this creates an ‘alignment’ structure between the variable value positions in the vector, allowing them to be used to predict the next value (in this case the value that needs to be predicted is the output variable), making use of alternate solution-finding methods like sequential pattern-prediction functions that apply useful structures like ‘sequential patterns’ to create predictions

Apply useful structures (like ‘opposite’ structures of ‘negative’ structures like ‘possible error structures’) as a way of improving the ‘accuracy’ of a problem/solution structure (like a problem ‘input’ such as a data set)

example: for the ‘find a prediction function’ problem, this would take the form of applying common error structures like ‘misidentifying random coincidence as the variable interaction being examined’ or ‘measurement errors’ or ‘formatting/processing errors’ to the data set to generate alternate versions of inputs that would potentially reflect the actual correct data set

a variant of this is applying errors to a standard solution like a regression function found for a data set

this attempts to correct ‘possible error structures’ given error structure possibilities & probabilities when actual error structures cant be definitively derived using requirements/definitions/data

Identify variables in specific applications of workflows & interface queries to specific problem formats to generate alternate solution-finding methods

example: for the ‘find a prediction function’ problem, given the set of all possible prediction functions created by connecting subsets of non/adjacent points, and given the set of all possible ‘merge’ functions of sets of those subset-connection functions, apply these ‘interim structures for a specific problem format’ as variables of problem-solving intents like ‘connect problem/solution’ and when applying aligning structures to those problem-solving intents like ‘input-output sequences’

‘merge functions applied to the sets of subset-connecting functions’ is an interim structure when solving the problem by connecting ‘subset-connection functions’ with the ‘prediction function’, after applying ‘find subset-connecting functions’ to ‘data points’

these interim structures can be useful as variables to generate other possible solution-finding methods for a problem format like ‘find a prediction function’

Apply specific useful structures for a particular problem/solution structure like a problem format to structures of useful structures like inputs/outputs to find specific structures for a problem format that can fulfill problem-solving intents like ‘reduce difference between problem/solution’ or ‘filter the solution space’

example: for the ‘find a prediction function’ problem, this would take the form of applying specific useful structures like ‘average’ or ‘minimum’ which are useful for the problem format of ‘find a prediction function’, to structures like ‘subsets’ of useful structures like ‘inputs/outputs’ like specific data points, to test if each data point can act like a useful structure (either locally for a subset or globally for the whole prediction function) to reduce computation time of determining the remaining structures and/or to filter the solution space once a representative or otherwise useful data point is found

Apply useful structures like ‘abstractions’ to useful structures like ‘input-output sequences’ to create useful structures like ‘alternates’ of useful structures to apply in solving other problems

example: abstracting the ‘input-output sequence’ that leads to a solution for a problem type leads to a general ‘input-output sequence’ that can have specification structures like constants applied to it to convert the abstract version into a specific solution

generalization: this can be generalized to ‘apply structures that are useful for general problem-solving intents like “creating alternates of useful structures” that are useful fro specific problem-solving intents like “specifying a specific instance of an abstraction like a type” which is a function useful for problem-solving intents like “apply changes to a standard solution (the abstract type structure) to generate specific/improved/new solutions”’

Identify changes that create optimizations when applied to various different standard solutions, to find change structures that indicate the location of the solution

example: for the ‘find a prediction function’ problem, this would take the form of applying changes to various standard solution functions, identifying which changes improve the optimality of the standard solution, and identify the location of the solution given the combination of the directions of optimization indicated by those changes

if two standard solutions are a constantly increasing line and another constantly increasing line with a higher slope, and when you apply changes that increase the higher line and decrease the lower line & produce an improvement in both, that indicates there are multiple possible optimal solutions—whereas if you apply changes that decrease the higher line and increase the lower line & produce an improvement in both, that indicates an optimal solution function in between them, where those ‘applied change sets’ are the only change sets found to result in an improvement in solution metrics

Apply the solution format as a starting point for the ‘problem/solution-connection’ problem-solving intent bc its more limited (in that it has more requirements than the inputs ,which is why solutions are a subset of possible states)

example: when building a chatbot, there are a few valid solution outputs (different extensions) of the chat session, so those should be used as the starting point of the problem/solution-connecting method, which can include ‘regex for the keywords of a particular solution’ (such as how the ‘speaking to a team member’ extension is selected if no other ‘extension-matching patterns’ are found, like selecting the ‘appointment scheduling’ extension when ‘appointment’ is mentioned)

starting from the outputs (the ‘set of valid optimal solution outputs’, such as the supported extensions) reduces the level of detail/complexity required, so the problem isnt to ‘handle all possible inputs’ but to ‘filter inputs into valid solution outputs where possible’, which may require ‘approximate-matching’ functions to separate inputs into the limited set of valid optimal solution outputs

generalization: this workflow can be generalized to ‘find an optimal problem/solution variable change to fulfill a problem-solving intent more optimally, such as how changing the starting point can fulfill the ‘problem/solution-connection intent’ or the ‘filter solution space’ intent more optimally bc valid optimal solutions are more limited so there are fewer options to search’

Identify changes that would break a solution (such as by ‘changing the solution format’, which are ‘inputs to errors’), and changes that would not break a solution (which are ‘possible variables’ of the solution) and differences between them to identify directions to apply changes in

example: some changes applied to nn inputs would invalidate a solution format of ‘prediction function coefficient vector values’ (like a ‘matrix multiplication operation’ that creates multiple coefficient output vectors or a matrix of dimension higher than one) and other changes (like ‘sums of weighted inputs’) would not invalidate the solution format

the difference between the ‘matrix multiplication operation’ and the ‘sums of weighted inputs’ is trivial to create (in the form of an ‘extra dimension’), but important to avoid (in order to avoid changing the solution format)

the pattern/structure/other interface structures of this ‘difference type’ are indicators of error structures like a ‘change to the solution format’, which can direct an interface query that finds ‘changes to inputs that would not invalidate the solution format’ (which are ‘possible variables’ of the solution), which would produce changes like ‘changing how node layer outputs are combined’ or ‘changing which node layer outputs are combined’

knowing more possible variables of the solution allows valid variants of the solution to be generated/applied/derived for various problem-solving intents like ‘improving an existing solution’ or specific problem format intents like ‘prioritizing different input structures (like subsets or adjacent features)’

related workflows: a related workflow of this workflow involves deriving intents of the problem/solution/solution-finding method formats (like ‘find a prediction function’ problem, ‘neural network’ solution-finding method, ‘prediction function coefficient vector’ solution format), such as ‘prioritize different input structures like feature subsets such as adjacent features according to usefulness of those structures & coverage of input-output feature sequences’ which is a useful intent for the ‘find a prediction function’ problem when the solution-finding method is ‘neural networks’

workflow fit: this is a specific version of a combination of the ‘avoid error structures (such as ‘error inputs’) & move toward solution structures (like ‘solution variables’)’ & ‘change solutions to improve them’ workflows

Derive other useful structures like ‘inputs’ or ‘alternate routes’ of a known useful structure (like ‘core components’) by applying useful structures like ‘definitions’ (‘core components’ being ‘simpler’ than other components, so there is a ‘structural similarity’ between ‘core components’ and the ‘easy’ attribute) to find useful structures like attributes of the structure (like ‘easy’) which can be used as solution formats of sub-queries to find relevant structures (‘adjacent structures’ such as ‘inputs/outputs’ or ‘alternate routes’) to the original known useful structure

this would find ‘what question would adjacently find useful structures’, with results like:

‘what structure would be the most optimal solution’ (with different definitions of ‘optimality’ including attributes like ‘easy’ including definitions like ‘default’ or ‘adjacent’ or ‘known’)

this question can adjacently lead to useful structures like ‘core components’, which have a ‘structural similarity’ with the structure of ‘easy’ (so theyre ‘one useful structure/function away’)

the default ‘solution filter sequence’ produced by the question are:

‘find possible solutions, then find optimal solutions’ (‘possible’ solution, then ‘optimal’ solution)

when another useful structure like ‘reverse/opposite of the input-output sequence’ is applied to the ‘optimal’ structure of the question, a different ‘solution filter sequence’ is produced by the question

‘find optimal structures, then find solutions in those optimal structures’ (‘possible’ optimal structure, then ‘solution’ optimal structure)

so this useful question (which is a problem-solving intent) created various useful structures (‘alternate solution filter sequence’, ‘alternate useful structures’, ‘problem/solution structures useful for problem-solving intents’) with adjacent transforms (‘find useful structures like structural similarities in the original structure’, ‘default problem/solution structures like “solution filter structures”’, ‘apply useful structures like “reverse” to useful structures like “input-output sequence” of the original structure’) resulting from applying various useful structures (‘default solution filter sequence’, ‘structurally similar structures’, ‘reverse a substructure’), making this useful structure (the question) a useful structure in general, since it can adjacently generate other useful structures, providing a problem-solving intent to ‘find useful structures that can adjacently generate other useful structures’ and a way to generate them (applying ‘structural similarities’ to useful structures to find inputs of the useful structures which may be generative functions of the useful structures, then testing if those input generative functions can also generate other useful structures by applying other inputs/structures to the functions)

Find structures of useful structures that are useful for the problem-solving intent of ‘optimizing useful structures’ & apply them to optimize useful structures

this is a generalization of the below workflow which found a useful structure to optimize (the ‘interface query’, specifically the ‘sequence of queries in the interface query’)

‘find’ useful structures ‘of’ useful structures to ‘apply’ useful structures (such as problem-solving intents) by ‘applying’ useful structures to useful structures to ‘find’ useful structures ‘in’ useful structures

the query “‘find’ x ‘of’ x to ‘apply’ x by ‘applying’ x to x to ‘find’ x ‘in’ x” may be a useful pattern to apply to useful structures in general, as a query of useful structures that involves fewer computations than other interface queries which would involve standardization to multiple other interfaces than the meaning (useful/relevance) interface

any ‘structure (like a network, sequence, or combination) of functions’ applied to useful structures may also be a useful structure be functions connect useful structures, so if one useful structure is known, another can be easily found/derived/generated using that ‘connecting function structure’

this generalizes to other structures having the same interaction level, where the applied functions are valid operations in the form of ‘interaction functions’ of structures on that ‘interaction level’, so they can be applied to any of the structures as the structures are interchangeable and so are the interaction functions, so this can be used to identify possible connection functions of structures on an interaction level once the interchangeable interaction functions for that interaction level are known

generalization: finding ‘alternate values’ of problem-solving variables like ‘problem-solving intents’ and ‘useful structures’ is a generalization of this solution automation workflow, as each new value of these variables identified adds a variant of existing solution automation workflows using that structure

Find useful structures (generative functions like ‘filter for rarer attributes’) of useful structures (like ‘more reductive filters’) to fulfill problem-solving intents (like ‘filter solution space’) by applying useful structures (like ‘opposite of an input-output sequence’) to useful structures (like ‘standardized problem definitions or sub-problems’ like components of an interface query like ‘what is the easiest solution’) to find useful structures (like ‘efficiencies’ or ‘optimizations’) in useful structures (like ‘interface queries’)

to find a useful structure like ‘core components’, an interface query would ask the question:

‘what would be the easiest (as in simplest, default, etc) structure to create’ or ‘what structures are easy (available or otherwise adjacent/trivial to find/derive/generate)’instead of the question:

‘what are the easy solutions to the problem’, a question which arrives at the ‘core component structures’ from another direction

‘what are the easy solutions (like existing/known/available, standard, basic, simple, or default solutions, as produced by various solution automation workflows) to the problem’ is a problem-solving intent

instead of looking for structures that are solutions to the problem & have an attribute (easy), which involves first finding solutions, then filtering them for the solution metric attribute—it becomes a query for structures with an attribute (easy to find/derive/generate), after which they can be filtered for solution fit, which first finds structures with the solution metric attribute, then filters them for a solution, which may be more efficient than the reverse direction be the ‘set of possible solutions’ may be larger than the ‘set of easy structures’, both of which would need to be filtered, so filtering the smaller solution space of ‘easy structures’ (which are solutions to the problem of ‘find easy structures’) may be more optimal if it's actually smaller than the solution space of ‘possible solutions to the original problem’

this workflow finds ‘useful structures’ that fulfill problem-solving intents like ‘filter the solution space’ more optimally than other structures, then finds ways to generate those structures (‘filter for the “rarer” or “more computable” attribute’), ways to find the outputs of those structures to find unique signals of the structures (‘more reduced solution space’), and fulfills other problem-solving intents applied to those structures to generalize the workflow

Identify finding/deriving/generative functions of equivalent interchangeable interface queries that can identify a solution or solution-finding method

example: ‘the possibility of a one-possibility decision’ is equivalent to a ‘requirement’ but uses different structures in its definition, just like a ‘possible solution filter’ acts like a ‘required solution metric application’

neural network examples of sets of ‘useful structures’ that can be used to adjacently derive the ‘neural network’ idea (in addition to core structures like ‘inputs/outputs’ and ‘sum/multiply operations’)

‘change structures like change combinations’, ‘input-output sequences’

‘solution requirements’, ‘problem assumptions’, ‘adjacent structures’

‘multiple alternatives’, ‘large outputs built by small inputs’, ‘difference-maximization’

‘variable network’, ‘change-application functions’

‘change variables of existing solutions’ (change coefficients of default prediction function, which is unit coefficients, biased/specific coefficients, or average coefficients among likely alternative probable coefficient sets)

these structures are all useful for building the ‘neural network’ structures be they align with other useful structures on some interface:

a ‘requirement’ is similar to an ‘assumption’ so it can be used in place of an assumption in some contexts where their inputs/outputs align in a way that wont produce errors in that context

connecting an ‘initial’ input with a ‘target’ output is similar to ‘connecting problem/solution’ or ‘connecting suboptimal solution with a more optimal solution’ so it can be used in place of a ‘problem/solution sequence’, like where the ‘problem-solution sequence’ is a known ‘requirement’ but only ‘input-output sequences’ are available to fulfill it, because of the ‘alignment’ on different interfaces between problem/solution and input/output structures which are aligned by some definition making them similar (like a ‘state/format/change/filter/function sequence’)

so applying the ‘change’ interface highlights the similarity between problem/solution and input/output sequences and identifies ‘input/output sequences’ as a useful structures that can be used to convert a problem into a solution, if available functions as ‘change units’ are known, which are a ‘requirement’ of the aligning structure of the ‘input/output sequence’

examples of structures that can be used to adjacently derive any of neural network, interface analysis, or other prediction function-finding methods

‘input-output sequences’ (like ‘data set’=>‘prediction function’) applied to ‘interface structures’ (like ‘combinations’) of ‘highest change-reducing/finding structures’ (like ‘interface analysis’ or ‘neural network’ functions or ‘statistical prediction function-finding methods’ or ‘function decomposition methods (into other functions)’) create functions that support core important functions (‘find’, ‘reduce’) applied to ‘changes’, a primary interface structure

these examples have similar inputs/outputs but are more optimal in different edge cases, so applying a useful structure like an ‘input-output sequences’ isnt always enough to find robust solutions, edge cases such as where a variable looks like an independent variable in one data set but is clearly correlated with another variable in another data set

finding structures that are ‘adequate’ for a particular prediction task but not robust to other inputs takes more structures to accurately describe than just ‘one structural similarity between inputs/outputs’

these solutions dont find these counterintuitive structures that are non-adjacently created from known functions/attributes/structures by default, so they are necessarily incomplete or otherwise suboptimal solution-finding methods without interface analysis injected at some point

generalization: this workflow finds ‘useful structures’ (like ‘alignments across interfaces’) that can be used for the intent of ‘building interchangeable alternate optimal structures’ for a given problem-solving intent like ‘find a solution or solution-finding method’

Index functions by whether they fulfill problem-related metrics like ‘functions that are called the most frequently’ (which by definition of ‘usefulness’ is relevant to most or all ‘intents’ which is inherently relevant to ‘problem-solving’)

this applies the definition of ‘useful structures’ to ‘useful structures’ in a way that allows ‘adjacent structures of useful structures’ to be identified, applying the ‘input-output sequence’ structure to known useful structures to identify the inputs/outputs of useful structures, such as ‘useful ways to index functions that injects the definition of usefulness so the most useful functions are found first, reducing the solution space of possible functions’ which fulfills the problem-solving intent of ‘finding useful structures’

Identify variables of useful structures (like ‘feature-changing functions’) in an existing solution-finding method (like ‘neural networks’) for the problem (like ‘find a prediction function’ problem) & useful structures like ‘connections of useful structures & other useful structures’ (like ‘feature-changing functions of a neural network’ and ‘usage intents of a neural network’ or ‘problems solved by a neural network’ such as ‘find high variance-capturing variables using input features’), to find out what interface queries a useful structure can fulfill and generate alternate useful structures for particular problem-solving intents related to usage intents of the solution-finding method

a network that allows repetition or reuse of a structure in other variables/functions will be flexible enough to store both a function and the component functions it calls, as well as a variable and the structures creating/using/changing that variable

a network that allows ‘combinations of changes’ in building features from combinations of other features will be able to identify ‘change combination features’ like a ‘feature of multiple versions of another feature or feature combination’

variables

other structures can generate features than ‘change combinations’ to build ‘general or high variance-capturing features from many input features, which are the default feature-changing structure & input-output structure of a standard neural network, and other causes for these feature-generating structures (such as ‘identify high variance-capturing feature like type from many input features like image subsets’) can be identified

other feature-generating functions exist than ‘change combinations’

‘change combinations of change combinations’

‘concepts’

‘combinations, once standardized to the change interface (comparing combinations rather than combinations of changes)’

‘input-output sequences, connections, or maps’

‘functions’ and ‘patterns’

‘filters’ and ‘requirements’

other usage intents exist than ‘find features that are inputs to high variance-capturing features & predict high variance-capturing feature values’

‘find variables that can cause inputs’

‘find variables that can create approximations’

‘find interface where other variables are high-variance’

‘find high variance-capturing functions to identify probable input-output sequences that should be used in a solution-finding method’

a useful structure involving this useful structure would be a “connecting function to find the associated ‘usage cause’ (like ‘find high variance-capturing feature like type’) of a ‘feature-generating structure’ (like ‘change combinations’)”, as a function that is particularly useful in the neural network problem space to find/derive/generate other neural network algorithms that would fulfill a particular usage cause/intent

merge alternate found/derived/generated solution-finding methods for the sub-problems theyre optimal/useful for in solving a problem, applying ‘break a problem into sub-problems’ and applying different known solution-finding methods to those sub-problems, once the optimal sub-problem for a solution-finding method is found

applying interface structure solution-finding method to find ‘useful intents’ that a neural network could implement in order to ‘find a prediction function [connecting variable sets]’, given probable variable interaction functions

applying the neural network solution-finding method to find ‘high variance-capturing variables & their input variables’ which are likely to be usable with & connectible to ‘useful intents’ like ‘find high variance-capturing features’ which are probable to be identified as a particularly useful intent that a neural network should fulfill

these two methods connect in the interim structures connecting the ‘feature-generating methods’ with the target ‘useful intents of a neural network’ solution structure, as an interim step to the final step

the final step involves using the integrated output of the previous step (in applying the ‘useful usage intents of a network’ and ‘feature-generating methods’ of a neural network) for the intent of ‘finding optimal feature-generating methods or useful usage intents of a network when either is required’ (such as in changing a known solution-finding method to solve different problems)

Identify variables & patterns of successful/optimal interface queries, apply abstraction to remove any unnecessary constants specified, & frame them in terms of the ‘problem’ interface to connect them to new solution automation workflows

example: an interface query like ‘find alternate input-output sequences to find other ways to connect problem inputs and solution outputs’ can be abstracted to the solution automation workflow ‘find useful structures to fulfill problem-solving intents having structural similarities to the useful structures’ (such as how ‘connect’ is structurally similar to ‘input-output sequences’ and ‘other ways’ is structurally similar to ‘alternate input-output sequences’ as ‘alternate routes’), given that:

‘connecting problem inputs and solution outputs’ maps directly to the problem-solving intent of ‘connect problem/solution’, as every solution automation workflow needs an associated problem-solving intent that it fulfills, either explicitly or implicitly

the ‘solution success cause’ of the interface query (the reason it is successful) is because it ‘finds other solutions, which may be more optimal than the original solution to improve’ and involves ‘finding a structure that is relevant for a problem-solving intent’ which by definition is useful for problem-solving, and because it has a useful structure (a ‘structural similarity’) allowing the specific useful interface structures (‘alternate input-output sequences’) & the problem-solving intent (‘connect problem-solution’) to be connected by that ‘structural similarity’, this connection determining usefulness of the structure for the problem-solving intent

generalization: a general method of ‘apply useful structures to find specific interface structures to fulfill problem-solving intents’ can be derived from this workflow, as well as variants like ‘apply useful structures to find specific interface structures to fulfill adjacent functions to problem-solving intents’ and the abstract version of both which is ‘apply useful structures to find specific interface structures to find/build/derive problem/solution structures (like problem-solving intents)’

Identify useful structures like ‘alternate routes to fulfill the problem-solving intent to “find/derive/generate useful structures”’ and ‘alternate changes applied to find/derive/generate useful structures’ as a way of fulfilling the problem-solving intent of ‘finding new useful structures’, such as the ‘outputs of useful structures’, ‘systems leading to the generation of useful structures’, ‘requirements triggering generative functions of useful structures’ other than known useful structures like ‘generative functions’ of useful structures, which can be found by applying changes to the relevant structures such as the ‘input-output sequence creating useful structures’, which if a change is applied to add the next output (the ‘useful structure output’), a new useful structure is found with that ‘adjacent applied change to a known useful structure’ in the form of ‘outputs of useful structures’ which is useful for ‘finding new useful structures’ by enabling identification of ‘common outputs of useful structures’ or ‘input-output patterns of useful structures’ to provide inputs to fulfill the ‘find new useful structures’ intent

Identify useful structures like ‘equivalencies created by problem-solving structures’ like interface queries & solution automation workflows, such as interface queries that are adjacently created by multiple solution automation workflows, as a way to identify attributes of commonly successful problem-solving structures so those structures can be generated/found/derived using those attributes

Identify useful structures like ‘optimization interchangeables’ (‘alternatives to optimize that can effectively replace other structures to optimize’) as a way of identifying useful target interim solution outputs to use as input to fulfill problem-solving intents like ‘avoid errors’ and ‘apply generally successful solution or optimization structures’

example: if the interface query to find a solution or a solution-finding method is optimized, other structures such as input formats dont have to be optimized as much

Find interface structures that when applied, make a problem more solvable with a more efficient interface query (involving fewer operations or already computed operations, etc)

example: for the ‘find a prediction function’ problem, this might take the form of identifying ‘interaction levels’ of ‘important variables’ to solve the problem or a related problem (the ‘find neural network parameters’ problem) at, such as the ‘personality’ interaction level or the ‘mental model’ interaction level of the ‘neural network parameter’ variable space, where the problem can be re-formatted as an interface query to ‘build a neural network with this personality or this mental model’ given that neural network parameters having different personality/mental model can solve problems with corresponding varying success, optionally with other queries to ‘build a neural network to predict the solution to a problem or problem-solving accuracy given input of a network personality or network mental model and a problem format’ to select network parameters to solve a problem with an ‘alternate route’, which might be more solvable with available data than ‘build a neural network to solve this problem’, which is less specific and may require manual selection of params or selection of param-selecting algorithm or injections of assumptions in selecting parameters/algorithms, and then repeat the process for other interaction levels such as ‘known outputs/effects/errors associated with parameter changes for various problem formats’, as a way of generating an ‘alignment’ across interaction levels indicating a structure of ‘certainty’ and integrating useful interface structures like ‘facts’ (from ‘known outputs’) and alternatives (as ‘solution testing and generalizing structures’), integration of which make a solution more complete, robust, and based on understanding

this identifies the ‘neural network parameters’ as the important variable for the ‘find neural network params’ problem that it identified as particularly useful to solve, which if solved, would be the ‘most efficient problem to solve’ to reduce the interface query steps

this is be a particular neural network may have relatively few parameters to search, and compared to reducing the solution space of all possible prediction functions, reducing the solution space of ‘all possible neural network parameters’ is easier to solve by comparison

this workflow then identifies the ‘neural network parameter’ interaction levels as important to vary when creating the solution space of all possible neural network parameters to search, as ‘personality’ or ‘mental model’ may significantly reduce the parameters of a neural network even further than they are already reduced, so the problem becomes the query ‘find the neural network personality’ to fulfill the intent of ‘train a model with in order to find the prediction function’ instead of the query ‘find the prediction function [coefficients]’ which is more general and requires more sub-queries to implement

workflow fit: this workflow is specifically designed to fulfill the problem-solving intent ‘solve a problem in fewer or easier steps’ specifically fulfilling the related function ‘reduce the interface query sub-queries as much as possible’, given that the interface query determines the resources (functions, memory, computations) required to solve a problem, as ‘selecting between alternate interface queries’ is an important intent relevant to solving a problem optimally, as one interface query can effectively match ‘trial & error’ in terms of efficiency, and another interface query can effectively match its optimal opposite in optimization metrics, so these differences are important to optimize

Find interchangeable alternate structures of structures (like combinations) of useful structures (like how ‘requirements’, ‘changes’, ‘sequences’, & ‘inputs’ or ‘solution’, ‘error’ & ‘change’ are useful by default but are more useful when applied together for known problem-solving intents like ‘change problem structure until its a solution structure given solution requirements’) that can be used as default interface queries to execute first or to run other interface queries on to improve them, given that they are relevant for known relevant problem-solving intents or related functions

example: some error structures are useful when applied together, in that they are sufficiently causative of enough errors that a solution avoiding those error structures can be considered to be a ‘better than standard’ or otherwise optimal solution

sets of interchangeable structures are themselves interchangeables, occupying the same interaction layer and not invalidating the other interactive components, as interchangeable structures such as the set (‘solutions’, ‘errors’, ‘changes’) and the set (‘requirements’, ‘inputs’, ‘outputs’, ‘changes’) and the set (‘irreducible function network’) and the set (‘useful structures’) and the set (‘core interaction functions’ and ‘problem-solving intents’) and the set (‘interface queries and solution automation workflows’) and the set (‘changes’ and ‘known or standard solutions’) and the set (‘structural interface’ and ‘interface application function’) can be substituted in for each other and can interact with each other, such as applying one set to another, without invalidating the other sets (as they can coexist in the same system), just like how find/build/derive can replace each other & interact, so these structures can be applied as variables when they occur in solution automation workflows, interface queries, or other structures, as opposed to structures like ‘alternate input-output sequences’ which might invalidate each other

Apply useful structures like ‘maximally different’ structures to generate relevant structures like ‘change structures’ applied to ‘solution automation workflows’ as a way of fulfilling relevant problem-solving intents like ‘generating new solution automation workflows’

example: apply ‘trial & error’ to ‘break a problem into sub-problems’, which involve very different functions, outputs & structures, to generate workflows applying the concepts of one workflow

like applying the concept of ‘every combination’ or ‘all instances of a type’ from ‘trial & error’ to the other workflow to generate:

‘try breaking every or other problem into sub-problems’ which is useful for problem-solving intents like ‘finding common problem attributes like causes or types’ that is useful for ‘improving an existing solution’

‘try every problem-breaking method’ which is useful when a particular problem-breaking method generates more solvable sub-problems

‘try every combination of problems or sub-problems as a way to generate more obvious or solvable errors or solution structures to other problems’

these workflows are different enough for their application to each other to be a useful source of new structures of change to use as variables (in this case applying the concept of ‘every’ to fulfill the problem-solving intent of ‘alternating the structures’ of the workflow having the ‘trial & error’ workflow applied to it to generate new workflows)

Index useful structures by useful structures such as ‘input requirements’ or ‘input causes’ of a useful structure or ‘usage intents the useful structure is most useful for’ (like a ‘variation-causing sequence of useful structures’) as a way of finding useful structures of useful structures quickly for a particular problem-solving intent or interface query intent

Identify useful structures by which structures would implement a useful structure like a function relevant to problem-solving (such as a ‘function to fulfill a particular problem-solving intent’ like a ‘solution-finding function’) across multiple problem types/formats, which by definition means they are useful for problem-solving, as a way of deriving useful structures

example: “identify useful structures (like ‘core components’) by which structures fulfill generally useful functions (like ‘build’) which are generally useful and therefore useful to problem-solving as well”

workflow fit: this identifies useful structures in a new way, by deriving them from changes, inputs, requirements, & other useful structures applied to problem/solution structures as the structures determining usefulness so they should be used as inputs to a function determining usefulness of a structure

Identify general interface structures or specific problem space system structures that would be useful (like ‘a solution-finding method parameter update function’) for various problem-solving intents as the target solution structure, and apply interface structures to structures of the problem space system to apply useful structures like patterns of interface structures to the problem space system structures to implement these optimal useful structures

example: for the ‘find a prediction function’ problem, this would take the form of identifying the impact of a particular change type in the system of variables that are inputs to the prediction function, thereby mapping interface structures like a change type to structures in the problem space system such as ‘coefficient value changes’, so that useful structures like patterns of that change type can be applied to calculate coefficient value changes, as opposed to a method like ‘create a set of sets of independent variables, representing functions of input variables, (like a set of layers of neural net nodes) and test if their impact on a prediction function is useful’

other useful mappings from interface structures to problem space system structures include:

identifying if a particular probable interface structure (like a ‘processing function’ that is hypothesized to be applied to the inputs at some point in the problem space system) would produce a particular change associated with a function or function network applied to some function of input variables of a data set, to derive which functions should be present in the neural network to implement or filter out that interface structure

this connects the solution-finding method with interface structures of the problem space system, so a theory of which functions of interface structures determine the problem/solution are probable can be tested by changing a solution-finding method's structure to test that theory

multiple workflows can be derived from a structure (like a sequence) of useful structures, by applying change functions relevant to the structure, such as adding/removing items at either side of the sequence, wrapping an interface query with an interface query, or substituting alternate structures

this interface query identifies specific problem space system structures associated with useful structures: ‘neutralization’

identify problem space structures (network node functions having neutralizing effects) implementing useful structures (neutralization) of useful structures (parameter changes) of useful structures (solution-finding method)

to identify problem space system structures implementing useful structures of neutralization

to use in a function improving the solution-finding method

to fulfill the problem-solving intent ‘improve existing solution’

this interface query identifies an input-output sequence having a useful structure in the form of a useful function (an update function of solution-finding method parameters) as its output

identify useful structures (inputs) of useful structures (update function) of useful structures (solution-finding method parameters)

to identify neutralization structures as useful structures

to use in a function improving the solution-finding method

to fulfill the problem-solving intent ‘improve existing solution’

identify useful structures like ‘possible error structures’ such as whether the input-output direction of solution-finding methods & queries implementing or creating them reflects the problem space system direction (whether specific features can construct general features or vice versa), and whether the direction can be determined or if the variable type/interaction could be different from the input-output sequence assumed by the solution-finding method

for example, identifying where effects of nodes' functions have effects like ‘neutralization’ to identify relevant structures to the solution-finding method's changes (the network's parameter (weight) changes), like ‘deactivation probability of a node’ given that structures of ‘neutralization’ would by definition not change the outputs of a network, and would therefore be relevant for processes relevant to the solution-finding method like ‘node deactivation’, so ‘neutralization’ structures are relevant to the solution-finding method's changes so ‘neutralization’ structures can be considered an input to a function that changes (improves) a solution-finding method's parameters

other example useful structures would be the opposite related function of a function with useful outputs like ‘decreasing the solution-finding method structures’ (to fulfill the useful structure of ‘removing unnecessary structures that dont change outputs’), such a function with useful outputs like ‘increasing the solution-finding method structures’ (to fulfill the useful structure of ‘improving a solution metric like accuracy or robustness that changes outputs in a useful way’)

identify useful structures (like ‘inputs’) of useful structures in the problem space system to identify structures that can create useful structures

identifying structures like ‘weight update functions’ that enable or create other useful structures such as requirement-invalidating structures like ‘unnecessary training iterations’ to identify where iterations can be skipped

identifying which combination of optimal standard functions would be useful to start filtering the solution space & derive the neural network for that function combination as the initial first iteration output of the final dense layers (which structures of functions of inputs such as ‘functions of functions of inputs’ would produce the changes to inputs necessary to create those optimal standard functions)

identifying the default or useful interface structures such as change types (such as adjacent change types) that should be tried first as connecting structures (such as core combinations, core transformations of original data set variables) and whether those change types (as applied to input variables, to create output coefficients) are supported or likely to be produced by a neural network's parameters (whether a neural network can identify a particular variable subset combination as a useful structure for predicting another variable, in its supported weight update changes, which are the aligning problem space structure with the ‘change types’ interface structure)

this could allow avoiding the need for a neural network in best case scenarios, instead identifying the useful change types & other relevant interface structures before training

rather than ‘finding network parameters that enable finding the change types required to produce the prediction function’, this is a problem of ‘finding the change types applied to weights & other interface structures that can convert input features to output prediction function coefficients’

given that the sum of weighted coefficient vectors will act like operations (such as exponent operations, multiplication operations, or multiplication by zero operations) in some cases, varying change types (like exponents) are supported with that ‘overlap’ structure between the input-output sequence of those operations, supported by a neural network structure given the configured weight update rate, thresholds & other params, and given the data set's changes required to get from input features to output coefficients

applying the ‘minimum info’ requirement interface structure to neural networks, it could identify that if it cant improve its solution metrics beyond a certain range considered useful (like a ‘better than average prediction success rate’), it doesnt have the minimum of info required to solve the problem, so it can handle this sub=optimality by injecting a structure to ‘prevent nodes from being deactivated in a higher ratio of cases’ since it cant be absolutely certain given its inability to narrow the solution space that some nodes wont contribute with other training data sets or in some cases, so identifying nodes that could contribute in alternate probable edge cases inferred from the data set which should have a lower deactivation probability injected would be a solution structure to improve that sub-optimality

identifying a pattern structure such as ‘node-weight unit sets that change a function around various base or symmetry functions within the data set’ can identify useful structures in the data set, like alternate or component functions, and re-creating those node-weight unit patterns will allow those function structures to be detected in the data set

organizing weights & nodes to have a similar impact on the prediction function given similarity in node position can allow various sections of the network to be de/activated and the useful weight paths & other weight structures identified more quickly & consistently

describing node input as a ‘sum of functions of input features having different coefficients created by different weight paths’ with intent to ‘test alternate weights applied to the same summing tree’ is a perspective that makes it obvious that other structures can be applied to create the useful structures of the network (‘different coefficients applied to input features’), such as a change-generating or change-maximizing function applied to input features, a function to combine those changes & a function to derive contribution of change combinations

‘deriving what contribution types/structures would be particularly influential in finding a prediction function’ is the reverse direction, to find what changes should be applied to produce those contributions

example: a function might benefit from various extreme scalar values applied to various input features, a scalar that changes a default function into a function similar to the prediction function, an exponential-increasing value, and other contributions from values that are more powerful for some intent than other value types/structures, so these values which have a higher probability of contributing to a prediction function should be guaranteed as being generated by the change types supported by a neural network, as a requirement in selecting initial network parameters to start training from, or as a priority of which network parameters to test first

given an assumption such as ‘converting a discrete set of features to a continuous output value’ (like ‘more cat-like or dog-like on the species spectrum’, ‘output dependent variable value which has a value for adjacent input variable value sets, implying continuity’), it can be inferred that a neural network should have ‘many components applying changes to input combinations’, as simple combinations of features like sums are unlikely to create a smooth curved function that is likelier than simple constant-sloped functions than complex subtler coefficient changes that are likelier to be created by incremental weight changes

applying one scalar to a function can create certain change types like ‘increasing a constant slope’, but summing it with other one scalar-applied functions can introduce other change types given the differences in input values, and since these are the useful change types, that ‘summing with other one scalar-applied functions’ could be identified as a useful structure to implement

‘find useful combinations of changes’ can be identified as a solution requirement to fulfill once ‘change combinations’ are identified as a useful structure to apply to input features, supporting various change types like ‘changing coefficients to zero (or near-zero)’ to handle the error structure of ‘variables not contributing to the prediction function’ and the error structure of ‘subtle/small changes being required’, both error structures being potentially improved by a network supporting the change type ‘change coefficients to zero’

simple regression in general corrects for one error structure (‘difference from average’), but if other error structures are embedded in the solution-finding method (like ‘difference from specifically/exactly accurate function in one case’), the method can improve in general accuracy in most cases, an error structure that can be identified by applying the structure of ‘alternate’ to the ‘data set’ component of the problem space, to infer the existence of ‘alternate data sets’ and errors the standard simple solution would create with the possible changes associated with that variable

the intent path that follows could also generate the structure:

‘resolve difference between inputs/outputs’→‘change inputs until theyre outputs’→‘find change-applying function’→‘find change-combining function’→‘find change combination testing function’→‘find influence-assessing function (PDEs)’→‘find change-combination influence-prioritizing update function (weight update)’→‘find function to identify optimality of solution (stopping function)’

where actionable (specific structural) intents can be directly mapped to math structures having those inputs/outputs

given that some important variable structures cant be quantified using available input variables, the neural network structure of ‘isolating unique contributing variables, variable structures, and variable values’ will have an ‘error structure’ of ‘miss these variables that cant be generated from original data set variables’, which may require interface structures to find

in cases where the variable of ‘number of node layers left’ (representing the ‘number of changes available in this weight path’) is suboptimal at changing some states in a weight path to their optimal state (a weight path that would be highly useful in determining the final prediction function coefficients), in cases where the ‘optimal weight path state to form a useful weight path relevant for determining final prediction function coefficients’ can be determined, this can be used to conditionally add nodes where ‘adjacent optimizations’ are identified to ensure a particular weight path is optimized by the following changes, if enough other weight paths would benefit from such a neural network structure change, making ‘weight paths’ into important/influential structures (like ‘voters’ and ‘inputs’ and ‘causes’) in a ‘voting/weighting system’

applying structures like ‘adjacencies’ such as ‘adjacent weight paths or states’ that would ‘change threshold filter outcomes’ (deactivations) can identify useful neural network structures like ‘parameter change &initialization change recommendations’

alignments between useful structures like ‘input-output sequences’, ‘priorities (as weights)’, ‘filters (as deactivations)’, ‘feature-generating functions’, ‘directed function networks as overlaps in input-output sequences’ ‘alternatives’ and ‘specific-to-general variable generation direction’ can identify the ‘neural network’ structure as an optimality in the ‘solution-finding method’ solution space

identify ‘error structures’ such as a ‘false similarity/connection’ in variables that may be correlated coincidentally such as by ‘availability/accessibility’ or by ‘no preventative structures like limits in place that would prevent the connection’, but not for a relevant cause such as a ‘requirement’ indicating a required association rather than a potentionally irrelevant association (from coincidence such as the availability of an input/variable), by finding/deriving/generating & simulating a system where a correlation could occur that is false in terms of being irrelevant for determining another variable like a type as a way of identifying possible & probable error structures

applying ‘input’ structures to ‘error’ structures, in identifying the possible inputs to found/derived/generated error structures can determine if a neural network is likely to create those errors if it can fulfill the inputs to those errors, like functions or priorities or lack thereof that are inputs/enablers/triggers/users, or other useful structures of a particular error structure

identify the sets of changes producing known errors represented by changes to input/interim variables (as in, a variable should be deactivated with a weight of zero to represent the ‘irrelevant input variable’ error structure, so make sure theres a structure of nodes/weights that will probably produce a zero for each variable at some point during training)

this workflow would identify these structures (‘unnecessary nodes or training iterations or weight updates’, ‘solution-finding method update function parameter-improving function’, ‘neutralization/magnification structures’, ‘node deactivation probability’) as useful structures to implement, in order to avoid other interface applications to solve the original problem, and instead apply interfaces to implement those useful structures specific to a problem, and then given the mapping between the interface structures & problem space system structures to identify useful structures to implement, apply that mapping to identify useful structures to implement in other problems, ‘identify useful structures to implement’ being a problem-solving intent

Find/derive/generate specific structural structures (like structural sequences) that can be used to solve a problem and apply them as inputs to an alternate solution-weighting function or as parallel processes to find a solution function first or as inputs to another problem-solving intent like ‘generating probable standard solutions’

example: for the ‘find a prediction function’ problem, specific structural sequences include the following, which are input-output sequences of structures that can generate a prediction function

non-adjacent subset connection functions+function weighting scheme=prediction function

adjacent subset functions+smoothing function=prediction function

functions having various average definitions+function weighting scheme=prediction function

common function components (peaks, inflection points, extremes)+adjacent transforms to fit the function=prediction function

standard solution function+transforms to fit the function=prediction function

these ‘specific structural sequences’ are useful as default components of interface queries to fulfill a solution automation workflow involving structural similarities in required structures such as ‘connecting states’ or ‘finding input-output (connection, interactive) sequences’, where the ‘specific structural sequences’ involve structures that are efficiently resolved in a problem space (‘common function components’ or ‘smoothing functions’ being more structurally defined than the ‘find a prediction function’ problem, thereby adding value in these specific structural definitions)

these ‘specific structural sequences’ might be the output of an interface query, thereby building interface queries in reverse, given interactive/connective structures in a specific problem space, so that interface queries can alternate between these structures (‘iterate through & apply these input-output sequences’) that could be generated by other queries such as ‘find interactive/connective functions that can connect a data set and a function’

these ‘specific structural sequences’ are nonetheless still abstract in terms of the specific functions required to implement them, allowing variation in their implementation, so they can act like sub-interface queries (‘apply these input-output sequences to find inputs to the function-weighting scheme’), interim interface queries (‘apply these input-output sequences where relevant such as on-demand’ or ‘skip to these input-output sequences rather than finding alternative input-output sequences’ or ‘apply these input-output sequences as placeholders for an interface query to be executed when other input-output sequences are found to be sub-optimal for a problem’), or alternate interface queries (‘apply these input-output sequences in parallel to see which finds a solution faster’)

Apply useful structures like ‘alternate input-output sequences’ to various problem/solution structures across interface queries & workflows & apply them in relevant workflows/queries/problems (relevant in being specific to the same standard problem format like the ‘find a prediction function’ problem format)

example: for the ‘find a prediction function’ problem, this would take the form of ‘finding alternate input-output sequences for possible functions required by various interface queries’, like how the specific sub-function ‘find relevant connections between points’ is used by various solution automation workflows implemented with various interface queries that solve the ‘find a prediction function’ problem in a particular way involving connecting data set subsets such as adjacent pairs or high-priority pairs (such as adjacent subset averages or high-density averages), so alternate functions such as ‘clustering methods’ that also require these specific sub-functions may be relevant to the ‘find a prediction function’ problem be they have a similar input/output (data set input, connection function output), and applying ‘clustering methods’ to a data set can identify data points that can be connected using clustering functions like ‘connect to the nearest points having the most adjacent points’, where these ‘subset connections’ can be used to build a prediction function, just like how ‘anomaly detection methods’ can be applied to a data set to identify ‘non-standard connections’ which is a useful structure to the ‘find a prediction function’ problem

Apply anti-error structures like a ‘requirement of decisions/selections impacting the solution’ where decisions (‘selection’ structures, acting like ‘solution filters or specifiers’) are relevant to solving the problem (such as where the solution format requires it or its required by a process required to generate the solution) to avoid an interim error structure such as ‘false certainty in making a selection resolving an ambiguity’ when applied to problem/solution structures (such as when choosing between alternative solutions randomly, rather than for a reason), and apply variables to the solution where selections are not required, to avoid other error structures caused by not avoiding that error structure which would impact the solution structure, like ‘over-specifying a solution’ or ‘over-solving for a constant value that isnt required to be a constant’

example: for the ‘find a prediction function’ problem, this would involve applying variables to structures where optimization is ambiguous (such as regions where a function can vary without changing the optimization of the solution metric) to parameterize solutions restricted to a particular variable value

when applying ‘trial and error’, a decision about whether to ‘sort the options first before applying the test of the solution metric attribute’ or ‘find all solutions or an optimal solution, rather than the first successful one’ is not required in the standard problem format of ‘find an item having this attribute in this set of items’

Apply change structures to relevant structures for a particular problem format or problem type to identify other structures these relevant structures can be useful in for the original problem

example: for the ‘find a prediction function’ problem, structures of ‘representation’ are useful in finding a function that is ‘representative’ of the data set and can therefore be used for prediction/approximation

applying change structures to ‘structures of representation’ can generate alternate methods of finding a prediction function, such as ‘representative structures’ like:

‘connecting points by finding direction of greatest number of points to navigate in’ (similar to clustering algorithms), which prioritizes connections & points that are in higher-density regions of the data set

‘averages of dense regions’ indicating higher-priority data that should be more representative of the data set as a whole

these ‘representative structures’ can be used to identify high priority points to use as input to the ‘find a prediction function’ problem or to connect or otherwise interact in such a way that they are used to build the prediction function (like connecting various adjacent high-priority points to form subset functions and then weighting or connecting these subset functions)

to find/derive/build ‘representative structures’ like ‘averages of dense data point subsets’ or ‘connecting prioritized points to form subset functions & then connecting subset functions’, other representation structures like ‘average’ can be applied to problem space structures like ‘data points’ and ‘sets of data points’, and known calculations of weight/priority of a point can be analyzed to reveal the input data points that result in a higher weight (those in high-density regions or those representing an average of adjacent surrounding data points) in order to determine attributes of data points that should be prioritized, or identifying the subset of points that could adjacently generate a prediction function in other known example data set/prediction function pairs

Find useful structures such as ‘patterns’ of ‘differences between multiple alternate solutions’ so those differences can be applied to the origin problem state where possible, to maximize chances of finding a solution

example: for the ‘find a prediction function’ problem, patterns of differences between multiple optimal solutions might look like adjacent functions forming an ‘area of optimality’, where for the ‘find a local minima’ problem, patterns of differences between multiple optimal solutions might look like ‘separations by upward curves of a polynomial’, indicating that optimal minimum points are likely to be separated by a parabola/peak or similar structure, where these difference patterns can be applied to an origin problem state like a data set or standard solution (linear regression function) or a random point on a 3-d graph or a standard solution (adjacently computable local minimum)

Apply alternative structures (like differences from variables, randomness, opposites) to change problem/solution structures (like a specific solution-finding method for a specific problem format) in a way that optimizes a general solution metric (like ‘reducing number of required steps/functions’ or ‘adding information’)

example: for the ‘find a prediction function’ problem, this would take the form of finding ‘probability of a data point in this determining area of a function’ or ‘probability of a data point within range of determining point x of a function’ instead of ‘determining points of a function’, applying interface structures like ‘probability’ and ‘surrounding area of a point’ and ‘generative functions’ rather than the structure of an ‘exact point’, as a more optimal structure for determining whether an area is ‘representative’ of a ‘determining point of a function’, applying ‘find generative function of x’ as an alternative to ‘find x’ to optimize a solution metric like ‘number of steps required’ to generate a different workflow than ‘find determining points of a function’, therefore ‘finding inputs, alternatives, or approximations of determining points rather than the determining points themselves’

apply ‘mix’ interface structure to other solution-finding methods to find structures that add different information, such as ‘function coefficients’ and ‘determining points’:

generated different workflow: ‘find determining points of a function and predict a subset or all of those from the data set, instead of or in coordination with predicting the function coefficients’,

Find structures such as ‘representative’ structures that are useful for the problem-solving intent of ‘finding a solution balancing various solution variables once multiple probable solutions are found’ (solution variables like optimization, determined by solution metric fulfillment)

example: for the ‘find a prediction function’ problem, this would take the form of finding an ‘average function’ or ‘base function’ of probable functions that can be solutions, to represent the probable alternate solutions based on a weighting schema, or to represent the ‘probable versions’ of a function once some parameter change is applied to the ‘solution base function’

Find the relevant structures (like the ‘representative’ structures such as averages, representative examples like important data points, important variables, counterexamples like outliers, etc) for a particular problem given alternate definitions of that problem (‘find a prediction function’ as a ‘find a representative function’ problem)

these relevant structures give a different format to aim for when solving the problem, such as finding ‘representative examples’ as inputs to a ‘find a prediction function’ problem rather than the original input of the entire data set, ‘representative examples of the data set’ being relevant because the problem is to find a ‘representative function of the data set’

workflow fit: this applies ‘alternate’ structures to the ‘problem format’ to find ‘alternate problem formats’

generalization: this can be generalized to apply ‘alternate’ structures to other problem/solution structures to find ‘alternate routes’ to fulfill a problem-solving intent or solution automation workflow

Derive useful structures that can act like alternatives to interfaces, such as structures including objects of a particular interface structure type (like functions, variables, vectors, data sets, or positions)

where problems are standardized to ‘find a set of transforms to convert one vector/matrix into another’, given interaction rules of the problem space system (such as available operations & interaction levels), a useful structure would be the format of a space where a vector is transformed into another vector, where points represent operations applied to an adjacent vector as specified by the interaction rules, so that solution automation workflows can be applied, such as ‘finding alternate solution vectors similar to the original solution vector to aim for instead’

this space can function like a ‘base network’ similar to how a language map is used as a base network for solving nlp problems

these ‘base structures’ can act like sub-interfaces and can be useful as alternate structures to interface structures or other useful structures which can be used as ‘standardized problem spaces’ to convert a problem to, as opposed to converting a problem to an interface

the ‘base structures’ dont need to be comprehensive to be useful—examples of the problem system interactions to specify a vector at a point relative to another vector may be sufficient for solving some problems

Find structures where functions can be applied to adjacently create the solution, such as ‘solutions fulfilling opposing filters’ where a ‘connect’ or ‘average’ function can be applied to ‘solutions fulfilling opposing filters’ to find a more optimal solution between these opposites, where opposites represent error structures of varying extremes (extremely general/specific)

example: for the ‘find a prediction function’ problem, solution space filters such as solutions fulfilling the filters ‘most intersections with actual data points (most specific function)’ and ‘most general function or generally representative function’ allow those solutions to act like opposing filters, where the optimal solution is between these filter structures implemented as solution structures (a specific function and a general function)

the opposite structures represent an ‘extreme’ error structure, fulfilled by the abstraction attribute (‘general/specific’)

‘finding an average between values (such as extremes)’ is a relatively simple function

other alternate functions would be ‘finding a function that reduces extreme metric 1 (number of data point intersections) and extreme metric 2 (linearity) while still representing the data set to some degree’

this workflow finds a structure representing an error structure of the solution (such as opposite extremes of a solution attribute, such as abstraction) then finds structures (solution space filters like ‘most intersections with data points’) that could create those structures (solution functions having opposing extremes of abstraction) then applies problem-solving functions (connect) or other functions (average) to correct those errors, finding the solution from those sub-optimal solution structures that are adjacent to the solution

Parameterize the impact of solution automation workflows on problem/solution structures like the solution space to neutralize the intent/requirement to apply the workflow itself, rather than applying its average or otherwise representative output (like its impact on the solution space or the changes applied to the problem origin state)

differences in reductions of the solution space created by various solution automation workflows can fulfill various problem-solving intents and help solve various problems more optimally than others

a ‘trial & error’ workflow doesnt reduce the solution space at all, whereas other solution automation workflows like ‘derive possible/probable solutions or solution structures like solution limits/boundaries based on solution requirements’ would likely reduce the solution space

the difference between these workflows' impact on the solution space encodes information about what assumptions are made which can reflect whether a solution space reduction is useful for a particular problem or problem-solving intent

example: for the ‘find a prediction function’ problem, a workflow might derive solution space-reducing filters such as ‘a prediction function has to come this close to the data set average for each data subset of size n’ or ‘a prediction function has to be this similar to these data subset-connecting functions’

the resulting reducing impact on the solution space is different from the unfiltered solution space by some parameter set

Find/derive/generate requirements of various required functions of the solution-finding process like calculating solution success (in the form of determining calculation possibilities such as whether one solution is more optimal than another), requirements such as ‘being able to calculate & compare optimality of solutions’, to identify useful structures that would invalidate these processes or make them easier/more difficult to execute (such as ‘areas of error or solution ambiguity’ on a graph, which if you can calculate can make reducing the solution space or finding an acceptable solution easier)

example: for a ‘find a prediction function’ problem, this would take the form of finding/deriving/generating the sections where it would & would not be possible to derive if a solution was better than another (structures of optimization and structures of ambiguity), deriving which of these sections of ambiguity is more optimal than others (a ‘solution ambiguity’ rather than a ‘error ambiguity’), and aiming for a function that intersects with those solution sections (there may be areas or other structures like function bundles or adjacent parameterized function points on a graph where it is clear that a function is sub-optimal, clear that a function is successful, ambiguous whether a function is a solution or error, areas where it is clear that a function is a solution but ambiguously successful when compared to similar solution functions, etc)

Apply changes to the attributes like position of a useful structure applied in a solution-finding method to implement the intent of the useful structure in its original position in a different way

example: for a ‘find a prediction function’ problem, this would take the form of applying changes in the filter types or change types applied to create ‘maximally different’ weight path patterns, rather than applying changes to weight path patterns themselves, where ‘maximally different’ weight path patterns are a useful structure applied to a neural network structure or coefficient sets to test various prediction functions or use them as a base to apply changes to, but applying the useful structure to the filters or change types used to create the maximal differences in weight path patterns can be a more optimal structure than maximizing the differences in the weight path patterns themselves

this uses ‘maximal differences’ and variation in change/filter types be those structures are useful for reducing the solution space the most

changing a standard base prediction function with one change type like ‘adding an exponent to a linear function’ creates more differences when compared to another change type applied to the standard function like ‘adding gaps in the function’, which would create two functions that are more easily filtered out because they are more different, whereas very similar functions may not only be difficult to filter out as they are an ambiguity, but they may also be equally or similarly optimal functions that both could be considered correct

generative interface query: the interface query to generate this workflow is ‘apply alternate routes to the input-output sequence of the intent of the difference-maximizing changes/filters rather than to the input-output sequence of the weight paths (or their patterns) to identify different solution automation workflows to fulfill the problem-solving intent of “connect the problem & solution” than those applying useful structures like difference-maximizing structures’ (changing the position to the input (the change/filter types) rather than to the structure theyre applied to (weight path patterns))

Apply changes to problem/solution structures, derive functions required to use these problem/solution structures, and from those required functions derive a solution automation workflow fulfilling those function requirements

example: in finding different solution formats like ‘determining prediction function points’ or ‘function limits acting like the prediction function’, a new requirement for a function is generated like ‘find determining prediction function points’, from which a solution automation workflow can be derived like ‘find a different solution format and find the structures required for that different solution format’ which involves different operations than solving the original problem, therefore comprising a different solution automation workflow

Identify structures (such as a number of significant or accessible structural similarities) required to apply structures from other systems to automatically find useful structures to apply as templates for problem-solving structures, filtering the set of structures produced by an ‘input-output sequence’ similarity with additional similarities or other structures that indicate enough relevance to apply the structure to other problems requiring the original structure, those similarities or other structures having compounding value in indicating relevance

example: for the ‘find a prediction function’ problem, this could take the form of ‘finding similar structures in other systems like a “superposition” that can act like a template to create the same output structures such as attributes like “certainty” or functions like “uncertainty resolution”’ to apply to standard structures in other systems, fitting standard structures like functions & activation states in the various structure of a superposition (either having multiple possible activation states of many possible functions, or having an uncertainty in a function's activation state that is resolved at a later time), where the inputs (atomic components), interim uncertainty structures (superposition of many possible states), and outputs (measured metric value) have a structural similarity to the relative dimensions of the neural network, so the similarity in uncertainty resolution & possible dimension sequences create enough similarities to justify applying this structure as a template for a neural network to solve the ‘find a prediction function’ problem converting a data set into a function parameter set (and the associated conversion of a data set example of independent variable values into the dependent variable value)

Apply useful structures like ‘input-output sequences’ or ‘causal sequences’ to other solution automation workflow inputs, such as inputs or generative functions of ‘determining points of the prediction function’, to identify new problem/solution structures to aim for in implementing the original solution automation workflow

example: for the ‘find a prediction function’ problem, this could take the form of ‘finding functions separating data subsets that act like tangents to the determining points of the prediction function’

Find useful structures in structures like combinations of interface structures such as ‘optimization functions’ and useful concepts like ‘complexity’ (as an error structure), to find for example ‘points optimizing for minimized error structures’ which are relevant to problem-solving intents

example: for the ‘find a prediction function’ problem, this would take the form of identifying what structures of complexity or simplicity the data set is likely adjacent to, and at what structures of simplicity the data set is likely to converge or stabilize to, at what point in the future, given adjacent stable points and the probability of changing and/or converging in the direction of any of those points, given that stable systems tend to be simpler, so if a prediction function is going to be correct for a longer period of time, it will likely be simpler than other possible prediction functions

if structures of complexity have just occurred at the time the data was measured, such as if a system has collided with another system, the effects will either invalidate the system, leading to dissolution of the system into core components, core components which may include the variable interactions of the data set, or the system may stabilize in a different or its original state depending on how it sustains variance injections—if an optimal minimum of simplicity can be derived as adjacent, that simpler function may be the best prediction function until a change occurs in the system hosting those variables that doesnt result in system invalidation

Apply problem-solving functions like core interaction functions fulfilling a problem-solving intent to various problem structures in a particular solution-finding method

example: for the ‘find a prediction function’ problem, apply ‘reduce’ function to various possible problem structures like ‘more operations than necessary’ in a regression method, such as ‘finding a representative line of more points than necessary’ by reducing the number of points that need to be represented (by finding representative points of point subsets or finding the minimum determining/differentiating points that should be connected or averages to create the prediction function), or ‘finding a representation or optimized error metric calculation for a subset of points at regular intervals in the data set so these representation metrics can be connected instead of applying the representation or error metric calculation at every point’, at which point ‘finding the points to connect or average or represent’ or ‘finding the interval at which error metrics can be calculated to find an approximation of the prediction function’ becomes the primary problem rather than ‘finding a representative function of the data set that minimizes an error metric or represents a ratio of points’, and if a solution is found by applying core interaction functions to solve these ‘problem structures’, they can be considered problem structures of a solution-finding method

Identify interchangeable solution structures (like interchangeable solution-finding methods or interface queries) and their variables to generate other items that could also be interchangeable solution structures

example: for the ‘find a prediction function’ problem, this would take the form of identifying interchangeable solution-finding methods like various regression methods such as ‘connecting dependent variable value averages between different point pairs’ and ‘finding the line that minimizes an error definition’ (or identifying alternate structures to this set of interchangeable functions, such as interchangeable interface queries or other generative functions to generate those solution-finding methods) and identifying the variables to generate the interchangeable structures on that interaction level, given that interchangeable methods act like structures having the same interaction level and will likely have adjacent variables in common as they are likely to find/build/derive/apply the same structures

for the two example regression-implementing solution-finding methods indicated above, both use an error metric, the first one implicitly (‘minimize differences in averages between point pairs so they can be connected in a line’) and the second one explicitly, which could be derived as a variable of a solution-finding method—an error metric determining whether the output is accurate (fulfills a solution metric)—that could be used to find other solution-finding methods (generate other error metrics that could determine a solution metric of a prediction function, and reverse-engineer a solution-finding method in deriving/finding/generating a solution-finding method that uses that error metric)

Apply the useful structure of ‘interchangeable alternates’ to find interface queries with ‘equal/similar impact but different implementations’ to filter for useful structures like ‘fewer steps’ or having more ‘reasons for solution success’ than other queries

example: some interface queries are more efficient than others in arriving at solutions, other things being equal

deriving interface queries of solution automation workflows & optimal solutions and selecting the query with the fewest or least computation-intensive steps is a way to find generally useful interface queries

generally useful interface queries are likely to result in a set of interface queries that make use of ‘useful structures’ like ‘alternate input-output sequences’

identifying these optimal interface queries is another way to identify useful structures bc those apply the ‘reason’ for specific solution success metric values (the ‘efficiency’ or other ‘optimality’) of those queries

Apply changes to different problem/solution structures like applying changes to create different solution formats to create different structures that can act as inputs to problem-solving structures like solution automation workflows

example: with the ‘find a prediction function’ problem:

different solution formats include a network of conditional prediction functions, representative averages for subsets of the function, function limit structures (like function range caps/boxes), a solution-finding method or generative function of prediction functions, a prediction function for inputs of the original prediction function, a prediction function range or parameterized function to produce functions in that range instead of the original solution format of one prediction function

different solution-finding methods include different parameters of regression, merging different subset functions, prioritizing representative data points, data subsets or function subsets to weight their contribution to the prediction function differently, neural networks, applying solution metric filters, applying solution metric filter-fulfilling structures as solution structures, applying adjacent structures like transforms or combinations of standard or base functions, moving subsets of a standard regression line to be more general and/or more accurate & smoothing the resulting set of linear functions, etc

this works to generate new solution automation workflows bc applying ‘changes’ by definition changes the structures involved, so if changes are applied to problem/solution structures in a way that doesnt invalidate their definitions, that method can generate new problem/solution structures that use those changed problem/solution structures as input

Apply interface structures to solution metrics to derive structures useful in generating those solution metrics, and aim to fulfill those structures of solution metrics instead of the original solution metric

example: for the ‘find a prediction function’ problem, use structures derived from solution metrics like ‘sets of allowed function subset ranges’ or ‘alternate sets of allowed function subset ranges’ as filters of how much the solution can vary in a particular location (like a set of ‘open-ended boxes’ capping variation in a particular subset position of the data set) while still fulfilling the level of accuracy or other solution metric specified by the solution requirements, given that many functions will produce the same solution metric fulfillment if solution metrics arent specific enough, so any function within certain ranges will be considered a sufficient or optimal solution in those cases

to find out what structure would fulfill the solution metrics of ‘representative accuracy’ and ‘representative coverage’ of a prediction function, an interface query would identify that there are many possible solutions, then identify a structure that would place a limit on what solutions are allowed to fulfill the solution metrics while allowing variation in which solution is selected, which would result in either prediction function parameters to allow for variation in the prediction function that would have the same effect as a ‘set of function subset range boxes’, or the structure of the ‘set of function subset range boxes’ itself, boxes having a ‘containing’ or ‘boundary’ effect that aligns with the ‘limited range’ structure of the ‘accuracy’ solution metric requirement, and subsets of the function having different boxes limiting their range, allowing the boxes to fulfill the ‘coverage’ solution metric requirement

Apply interface structures such as a ‘change’ to the perspective applied at various interaction levels & in various problem/solution structures in solving a problem to change the functions required to solve it

example: for the ‘find a prediction function’ problem, converting a standard ‘find a regression line’ problem into the same problem from a different angle such as the perspective of an agent standing at the first data point at the lowest x value and looking in the direction of the data point at the highest x value, at which point the problem becomes ‘minimize the distance from the center formed by a line intersecting with the point, where the first point represents a point on a line formed by the sequence of y-value points’, which is a different way of framing the ‘reduce distance from the regression line to the data points’ problem that results from a different perspective applied to the problem, changing the functions required to solve it—instead of finding a function for a line fitting the data the best, its finding a function for the point that minimizes distance from other points on the line of y-values, where the y-value line can represent weights of values with minimized distance from higher-weight points have a greater count in the original data set

finding a line minimizing vertical distance to points vs. finding a point minimizing distance to other y-value points, which is a way of finding the average value in a set, which can be applied to adjacent subsets and the averages of these subsets connected or used as input to the regression method, thus making the problem easier to solve by reducing the number of points to find a prediction function for, as the prediction function-finding method may be more costly than a method to find the average in a subset

this method reduces the data set to subsets using some partitioning method, then applies a perspective that reduces variation to one-dimension (y), finds a representative metric for that dimension for that subset, then connects the averages as a standard regression line to base improvements on, or inputs the averages to a regression method, thus reducing the number of points to find a regression line fitting

the application of the perspective adds value in isolating a change type, which is useful for finding attributes of that change type such as averages, ranges, change rates, probability distributions, & other attributes

the perspective cant be used on its own bc it loses info about the other dimension, so it needs to be integrated back into the original solution format (prediction function for the whole data set) by finding a line connecting or fitting the average y-values of adjacent x-value subsets

workflow fit: this is similar to applying a perspective to find perspectives that immediately precede or otherwise usually lead to a solution, but generalizes the application of interface structures to the perspective before applying the perspectives across various problem/solution structures, like in the problem system, to find useful perspective changes and other interface structures applied to perspectives that fulfill a problem-solving intent like making the problem easier to solve

Identify identifying metrics of possible error cases where a particular found/derived/generated solution would be sub-optimal and apply those case-identifying metrics as filters (in the form of error structures) of a solution to design a solution that doesnt fulfill any of the case-identifying metrics, as a way of fulfilling the ‘avoid errors’ problem-solving intent

example: for a regression method, the case where the data points have randomness or outliers is a case where a regression method such as using an average definition is sub-optimal bc it loses useful information about outliers in cases where they exist, so check if the case fulfilling the identifying metric of ‘outliers’ applies before designing a solution using the associated sub-optimal solution for that case (the regression method), or apply changes to that solution if that case if either known to be fulfilled or probable, or design a solution that is different from the associated sub-optimal solutions for these cases in ways that are useful for the original problem (rather than just any difference from the sub-optimal solution such as ‘not using that average definition’ if the identifying metric of ‘outliers’ is fulfilled, a useful difference such as ‘using an average definition that integrates the outliers such as a weighted average’, which integrates the outliers' information and avoids the error of ‘losing information’ that applies to the sub-optimal solution)

this avoids errors for worst-case scenarios in a way that applies useful methods of avoiding the error structure of the worst-case scenario, rather than a standard method of avoiding errors, using efficient identifying metrics of cases (the outliers being the identifiers of a ‘worst-case scenario’ for that particular solution method)

this identifies worst-case scenarios where a solution would break by the variables that the solution doesnt handle which are required to be handled, like extra info, where this info should be preserved in the solution format

extension: this could be extended to include a method to integrate solutions for various cases, like a weighting scheme for case-specific solutions, and a method to identify worst-case scenarios using variables that are not handled by a solution, such as extremity of outliers or number of outliers which are relevant to the original problem, which is aiming for a prediction function fulfilling accuracy metrics

Apply interface structures like ‘conditional network’ or ‘combination’ to problem/solution structures like solution formats where useful

example: for the ‘find a prediction function’ problem, a function might be better represented as a mixed structure including a function and a set of points or conditions linking those points in a network, if some points would distort the function too much if incorporated into the function given some solution-finding method that handles outliers in a way that would distort the function beyond their relevance to the other points, or a parameterized function indicating some parameter preserving the original difference between the outlier & average

generalization: this applies a variable to the problem/solution structures & their attributes (like the number of solution formats being a variable instead of a constant of one)

Identify useful changes & other interface structures (like ‘self-reference’ structures such as ‘connect connections’, ‘patterns’, and ‘common’ structures, or formatting a structure by its ‘opposite’ structures identifying a ‘difference-resolution’ structure as opposed to a ‘connection’ structure) to apply to problem/solution structures like function types such as core interaction functions to make these problem/solution structures more specific & useful for a problem

example: for the ‘find a prediction function’ problem, this could take the form of ‘apply difference-resolution structures like maximally-different point connection functions or tension-resolution structures such as wave-generation functions or momentum-application functions to account for variation in data that follows normal or common patterns of difference-resolution (connection) to find a prediction function’

the ‘difference-resolution’ structures would connect the ‘most different’ points in the data set, to find difference types and the common structures (like an average) resolving those differences in the form of a connection between different points or a connection between connections between different points of varying difference types (difference types such as ‘greatest distance on both variables’ or “greatest difference in a variable once standardized on the other variable such as adjacent points' vertical differences”), fulfilling a ‘connect’ or a ‘connect connections’ core interaction function

the ‘tension-resolution’ structures would connect the data set points using common connection patterns, such as patterns of momentum (like the ‘wave generation’ tension-resolution pattern resolves the difference created in the wave-triggering event), thereby fulfilling the ‘connect with common connections’ core interaction function

‘connecting connections between connections’ is useful because it finds similarities between connections, allowing the identification of a pattern or common attributes including common differences which can be variables of the connections

‘self-reference’ structures are useful be they apply the same definition repeatedly, and are useful in identifying structures relevant to the ‘connect’ function, such as similarities, patterns, & common structures in identifying meta-attributes (filters of filters, reductions of reductions, structures of structures, limits of limits, connections of connections)

these create structures that are specifically useful for the ‘find a prediction function’ problem in identifying useful functions that can re-use known concepts like ‘connections’ which are already defined for that problem space (as in ‘line structures having distance, intersecting with points as endpoints’) to identify useful info like the ‘probable prediction function’, useful functions such as ‘connect connections’ to create useful info like the ‘average function’ that is relevant to this problem

the useful functions to create this useful info can be derived by which functions could connect the ‘connect’ function with the ‘average function’ (a ‘self-reference’ structure, thereby identifying the specifically useful ‘connect connections’ function), a useful function derivation process that can be applied to other problems, and the specifically useful structure being re-usable with other problems to create specifically useful functions, as well as the useful structure used to generate it, and the identification of the ‘average function’ as a useful interim target being derivable from its adjacence to known solutions or the original problem's solution as a base standard,

workflow fit: this workflow involves customizing problem/solution structures such as core interaction functions with useful structures like self-reference or opposites to create specifically useful structures for a problem

Identify opposite structures like ‘gaps’ of useful problem/solution structures like ‘variable handling coverage’ created by available structures of the problem & known solutions, structures such as filters, where available filters represent what can be or is measured, so anything not covered by them is a source of possible error structures, as a way of identifying/finding/deriving new error structures, fulfilling the problem-solving intent of ‘avoid errors’

example: for the ‘find a prediction function’ problem, filters include requirements and assumptions built-in to the solution-finding method such as the definition of the concept of average that is used, or the method applied to tune the function such as generalization, smoothing, simplifying, regularizing, normalizing, standardizing, or curving methods, and given these filters, other change types may not be applied to the function, such as an outlier not handled by the function that is nevertheless valid, or a break in continuity that is valid, because the assumptions inherent to applying a ‘smoothing’ or ‘generalizing’ method will ignore these points in the data set and prioritize creating a continuous function to represent or connect certain subsets of the data set, so the ‘gap’ in the available filters including a particular definition or a solution-finding method contains the alternate structures not creatable with that definition or method, as a discrete point such as a valid outlier is not creatable with a method that produces a continuous function that ‘represents’ the data set, unless it coincidentally intersects with that structure, which is relying on randomness rather than a reliable method of preventing those errors

the ‘variable handling coverage’ refers to structures that can be built/derived/found with a set of structures in the problem space or known solution set

‘variable handling coverage’ is a useful structure in determining what is adjacently & non-adjacently possible with a set of structures, such as a set of known solutions

‘variable handling coverage’ could also be applied to problems, in finding gaps between problem structures given variables of problems in that problem space, which are possible solutions

Identify interface structures such as the change types required to find/derive/generate a useful structure for a particular problem format given its definition and apply those change types to find useful structures for a particular problem

example: for the ‘find a prediction function’ problem, useful structures include the function's parameters, its determining points & requirements, and generative functions of the function

to convert ‘find a prediction function’ into these useful structures, various change types are applied which can be applied in other problems to find useful structures

changing its format to include other components (exponent terms), converting it to a set of ‘constants’ applied to these standardized exponent terms

changing its format into its ‘determining points & requirements’

changing the causal position by identifying ‘generative functions’

workflow fit: an alternative to the ‘apply known useful structures for a particular problem after standardizing to that problem’

Derive interface queries of known solutions and identify other interface queries that could be applied to generate other solutions, where known solutions are inefficient, impractical, or sub-optimal in another way

example: for the ‘find a prediction function’ problem, the following interface queries can generate existing solutions

the ‘parameter matrix’ is generated by an interface query to ‘find “structure” that can store “output” of applying “multiple” structure to “generative parameters” of the “function”’

the ‘regression’ solution is generated by an interface query to ‘find “required” structures given the problem definition such as “representative line”’ (leading to the concept of the ‘average’ as an input to a ‘representation’ structure)

‘find “subset” prediction functions and apply a “average” definition to them’

‘find “adjacence” structures (like adjacent y-values) and apply adjacent change structures found’

Once useful structures are found/derived/generated/applied for a particular problem, apply other useful structures like change structures that are likely to create differences that could make useful structures like patterns in problem structures like values more obvious

example: for the ‘find a prediction function’ problem, a useful value structure would be a matrix of alternate parameters of the function if one exists (if there are parameter sets with equal number of parameters across different generative function types), so that other changes could be applied to this structure, to create other value structures to examine for connections (such as representing this matrix as a grid of scalar vectors mapping to each value in the parameter matrix)

Find possible errors in the problem statement such as assumptions that could change the other problem/solution structures, such as solution formats

example: for the ‘find a prediction function’ problem:

find different parameterized lines (such as lines converted into a set of segments with different formatting, where the parameters have relevance structures like complimentary variance handling or an overlap structure across different parameter sets) that can generate the line

find parameters of a matrix representing different parameter sets of a function (descriptive parameters, compression parameters, generative neural network parameters, wave function parameters, regression parameters, etc) & how they relate to actual function parameters (coefficients, powers)

or find a function for an area/shape rather than a line to represent different possible averages and probabilities that each average definition or type should be used as the output's predictor where the area indicates probability of an output occurring between the various lines

or find a function that emphasizes/prioritizes data points likely to be near to the actual prediction function or standardizes points in a way that makes them closer to the actual prediction function or removes points that are not closer, to give a shape of an implied function by a data set with a more obvious pattern

all of which have a different solution output format that is a variable when the assumption that the output should be a line and nothing else is removed, or that one definition of a component should be used

workflow fit: this is similar to other workflows that change the source/destination but applies error structures to find possible variables to apply to problem/solution structures like the solution output format

Find a space where the prediction function's parameters will be more clearly identifiable (such as by extreme values like minima, or by converging values, or by values that signal a change in change types like inflection points or changes in change rate), like how adding a dimension to a 2-d prediction function might allow identifying a minimum point in the 3-d space where the change types stabilize, which reveals where the peaks & other features of the function are located, so that the task becomes finding the original feature-differentiating minima or other structures in the 3-d space

Identify connections to generate different solution formats and how to find the format most adjacent and useful for a particular problem

example: with the ‘find a prediction function’ problem, the prediction function can take multiple formats—a set of function parameters like coefficients, a set of interactions with other structures of different dimensions like the pattern of a straight line's intersecting points with a curved function, a set of change rates/types in a structure like a sequence, a set of neural network parameters that could find the prediction function parameters, an infinite sequence, a set of minimal points that could derive the rest of the function (like how a parabola can be derived from 3-5 points depending on their positions & other requirements like positive values, where these points can be found with ‘subset function’ averages & other representations, or in finding the core structures like angles or change types like fast/slow curved/linear change of the function and determining points that determine those core structures), and some of these formats are more amenable to being used with particular solution-finding methods

Identify multiple solution-finding methods and apply components of one to the other in a way that is likely to be useful

example: applying the method used to ‘generate different variants’ of the function coefficients in neural networks is likely to be useful in an altered method of regression, which doesnt inherently find alternate variants of a function and merge them in a weighting method, be regression uses the concept of the ‘average’ already and incorporating another version of the concept of ‘average’ is likely to be useful

Find/derive/generate solutions having specific error structures (such as an incorrect assumption that the ‘average of a data set is the correct average but is incorrect’) as a way to quickly identify what is not the solution by applying these incorrect solutions as an initial non-solution space to use as a filter to find the correct solution

workflow fit: this is similar to finding the set of ‘maximally different’ solutions as an initial solution space to filter, with the exception that known error types are injected in these initial solutions, which are likelier to be not solutions but by definition non-solutions that have a known probable error, as a way to determine the actual solution by its difference from these known error non-solutions

Apply useful structures like system layer graphs as a general structure that is useful for problem-solving, integrating new problem & information learned from them into the same structure, adding as few structures as possible in the form of new objects, connections, and levels, which are default structures with which most other structures can be framed, similar to a network graph

new structures like problems/systems may take new structures to accurately represent on a graph like the system layer graph, and while that is being identified, vacillating between an ‘exploratory’ state (to consider the possibility of new structures encountered in a problem/system) and a ‘learning fitting’ state (to integrate new learned info into the system), the system layer graph has an ‘uncertainty structure’ to capture the extra possible complexity (in the form of an interface structure network or system layer graph, containing more useful interface structures nearer to the origin)

derive useful structures by which structures reduce the most variation (as in ‘capture the most complexity’)

other useful structures for problem solving would include networks/trees, interfaces (and more specific input-output sequences & core components) as different structures to standardize representations of information in a way that is likely to be useful for problem-solving in general

Identify which structures would enable finding relevant structures for a particular problem

example: for the ‘find a prediction function’ problem, this would take the form of ‘predicting other variables from various sets of other variables in the variable set’, because ‘causal dependencies’ are a particularly relevant structure for this problem format, and applying ‘change’ to the important structures of the problem space like ‘variable’ structures using various change types generated by interface analysis will help in identifying these relevant structures for solving the problem (‘causal dependencies’)

apply interface analysis to determine probabilities of dependence structures

apply the ‘subset’ structure to the ‘variable set’ structure

can one variable predict multiple other variables

which variables are necessary to predict the others

which variables can be removed without high impact on most of these subset predictions

apply the ‘change position’ structure to the ‘variable positions’ determined by ‘variable type’

can the dependent variable adjacently determine an independent variable

is one of the independent variables a possible output variable (multiple output variables)

apply the ‘change position’ and ‘subset’ structure changes

can the dependent variable adjacently determine a subset of independent variables

apply the ‘sequence’ structure

can the variables be framed in a sequence structure, where one set determines an interim set that determines an output set

apply filters of possible variable interactions based on:

probability:

how many operations are necessary to convert one variable set into another, given that fewer operations implies a structure of truth in an optimized system

do variable interactions align on multiple interfaces

are variable interactions probable given patterns of other variable interactions

are variable interactions possible given known limits, requirements, and rules

Apply solutions to a more complex problem than the problem like how predicting a value in an infinite sequence (or determining differences between infinite sequences or their functions) is more complex than predicting a dependent variable value in a polynomial function, so filtering a set of many (possibly infinitely many) different prediction functions can be solved with methods from a related but more complex problem

Identify information that is an output of a solution that can be used to derive/find/generate the solution, rather than identifying info about the solution or solution inputs, to use as a different target when solving a problem

example: for the ‘find a prediction function’ problem, this would take the form of identifying solution output metrics such as proxy metrics to a prediction function (including area under curve, number of peaks, probability distribution of local averages, etc) that can be used to identify/determine/approximate the prediction function, and change the problem to predicting those function metrics instead of function parameters like constants/multipliers/exponents applied to variables

Apply interface structures to problem space to determine other problem structures than those directly relevant to the original problem that can be used to infer solutions to the original problem

example:

in the ‘find a prediction function’ problem, apply interface structures such as ‘alternates’ and ‘adjacence’ to problem space structures such as ‘input variables’, to infer adjacent variables of a data set, such as direct inputs & outputs of the original inputs, to find a set of connecting variables that can be further connected to the original outputs to predict, or to find out if the original inputs can be corrected in some way given these adjacent variables, or if adjacent variables to the original inputs can more easily be used to predict original outputs

another example is how ‘cause’ is a directly relevant structure to the ‘find a prediction function’ problem, which attempts to identify variable dependencies, dependencies being a causal structure

an alternate general variant of this would be to apply interface structures to identify structures like ‘alternate’ applied to general problem/solution structures, like ‘alternate’ function types (such as finding an alternate general function than find/derive/apply/generate)

Apply interface structures to determine what structures could produce a useful structure for solving a problem in a particular problem format (such as how a ‘variable relationship’ is useful for solving a problem formatted as a ‘find a prediction function’ problem) and whether those structures have structures of truth (such as whether they are interactive, exist, or are probable), after standardizing the original problem to a problem format (such as ‘find a prediction function’ problem) where such a problem structure (such as a ‘variable relationship’) could be used as a target to generate with interface structures

example: in the ‘find a prediction function’ problem, identify which structures could produce a ‘exponential to integer or boolean’ variable relationship, including such information as what degree of structures applied could connect the variable structures, and identify whether these structures are possible in a standard or specific system given how structures interact, such as a ‘continuous input variable’ being used as an ‘activation signal’ or ‘type variable’ in a standard system

another example is whether these structures can be connected using other interface structure connections, like whether the intent sequence of a structure sequence is possible/probable, thereby indicating with multi-interface alignment that the structural sequence is likelier to be true

Identify & fulfill other problem-solving intents such as ‘solve for relevant structures to solving the original problem’ instead of ‘solving the original problem’

standard problem formats (such as ‘find a prediction function’ or ‘sort a sequence’) where all problems can be solved with known methods once formatted to these standard problem formats are generally found with standard interface structures, such as how the ‘prediction function’ involves a standard function interface structure of a ‘variable relationship’ and how the ‘sort a sequence’ problem format involves a standard structural interface structure of a ‘sequence’, where these structures are ‘relevant structures’ to solving these problems

‘solving for relevant structures to solving a problem’ is another problem-solving intent

other problem-solving intents can be identified by variables of problem-solving intents, such as which problem/solution structures & functions are involved, which interface structures are applied or fulfilled in the problem/solution structure interactions such as an input/output sequence between problem/solution structures that applies across various problem-solving intents, which problem/solution structures & formats are required by a problem-solving intent (such as a ‘set of solutions’), and the degree to which & method in which the problem is solved by that intent

Apply interface structures like concepts to a problem system and find useful structures like interaction structures of those applied interface structures as a way of finding structures that can be used to determine probability of solution success to apply as a filter of solutions

example: in the ‘find a prediction function’ problem, apply concept interface to find concepts like ‘average’, ‘correlation’ and ‘causation’, and apply useful structures to these applied interface structures to find structures of possible relevance as a solution filter like ‘functions of data subsets that could represent correlations’ and ‘correlation functions that when averaged could produce the prediction function’ and ‘functions that would indicate causation vs. functions that would indicate correlation and filters of these function types’, that can be used as ‘prediction function’ solution filters, given the possible meaning of these structures

Apply structures of absolute certainty (like variables that can absolutely vary in all cases and requirements such as required variable limits or interactions) to use as starting point to reach structures of approximate or probable certainties

example: in the ‘find a prediction function’ problem, absolute certainties include ‘some points may be due to randomness’, ‘some points may indicate change in the underlying variable interaction’, etc, which indicate the absolute truth of a variable of the data set (randomness, change in interaction function) that may vary

from these absolute truths, approximate/probable truths connecting absolute truths that are otherwise unconnectible with absolute truths can be identified as more probable than other approximate/probable truths, having filtered out ‘impossible truths’ and ‘improbable truths’ implied or required by the ‘absolute truths’

Apply solutions that are known to be exactly incorrect/sub-optimal as a way of finding/deriving/generating errors to generate useful information to find correct/optimal solutions

example: if you applied a regression algorithm to a classification problem, you would identify a difference in the output regarding data type, alerting you to the fact that the data type is where the error is and is related to or is the component of the solution that needs to be changed

Apply other useful structures than ‘connections’, ‘sequences’, or ‘interactive components’ applied to components of problem/solutions in fulfilling problem-solving intent functions, problem/solution core interaction functions, or other functions related to problem/solutions

example: rather than finding ‘input-output sequences’ to connect problem/solution formats/states or components available in the problem space, or finding ‘interactive components’ that can be chained together (starting from the ‘core component’ structure), apply other core structures to fulfill core interaction functions between problem/solution

finding structures that are by definition related to the ‘connect’ function, such as ‘input-output sequences’, are a useful structure by default in fulfilling/implementing that function, but other structures like ‘sets’ or ‘combinations’ can be useful as well, indicating objects that are frequently or by definition found together, indicating an ‘implicit’ connection by adjacence/approximation rather than ‘explicit’ connection by match/equivalence in definition

Apply useful structures (such as ‘mix’) to connect various solutions or solution-finding methods in a solution space, to useful structures (like ‘components’) to generate new solutions or solution-finding methods

example: for a problem with multiple generated/derived/found solutions or solution-finding methods like ‘find a prediction function’, apply the combination useful structure ‘mix components’ to switch various components of the solutions or solution-finding methods with alternate variants

for the ‘find a prediction function’ problem, this could take the form of switching error calculation methods or solution metrics

workflow fit: this is similar to the workflow of ‘generating different solutions’ or ‘identifying variables of different solutions & generating solution variants with these variables’, but is another way of achieving similar or equal intents using structures of useful structures

Generating example solution-finding methods of varying specificity & results by applying various alternate solution automation workflows, then abstracting & parameterizing differences between examples and imputing missing differences that could generate new solution-finding methods without changing output of known examples

example:

the difference between ‘regression methods’ lies in the ‘error calculation metric & associated function’

the difference between ‘regression’ & ‘finding prediction functions of subsets & merging their outputs by some weight assignment function’ includes differences in the different percent of data input to each function, the difference in outputs of subset prediction functions, the difference-resolution/merging method of subset functions

these differences can be added as abstract variables like ‘alternate input-output routes’ & ‘alternate inputs/outputs’ or as specific variables like ‘alternate data subset routes’ & ‘alternate data subsets’

these differences can be increased through combination with other interface structures than ‘abstraction’

these identified variables can be used to calculate other methods not already identified in the variable interaction space

workflow fit: this workflow is similar to other workflows that apply ‘alternate routes’ to structures to find/derive/build a solution, with a specific focus on ‘solution-finding methods’ which can function as ‘standalone interface queries’ if they fit into a workflow that uses a ‘standardization’ step so standard solution-finding methods can be applied, or if the solution-finding methods are found/derived/generated in a specific problem space, so theyre already in a format that is relevant to the original problem

Convert solutions from another format for an adjacent solution-finding method into a useful format for the original problem when applying another solution-finding method

example: for the ‘find a prediction function’ problem, apply solutions associated with ‘classification’ to solution-finding methods like ‘regression’

meaning, for a given subset of the data set, use ‘classification’ to predict a value out of several discrete possible values, as calculated by various different averages of that subset of the data set, rather than finding the prediction function using standard regression methods for the entire data set

workflow fit: this is applying ‘alternate routes’ useful structure to the ‘solution-finding method’ solution structure, rather than the normal position of applying it to the ‘problem/solution connecting functions’ to find ‘alternate problem/solution connecting functions’

interface query: the interface query for this workflow involves ‘finding ‘approximation structures’ or ‘generative structures’ or ‘prediction structures’ of solutions’ (‘solution-finding methods’), rather than ‘finding solutions’, where the ‘alternate’ structure is applied to ‘type’ of ‘solution-finding method’ as well alternating the ‘solution-finding method of solution-finding methods’ (like ‘a method to find regression-calculation functions’) from the standard ‘solution-finding method’ (like a ‘specific regression function to find the prediction function’)

generalization: in general this method finds/derives/generates variables of the problem space (like ‘alternate routes between inputs/outputs’ such as: ‘method of finding y from x’ or ‘method of finding all ys from all xs’ or ‘method of finding a subset of ys from a subset of xs’ or ‘method of finding ys from adjacent ys’ and injects relevant useful structures (like how ‘alternates’ are useful for ‘variables’, as they both have a common structure of ‘change’)

Apply differences to useful/core/default structures like ‘function networks’ to find their associated useful structures like ‘interaction rules with other structures’ that could help find/derive/generate useful structures to fulfill problem-solving intents

example:

asking the question such as ‘what is the cause/context of the sub-optimality of a useful/core structure’ such as “why is a ‘function network’ inadequate/incomplete for some intents” generates the following insight path which reveals a new solution automation workflow to find useful structures

differences between ‘function network’ and ‘optimal function network’

a function network can only represent ‘functions using the function network’ as ‘queries of the function network’, rather than representing the ‘functions using the network’ as ‘nodes on the function network’

so if an agent calls a function ‘go to specific point A’, that cant be represented as a function on a function network that only contains functions like ‘go’ and ‘go to destination’ and ‘convert destination to point’, rather than ‘go to specific point A’, only as a call to functions on that network, so a function network cant contain the functions calling it as nodes but rather ‘structures (like sequences/trees/networks) of nodes’

‘requirements’ of ‘function network’

inevitably in order to be useful, a function network will require that other structures/functions be converted to functions on that network so it will necessarily be incomplete

‘inabilities’, ‘suboptimalities’, and ‘errors’ of a ‘function network’

a function network cant figure out why its not being used for a task unless it has functions to adjacently identify ‘alternate functions’ and/or ‘tasks that would find those alternate functions useful’ and has functionality to apply its own functions to identify those structures as a ‘function network metric’ to optimize

‘differences’ in ‘function networks’ relating to ‘problem-solving’

some function networks are more adjacent to solving problems just by framing problems in terms of functions defined on that network, so some function networks are more generally optimal or specifically optimal for solving some problems than other function networks, while producing errors for other problems

this implies the usefulness of ‘finding a function network that would make problems in general easier to solve’, and ‘finding a function network that is optimal for solving known different problem types/formats’, and ‘finding the differences in specifying a more optimal function network for a given problem than the generally optimal function network, as a generative method of more optimal function networks’

abstracting these useful structures (‘finding differences’ and ‘finding difference-causing variables’ for problem-solving intents mentioned above) leads to this workflow

Find alternate formats of problem/solution structures by applying useful structures to find alternate structures with the same input/output sequence to optimize problem/solution structures for different input/output formats

how to create a ‘notebook’ solution to the problem of ‘having to print variable state and function output in order to see if a function is correct or applied correctly’:

problem type ‘sub-optimal separation of information’

solution type ‘combination of information’

solution format ‘editable web asset to show function outputs like info formats such as ‘graphs’, in addition to info formats that can already be stored in existing solution format (code files) like ‘text in comments”’

problem-solution connection query

identify problem type & corresponding solution type

identify requirements of solution type

has to store useful info of all types (code, variable attributes like ‘variable state’ or ‘variable state sequence’, and function attributes like ‘function outputs’ like graphs) in one location (like a ‘file’ or ‘web page’ or ‘editor app widget view’)

these requirements fulfill the requirement of ‘all useful info types’ being ‘visible at or approximately at the same time (in the same window/screen)’

identify solution format that would support the solution type's requirements

identify any difference that contradicts a particular solution format, in order to filter the solution space of possible solution formats

an example is the difference between a graph info format and a code info format, which contradict/filter the ‘code file’ format as a possible solution structure in its current implementation

identify similarity of ‘code files’ and ‘html files’ in having a possible function of ‘storing code’, given that ‘storing code’ is a requirement of the solution

identify difference of ‘code files’ and ‘html files’ in having a possible function of ‘storing graphs’, given that ‘storing alternate info formats like graphs’ is a requirement of the solution

given that the ‘html files’ info format fulfills both solution requirements, it fulfills an optimization metric of ‘fulfilling more solution requirements’

apply ‘alternates’ structure to problem/solution structures like ‘interface queries’ to find alternate formats of the query, such as a ‘set of questions’, a ‘set of function calls to answer questions’, a ‘set of requirements such as info or structures’, which have varying usefulness for different input formats, like if input is formatted in terms of ‘structures’ in which case ‘requirements’ for optimal structures may be a better format be requirements can be structures, not just a ‘missing information’ structure like questions

Useful structures like ‘function/rule set interactions’ can be used to find/derive/build problem/solution structures like problem/solution components/variables/examples/filters, problem space systems for simulating solutions, & solution automation workflows

various systems as ‘isolatable/closed rule sets’ act like interfaces in the brain

sub/unconscious

‘learned rules’ like memory associations

‘inherent rules’ like requirements

‘emergent rules’

lack of contradictory structures (if a system survives, its likely to optimize on some metric involving the avoidance of destructive contradictory structures)

there is no inherent ‘rule set’-controlling rule that corrects the whole set of rule sets, except for an emergent rule set in the form of structural survival (energy rules & other physics rules)

interaction levels that emerge between rule sets

emergent limits on functionality like ‘picturing higher-dimensional spaces’ (these limits being created by the interactions of other rules) or ‘thinking of unknowns that can or cant be known’ or ‘evaluating uncalculatable uncertainties’

emergent priorities like ‘simplicity’ given input priorities like ‘minimize cost’, leading to emergent rules like ‘biased rules’

these would include the ‘default structures’, like ‘core structures’

consciousness (rules enabling/describing the control of other rules)

‘rule-update/learning rules’

‘rule-testing rules’

‘rule-storage/retrieval/deletion rules’

‘rule-activating rules’

‘variable-handling rules’

‘abstraction rules to enable additional layers of rule-controlling rules’

‘logic rules’, ‘filter rules’, ‘change rules’, ‘info rules’, ‘derivation rules’, and other interface structure rules

these include ‘adaptive structures’, like structures to improve a default/standard solution

other interfaces (also formattable as rule sets or systems) emerge be of these ‘rule set’ interactions

error structures

imbalances in rule attributes like ‘rule importance’ and ‘rule functions’

a ‘rule-deletion rule’ can destroy useful rules, even if its primary function & usage of that function is to remove useless rules

lack of consciousness/ability (limit structure)

these rules may interact to have blind spots and other error structures, where one rule (prioritize positive thinking) may invalidate updating another specific rule type (self-evaluation rules)

a consciousness that depends on a rule may not be able to evaluate that rule objectively

some rule types can disable conscious/adaptive rules

‘emergent rules’ like ‘error (bias) rules’ can disable conscious rules from being applied

structure interface

formatting other structures like attributes & systems as rules to standardize input so rules can be organized

structures (like combinations, filters, gaps) of rule sets

learned & inherent & emergent rules might all seem like alternate rule sets or one combined rule set building or representing sub/consciousness depending on how much consciousness is enabled

usage interface

conscious/adaptive rule interactions are limited by the degree/type of consciousness applied

system interface

a system providing/prioritizing access to some rules can have a scalable effect like an activation effect on other rules (like useful questions to speed up learning)

meaning interface

organization rules of rules

interaction rules of rules

some of these systems are likely to develop, to develop in parallel, to replace other systems, and/or likely to develop similar/equivalent functionality as other systems

placing filters between rule sets enables the injection of rules to apply these rule sets, which allows the development of structures like non-linearity, potential, flexibility, alternatives & abstraction layers around rule sets

‘apply this rule set when this condition is met (the condition rule is applied as a filter, so the rule set acts like an option), rather than by default in all cases (the rule set acts like a requirement)’

these structures emerge as ‘freedom’ or ‘consciousness’, allowing ‘variables’ to be represented in which rule sets are applied

the ‘line’ representing a ‘difference’ between un/sub/conscious may be a line on a spectrum of consciousness, or a line separating separable systems of rule sets, or an emergent structure that can take multiple alternate/combined forms, where its variation (reflected in its ‘energy’ or ‘information’) can be distributed across alternates or centralized in one alternate

a structure allowing a ‘requirement’ to be converted into an ‘optional alternate’ (applying a variable) is useful in adding attributes of consciousness, if that variable can be handled given the other rules existing, as in if there are limits on this structure to add variables, so variation can be handled at a survivable pace

these structures can be used to derive solution automation workflows, solutions, or other problem/solution structures (such as ‘adding a variable’ to a workflow, ‘adding a filter to create a variable’ of a workflow, ‘applying rule-update rules’ to improve a workflow, ‘applying abstraction rules’ to abstract a workflow, ‘adding rule set state storage’ to allow deriving examples/intent/common attributes/errors/variables of other possible rule set systems, ‘adding extra resources for simulating/testing structures’ to allow storing a mock system as a sub-system for testing solutions before applying them, etc)

simplication: this workflow finds/builds/derives/applies useful formats like ‘rule sets’ (systems, functions) as useful structures like components/inputs of a solution automatically, to find specific rule sets/functions that can relevantly simulate a problem space system in which a solution can be found adjacently

a ‘complex’ rule set (like a ‘neural network structure’ as a ‘complexity-reduction’ or ‘complexity-handling’ structure) may handle enough complexity to identify ‘complex variable interactions’ in an input problem like ‘find a prediction function’

a rule set with ‘minimal error structures’ like a ‘general error-correcting method’ or a ‘general solution-finding method’ may be adjacent enough to the input problem state that it can adjacently be converted/fit into the rule set

converting interface structures from other interfaces (change, cause) to a standard format like ‘functions’ is useful for identifying other useful structures in a problem space including the ‘find a prediction function’ problem and the ‘neural network’ solution-finding method, useful structures like:

overlaps of functions that can generate an example input like a data point

functions that can map a set of input/output example vectors to a general (connecting) coefficient vector

this is useful be primary interfaces (like ‘system’, as in a ‘rule set’, or ‘change’, as in an ‘input/output difference’) can be represented on other primary interfaces (a ‘function set’ or ‘function having an input-output connection’)

workflow fit: this is related to workflows where an interface is found/built/derived that would make solving the problem trivial, but specifically uses ‘interchangeable alternate’ formats like functions which can reflect high variation in interactions and specifically applies them to problem/solution structures by applying useful cross-interface structures like ‘attribute-system connections’ or ‘attribute-structure connections’

One skilled in the art, after reviewing this disclosure, may recognize that modifications, additions, or omissions may be made to the solution automation module 140 without departing from the scope of the disclosure. For example, the designations of different elements in the manner described is meant to help explain concepts described herein and is not limiting. Further, the solution automation module 140 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component in this disclaimer is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1. A method optionally comprising relating solution automation & interface analysis implementation variables & components such as the following:
Problem-solving intents like ‘apply generally successful solution or optimization structures’
Solution automation workflows & their useful structures (like ‘interchangeable alternate variable sets to generate a workflow’) & their implementation variables (like ‘variable workflow component combinations’)
Variables of implementations of solution automation & interface analysis (like ‘specific structures, like certainty structures, applied in a workflow as limits/bases, such as known suboptimal workflows to apply as a base workflow’)
Generally useful structures like ‘structure/intent connections’ (for example, like ‘combinations of uncertainty/certainty structures’ & its associated intents like ‘resolving uncertainties, based on certainties applied as a foundation’)
Error/sub-optimality structures (error structures such as ‘differences unresolvable with adjacent interaction level concepts/functions’)

2. The method of claim 1, wherein example component variables of solution automation & interface analysis (like ‘solution automation workflow variables’) include ‘problem-solving intents’ like ‘apply structures with a reason to be successful, like having functionality such as fulfilling a problem-solving intent’.

3. The method of claim 1, wherein example component variables of solution automation & interface analysis (like ‘solution automation workflow variables’) include ‘variable workflow component combinations’ like ‘useful structures and a problem-solving intent’ or ‘useful structures and a problem-solving intent and a solution metric fulfilled by that structure-intent interaction’.

4. The method of claim 1, wherein example component variables of solution automation & interface analysis (like ‘solution automation workflow variables’) include ‘specific structures required to be applied in a workflow’ like ‘certainty structures applied in a workflow as limits/bases, such as known suboptimal workflows to apply as a base workflow’.

5. The method of claim 1, wherein example component variables of solution automation & interface analysis (like ‘solution automation workflow variables’) include ‘useful structures’ like ‘structure-intent connections’ and ‘interchangeable alternate variable sets (requirements, format sequences, etc) to generate a workflow’.

6. The method of claim 1, wherein example component variables of solution automation & interface analysis (like ‘solution automation workflow variables’) include ‘error structures corrected/created by a workflow/query’ like ‘differences unresolvable with adjacent interaction level concepts/functions’.

7. A non-transitory computer-readable medium containing instructions that, when executed by a processor, cause a device to perform operations, the operations comprising relating solution automation & interface analysis implementation variables & components such as the following:
Problem-solving intents like ‘apply generally successful solution or optimization structures’
Solution automation workflows & their useful structures (like ‘interchangeable alternate workflows’) & their implementation variables (like ‘variable workflow component combinations’)
Generally useful structures like ‘structure/intent connections’ (for example, like ‘combinations of uncertainty/certainty structures’ & its associated intents like ‘resolving uncertainties, based on certainties applied as a foundation’)
Variables of implementations of solution automation & interface analysis (like ‘certainty structures applied in a workflow as limits/bases, such as known suboptimal workflows to apply as a base workflow’)
Error/sub-optimality structures (error structures such as ‘differences unresolvable with adjacent interaction level concepts/functions’)

8. The non-transitory computer-readable medium of claim 7, wherein example component variables of solution automation & interface analysis (like ‘solution automation workflow variables’) include ‘problem-solving intents’ like ‘apply structures with a reason to be successful, like having functionality such as fulfilling a problem-solving intent’.

9. The non-transitory computer-readable medium of claim 7, wherein example component variables of solution automation & interface analysis (like ‘solution automation workflow variables’) include ‘variable workflow component combinations’ like ‘useful structures and a problem-solving intent’ or ‘useful structures and a problem-solving intent and a solution metric fulfilled by that structure-intent interaction’.

10. The non-transitory computer-readable medium of claim 7, wherein example component variables of solution automation & interface analysis (like ‘solution automation workflow variables’) include ‘specific structures required to be applied in a workflow’ like ‘certainty structures applied in a workflow as limits/bases, such as known suboptimal workflows to apply as a base workflow’.

11. The non-transitory computer-readable medium of claim 7, wherein example component variables of solution automation & interface analysis (like ‘solution automation workflow variables’) include ‘useful structures’ like ‘structure-intent connections’ and ‘interchangeable alternate variable sets (requirements, format sequences, etc) to generate a workflow’.

12. The non-transitory computer-readable medium of claim 7, wherein example component variables of solution automation & interface analysis (like ‘solution automation workflow variables’) include ‘error structures corrected/created by a workflow/query’ like ‘differences unresolvable with adjacent interaction level concepts/functions’.

13. A system comprising: one or more processors; and one or more non-transitory computer-readable media containing instructions that, when executed by the one or more processors, cause the system to perform operations, the operations comprising relating solution automation & interface analysis implementation variables & components such as the following:
Problem-solving intents like ‘apply generally successful solution or optimization structures’
Solution automation workflows & their useful structures (like ‘interchangeable alternate workflows’) & their implementation variables (like ‘variable workflow component combinations’)
Generally useful structures like ‘structure/intent connections’ (for example, like ‘combinations of uncertainty/certainty structures’ & its associated intents like ‘resolving uncertainties, based on certainties applied as a foundation’)
Variables of implementations of solution automation & interface analysis (like ‘certainty structures applied in a workflow as limits/bases, such as known suboptimal workflows to apply as a base workflow’)
Error/sub-optimality structures (error structures such as ‘differences unresolvable with adjacent interaction level concepts/functions’)

14. The system of claim 13, wherein example component variables of solution automation & interface analysis (like ‘solution automation workflow variables’) include ‘problem-solving intents’ like ‘apply structures with a reason to be successful, like having functionality such as fulfilling a problem-solving intent’.

15. The system of claim 13, wherein example component variables of solution automation & interface analysis (like ‘solution automation workflow variables’) include ‘variable workflow component combinations’ like ‘useful structures and a problem-solving intent’ or ‘useful structures and a problem-solving intent and a solution metric fulfilled by that structure-intent interaction’.

16. The system of claim 13, wherein example component variables of solution automation & interface analysis (like ‘solution automation workflow variables’) include ‘specific structures required to be applied in a workflow’ like ‘certainty structures applied in a workflow as limits/bases, such as known suboptimal workflows to apply as a base workflow’.

17. The system of claim 13, wherein example component variables of solution automation & interface analysis (like ‘solution automation workflow variables’) include ‘useful structures’ like ‘structure-intent connections’ and ‘interchangeable alternate variable sets (requirements, format sequences, etc) to generate a workflow’.

18. The system of claim 13, wherein example component variables of solution automation & interface analysis (like ‘solution automation workflow variables’) include ‘error structures corrected/created by a workflow/query’ like ‘differences unresolvable with adjacent interaction level concepts/functions’.
